(19) United States
(12) Patent Application Publication
(10) Pub. No.: US 2016/0327653 A1
(43) Pub. Date: Nov. 10, 2016

(54) SYSTEM AND METHOD FOR FUSION OF CAMERA AND GLOBAL NAVIGATION SATELLITE SYSTEM (GNSS) CARRIER-PHASE MEASUREMENTS FOR GLOBALLY-REFERENCED MOBILE DEVICE POSE DETERMINATION

(71) Applicant: Board of Regents, The University of Texas System, Austin, TX (US)

(72) Inventors: Todd Humphreys, Austin, TX (US); Kenneth Pesyna, JR., Austin, TX (US); Daniel Shepard, Austin, TX (US)

(21) Appl. No.: 15/211,820

(22) Filed: Jul. 15, 2016

Related U.S. Application Data
(63) Continuation-in-part of application No. 14/608,381, filed on Jan. 29, 2015.
(60) Provisional application No. 61/935,128, filed on Feb. 3, 2014.

(51) Int. Cl. G01S 19/48; G01S 19/26; G01S 19/55; G01S 19/44

(52) U.S. Cl. CPC G01S 19/48; G01S 19/44; G01S 19/26; G01S 19/55

(57) ABSTRACT

An apparatus including a global navigation satellite system (GNSS) antenna, a mobile GNSS receiver connected to the GNSS antenna, a camera operable to produce an image, and a processor communicably coupled to the mobile GNSS receiver and the camera. The mobile GNSS receiver is operable to produce a set of carrier-phase measurements from a GNSS. The processor is operable to receive the image and the set of carrier-phase measurements, extract point feature measurements from the image, model the point feature measurements based on the image to produce a point feature model, model the set of carrier-phase measurements to produce a carrier-phase model, execute a cost function including the point feature measurements, the carrier-phase measurements, the point feature model, and the carrier-phase model, and determine a state associated with the apparatus based on the executed cost function.

### CROSS-REFERENCE TO RELATED APPLICATIONS

This application is a continuation-in-part of U.S. patent application Ser. No. 14/608,381, filed Jan. 29, 2015, which claims the benefit of U.S. Provisional Patent Application No. 61/935,128, filed Feb. 3, 2014, the entire contents of both of which are hereby incorporated by reference.

### FIELD OF THE INVENTION

The present invention relates generally to the field of navigation systems and, more particularly, to a system and method for using global navigation satellite system (GNSS) navigation and visual navigation to recover an absolute position and attitude of an apparatus without any prior association of visual features with known coordinates.

### BACKGROUND OF THE INVENTION

Augmented reality (AR) is a concept closely related to virtual reality (VR), but has a fundamentally different goal. Instead of replacing the real world with a virtual one like VR does, AR seeks to produce a blended version of the real world and context-relevant virtual elements that enhance or augment the user's experience in some way, typically through visuals. The relation of AR to VR is best explained by imagining a continuum of perception with the real world on one end and VR on the other. On this continuum, AR would be placed in between the real world and VR with the exact placement depending on the goal of the particular application of AR.

AR has been a perennial disappointment since the term was first coined 23 years ago by Tom Caudell. Wellner et al. [5] in 1993 lamented that “for the most part our computing takes place sitting in front of, and staring at, a single glowing screen attached to an array of buttons and a mouse.” As the ultimate promise of AR, he imagined a world where both entirely virtual objects and real objects imbued with virtual properties could be used to bring the physical world and computing together. Instead of viewing information on a two-dimensional computer screen, the three-dimensional physical world becomes a canvas on which virtual information can be displayed or edited either individually or collaboratively. Twenty years have passed since Wellner's article and little has changed. There have been technological advances in AR, but, with all the promise of AR, it simply has not gained much traction in the commercial world.

The operative question is then what has prevented AR from reaching Wellner's vision. The answer is that creating augmented visuals that provide a convincing illusion of realism is extremely difficult. Thus, AR has either suffered from poor alignment of the virtual elements and the real world, resulting in an unconvincing illusion, or has been limited in application to avoid this difficulty.

Errors in the alignment of virtual objects or information with their desired real world position and orientation, or pose, are typically referred to as registration errors. Registration errors are a direct result of the estimation error of the user's position and orientation relative to the virtual element. These registration errors have been the primary limiting factor in the suitability of AR for various applications [6]. If registration errors are too large, then it becomes difficult or even impossible to interact with the virtual objects because the object may not appear stationary as the user approaches. This is because registration errors become more prominent in the user's view of the object as the user gets closer to the virtual object due to user positioning errors.

Many current AR applications leverage the fact that user positioning errors have little impact on registration errors when virtual objects are far away and constrain themselves to only visualizing objects at a distance. The recently announced Google Glass [7] falls into this category. While there is utility to these applications, they seem disappointing when compared to Wellner's vision of a fully immersive AR experience.

Techniques capable of creating convincing augmented visuals with small registration errors have been created using relative navigation to visual cues in the environment. However, these techniques are not generally applicable. Relative navigation alone does not provide any global reference, which is necessary for many applications and convenient for others.

The desired positioning accuracy is difficult to achieve in a global reference frame, but can be accomplished with carrier-phase differential GPS (CDGPS). CDGPS, commonly referred to as real-time-kinematics (RTK) for operation in real-time with motion, is a technique in which the difference between the carrier-phase observables from two GPS receivers are used to obtain the relative position of the two antennas. Under normal conditions, this technique results in centimeter-level or better accuracy of the relative position vector. Therefore, if the location of one of the antennas, the reference antenna, is known accurately from a survey of the location, then the absolute coordinates of the other antenna, the mobile antenna, can be determined to centimeter-level or better accuracy.

Currently, the price of commercially available CDGPS-capable receivers is out of reach for the typical consumer. However, the price could easily be reduced by making concessions in regards to signal diversity. CDGPS-capable receivers currently on the market are designed primarily for surveyors that desire instant, high-accuracy position fixes, even in urban canyons. This requires the use of multiple satellite constellations and multiple signal frequencies. Each additional satellite constellation and signal frequency adds significant cost to the receiver. On the other hand, inexpensive, single-frequency GPS receivers are on the market that produce the carrier-phase and pseudorange observables required to obtain CDGPS accuracy.

The concession of reducing signal diversity to maintain price, however, exacerbates problems with GPS availability. GPS reception is too weak for indoor navigation and is difficult in urban canyons. Multiple constellations could help with urban canyons, but indoor navigation with GPS alone is a difficult problem.

One well published solution to address GPS availability issues and provide attitude estimates is to couple GPS-based positioning with an inertial navigation system (INS). The sensors for an INS typically consist of a single-axis accelerometer, a dual-axis accelerometer, a three-axis accelerometer, a three-axis gyro, a magnetometer, and possibly a thermometer (for temperature calibration of the sensors). As used herein, the term inertial measurement unit (IMU) will be used to collectively refer to the sensors comprising an INS, as listed above. However, a coupled CDGPS and INS navigation system provides poor attitude estimates during dynamics and near magnetic disturbances. Additionally, the position solution of a coupled CDGPS and INS navigation system drifts quickly during periods of GPS unavailability for all but the highest-quality IMUs, which are large and expensive.

Some isolated applications of AR for which the full realization of the ideal AR system is unnecessary have been successful. These applications typically rely on visual cues or pattern recognition for relative navigation, but there are some applications that leverage absolute pose which do not have as stringent accuracy requirements as those envisioned for the ideal AR system. The following are some of these applications:

Sports Broadcasts: Sports broadcasts have used limited forms of AR for years to overlay information on the video feed to aid viewers. One example of this is the line-of-scrimmage and first-down lines typically drawn on American Football broadcasts. This technology uses a combination of visual cues from the footage itself and the known location of the video cameras [9]. This technology can also be seen in broadcasts of the Olympic Games for several sports including swimming and many track and field events. In this case, the lines drawn on the screen typically represent record paces or markers for previous athletes' performances.

Lego Models: To market their products, Lego employs AR technology at their kiosks which displays the fully constructed Lego model on top of the product package when held in front of a smart-phone camera. This technique uses visual tags on the product package to position and orient the model on top of the box [10].

Word Lens: Tourists to foreign countries often have trouble finding their way around because the signs are in foreign languages. Word Lens is an AR application which translates text on signs viewed through a smart-phone camera [1]. This application uses text recognition software to identify portions of the video feed with text and then places the translated text on top of the original text with the same color background.

Wikitude: Wikitude is another smart-phone application which displays information about nearby points of interest, such as restaurants and landmarks, in text bubbles above their actual location as the user looks around while holding up their smart-phone [11]. This application leverages coarse pose estimates provided by GPS and an IMU.

StarWalk: StarWalk is an application for smart-phones which allows users to point their smart-phones toward the sky and display constellations in that portion of the sky [2]. Like Wikitude, StarWalk utilizes coarse pose estimates provided by GPS and an IMU. However, StarWalk does not overlay the constellations on video from the phone. The display is entirely virtual, but reflects the user's actual pose.

Layar: Layar began as a smart-phone application that used visual recognition to overlay videos and website links onto magazine articles and advertisements [12]. The company, also called Layar, later created a software development kit that allows others to create their own AR applications based on either visual recognition, pose estimates provided by the smart-phone, or both.

Google Glass: Google recently introduced a product called Glass which is a wearable AR platform that looks like a pair of glasses with no lenses and a small display above the right eye. This is easily the most ambitious consumer AR platform to date. However, Glass makes no attempt toward improving registration accuracy over existing consumer AR. Glass is essentially just a smart-phone that is worn on the face with some additional hand gestures for ease of use. Like a smart-phone, Glass has a variety of useful applications that are capable of tasks such as giving directions, sending messages, taking photos or video, making calls, and providing a variety of other information on request [7].

Prior work in AR can be divided into two primary categories, fiduciary-marker-based and non-fiduciary-marker-based. Work in each of these categories is discussed separately below. This discussion is restricted to those techniques which provide or have the potential to provide absolute pose.

Fiduciary-marker-based AR relies on identification of visual cues or markers that can be correlated with a globally-referenced database and act as anchors for relative navigation. This requires the environment in which the AR system will operate to either be prepared, by placing and surveying fiduciary markers, or surveying for native features which are visually distinguishable ahead of time.

One such fiduciary AR technique by Huang et al. uses monocular visual SLAM to navigate indoors by matching doorways and other room-identifying-features to an online database of floor plans [13]. The appropriate floor plan is found using the rough location provided by an iPhone's or iPad's hybrid navigation algorithm, which is based on GPS, cellular phone signals, and Wi-Fi signals. The attitude is based on the iPhone's or iPad's IMU. This information was used to guide the user to locations within the building. The positioning of this technique was reported as accurate to meter-level, which would result in large registration errors for a virtual object within a meter of the user.

Another way of providing navigation for an AR system is to place uniquely identifiable markers at surveyed locations, like on the walls of buildings or on the ground. AR systems could download the locations of these markers from an online database as they identify the markers in their view and position themselves relative to the markers. This is similar to what is done with survey markers, which are often built into sidewalks and used as a starting point for surveyors with laser ranging equipment. An example of this technique used in a visual SLAM framework is given in [14] by Zachariah et al. This particular implementation uses a set of visual tags on walls in a hallway seen by a monocular camera and an IMU. Decimeter-level positioning accuracy was obtained in this example, which would still result in large registration errors for a virtual object within a meter of the user. This method also does not scale well as it would require a dense network of markers to be placed everywhere an AR system would be operated.

A final method takes the concept of fiduciary markers to its extreme limit and represents the current state of the art in fiduciary-marker-based AR. This technique is based on Microsoft's PhotoSynth which was pioneered by Snavely et al. in [15]. PhotoSynth takes a crowd-sourced database of photos of a location and determines the calibration and pose of the camera for each picture and the location of identified features common to the photos. PhototSynth also allows for smooth interpolation between views to give a full 6 degree-of-freedom (DOF) explorable model of the scene. This feature database could be leveraged for AR by applying visual SLAM and feature matching with the database after narrowing the search space with a coarse position estimate. In a TED talk by Arcas of Bing Maps [16] in 2010, the power of this technique for AR was demonstrated through a live video of Arcas' colleagues from a remote location that was integrated into Bing Maps as a floating frame at the exact pose of the real world video camera.

While the PhotoSynth approach seems to satisfy the accuracy requirements of an ideal AR system, there are several problems to universal availability. First, this technique requires that the world be mapped with pictures taken from enough angles for PhotoSynth to work. This could be crowd-sourced for many locations that are public and well trafficked, but other areas would have to be explored specifically for this purpose. Google and Microsoft both have teams using car and backpack mounted systems to provide street views for their corresponding map programs which could be leveraged for this purpose. However, the area covered by these teams is insignificant when it comes to mapping the whole world. Second, the world would have to be mapped over again as the environment changes. This requires a significant amount of management of an enormously large database. Third, applications that operate in changing environments, such as construction, could not use this technique. Finally, private spaces will require those who use the space to take these images themselves. For people to use this technique in their homes, they would need to walk around their homes and take pictures of every room from a number of different angles and locations. In addition to being a hassle for users, this could also create privacy issues if these images had to be incorporated into a public database to be usable with AR applications. Communications bandwidth would also be a severe limitation to the proliferation of AR using this technique.

Non-fiduciary-marker-based AR providing absolute pose primarily, if not entirely, consists of GPS-based solutions. Most of these systems couple some version of GPS positioning with an IMU for attitude. Variants of GPS positioning that have been used are: (1) pseudorange-based GPS, which, for civil users, provides meter-level positioning accuracy and is referred to as the standard positioning service (SPS); (2) differential GPS (DGPS), which provides relative positioning to a reference station at decimeter-level accuracy; and (3) carrier-phase differential GPS (CDGPS), which provides relative positioning to a reference station at centimeter-level accuracy or better.

One of the first GPS-based AR systems was designed to aid tourists in exploring urban environments. This AR system was developed in 1997 by Feiner et al. at Columbia University [3]. Feiner's AR system is composed of a backpack with a computer and GPS receiver, a pair of goggles for the display with a built-in IMU, and a hand-held pad for interfacing with the system. The operation of this system is similar to Wikitude in that it overlays information about points of interest on their corresponding location and aids the user in navigating to these locations. In fact, the reported pose accuracy of this device is comparable to that of Wikitude even though this system uses DGPS. The fact that the GPS antenna is not rigidly attached to the IMU and display also severely limits the potential accuracy of this AR system configuration even if the positioning accuracy of the GPS receiver was improved.

An AR system similar to the Columbia system was created and tested by Behzadan et al. [17, 18] at the University of Michigan for visualizing construction work-flow. Initially the AR system only used SPS GPS with a gyroscopes-only attitude solution, but was later upgraded with DGPS and a full INS.

Roberts et al. at the University of Nottingham built a hand-held AR system that looks like a pair of binoculars which allows utility workers to visualize subsurface infrastructure [4, 19]. This AR system used an uncoupled CDGPS and IMU solution for its pose estimate. However, no quantitative analysis of the system's accuracy was presented. This AR system restricts the user to applications with an open sky view, since it cannot produce position estimates in the absence of GPS. In a dynamic scenario, the CDGPS position solution would also suffer from the unknown user dynamics. The IMU could easily alleviate this issue if it were coupled to the CDGPS solution.

Schall et al. also constructed a hand-held AR device for visualizing subsurface infrastructure at Graz University of Technology [20]. Although their initial prototype only used SPS GPS and an IMU, much effort was spent in designing software to provide convincing visualizations of the subsurface infrastructure and on the ergonomics of the device. Later papers report an updated navigation filter and AR system that loosely couples CDGPS, an IMU, and a variant of visual SLAM for drift-free attitude tracking [21, 22]. This system does not fully couple CDGPS and visual SLAM.

Vision-aided navigation couples some form of visual navigation with other navigation techniques to improve the navigation system's performance. The vast majority of prior work in vision-aided navigation has only coupled visual SLAM and an INS. This allows for resolution of the inherent scale-factor ambiguity of the map created by visual SLAM to recover true metric distances. This approach has been broadly explored in both visual SLAM methodologies, filter-based and bundle-adjustment-based. Examples of this approach for filter-based visual SLAM and bundle-adjustment-based visual SLAM are given in [23-26] and [27-29] respectively. Several papers even specifically mention coupled visual SLAM and INS as an alternative to GPS, instead of a complementary navigation technique [30, 31].

There has been some prior work on coupling visual navigation and GPS, but these techniques only coupled the two in some limited fashion. One example of this is a technique developed by Soloviev and Venable that used GPS carrier-phase measurements to aid in scale-factor resolution and state propagation in an extended Kalman filter (EKF) visual SLAM framework [32]. This technique was primarily targeted at GPS-challenged environments where only a few GPS satellites could be tracked. Another technique developed by Wang et al. only used optical flow to aid a coupled GPS and INS navigation solution for an unmanned aerial vehicle [33].

The closest navigation technique to a full coupling of GPS and visual SLAM was developed by Schall et al., as previously mentioned [21, 22]. An important distinction of Schall's filter from a fully-coupled GPS and visual SLAM approach is that Schall's filter only extracts attitude estimates from visual SLAM to smooth out the IMU attitude estimates. In fact, Schall's filter leaves attitude estimation and position estimation decoupled and does not use accelerometer measurements from the IMU for propagating position between GPS measurements. This approach limits the absolute attitude accuracy of the filter to that of the IMU. This filter is also sub-optimal in that it throws away positioning information that could be readily obtained from the visual SLAM algorithm, ignores accelerometer measurements, and ignores coupling between attitude and position.

Accordingly there is a need for a system and method for global navigation satellite system (GNSS) navigation and visual navigation to recover an absolute position and attitude of an apparatus without any prior association of visual features with known coordinates.

### SUMMARY OF THE INVENTION

Prior to this invention, obtaining centimeter position and sub-degree orientation accuracy for devices has been costly, particularly for consumer applications. Earlier techniques required either GPS-aided inertial navigation systems (INS) or motion-capture systems costing thousands of dollars. This invention provides a system and method for fusion of camera (e.g., mobile phone camera) and global navigation satellite system (GNSS) carrier-phase measurements for globally-referenced mobile device pose determination with centimeter position accuracy and sub-degree orientation accuracy. The invention combines camera and GNSS measurements in a system that is faster, more robust, and more accurate than earlier systems. The system tightly-couples fusion of the carrier-phase differential GNSS (CDGNSS) and bundle-adjustment (BA) operations to more quickly resolve CDGNSS ambiguities than using standalone CDGNSS.

Additionally, the system enables prior or known information regarding the position and orientation of point features to be integrated with GNSS phase and point feature measurements to compute a device pose estimate even more quickly than using GNSS phase and point feature measurements. In some embodiments, the prior or known information allows the system to resolve CDGNSS ambiguities instantaneously or nearly instantaneously.

In one embodiment, the invention provides an apparatus including a global navigation satellite system (GNSS) antenna, a mobile GNSS receiver connected to the GNSS antenna, a camera operable to produce an image, and a processor communicably coupled to the mobile GNSS receiver and the camera. The mobile GNSS receiver is operable to produce a set of carrier-phase measurements from a GNSS. The processor is operable to receive the image and the set of carrier-phase measurements, extract point feature measurements from the image, model the point feature measurements based on the image to produce a point feature model, model the set of carrier-phase measurements to produce a carrier-phase model, execute a cost function including the point feature measurements, the carrier-phase measurements, the point feature model, and the carrier-phase model, and determine a state associated with the apparatus based on the executed cost function.

In another embodiment, the invention provides a computerized method for determining a state associated with an apparatus. The apparatus includes a global navigation satellite system (GNSS) antenna, a mobile GNSS receiver connected to the GNSS antenna, a camera operable to produce an image, and a processor communicably coupled to the mobile GNSS receiver and the camera. The mobile GNSS receiver is operable to produce a set of carrier-phase measurements from a GNSS. The method includes receiving the image and the set of carrier-phase measurements, extracting point feature measurements from the image, modelling point feature measurements based on the image to produce a point feature model, modelling the set of carrier-phase measurements to produce a carrier-phase model, executing a cost function including the point feature measurements, the carrier-phase measurements, the point feature model, and the carrier-phase model, and determining the state associated with the apparatus based on the executed cost function.

In another embodiment, the invention provides an apparatus including a global navigation satellite system (GNSS) antenna, a mobile GNSS receiver connected to the GNSS antenna, an interface, a camera operable to produce an image, and a processor communicably coupled to the mobile GNSS receiver and the camera. The mobile GNSS receiver is operable to produce a first set of carrier-phase measurements. The interface is operable to receive a second set of carrier-phase measurements associated with a second GNSS antenna. The processor is operable to receive the image and the set of carrier-phase measurements, extract point feature measurements from the image, model point feature measurements based on the image to produce a point feature model, model the first set of carrier-phase measurements and the second set of carrier-phase measurements to produce a carrier-phase model, execute a cost function including the point feature measurements, the first set of carrier-phase measurements, the second set of carrier-phase measurements, the point feature model, and the carrier-phase model, and determine an absolute position and an attitude of the camera, carrier-phase ambiguities, and point feature positions based on the executed cost function.

The present invention is described in detail below with reference to the accompanying drawings.

### BRIEF DESCRIPTION OF THE DRAWINGS

The above and further advantages of the invention may be better understood by referring to the following description in conjunction with the accompanying drawings.

FIGS. 1A and 1B are a block diagrams of a navigation system in accordance with two embodiments of the present invention.

FIG. 2 is a method for determining an absolute position and an attitude of an apparatus in accordance with the embodiment of the present invention of FIG. 1A.

FIG. 3 is a method for determining an absolute position and an attitude of an apparatus in accordance with the embodiment of the present invention of FIG. 1B.

FIG. 4 is a block diagram of a navigation system in accordance with another embodiment of the present invention.

FIG. 5 is a photograph of an assembled prototype augmented reality system in accordance with one embodiment of the present invention.

FIG. 6 is a photograph of a sensor package for the prototype augmented reality system of FIG. 5.

FIG. 7 is a photograph showing the approximate locations of the two antennas used for the static test of the prototype augmented reality system of FIG. 5.

FIG. 8 is a plot showing a lower bound on the probability that the integer ambiguities are correct as a function of time for the static test.

FIG. 9 is a plot showing a trace of the East and North position of the mobile antenna as estimated by the prototype AR system in CDGPS mode for the static test from after the integer ambiguities were declared converged.

FIGS. 10A, 10B and 10C are plots show the East (top), North (middle), and Up (bottom) deviations about the mean of the position estimate from the prototype AR system in CDGPS mode for the static test.

FIG. 11 is a plot showing a lower bound on the probability that the integer ambiguities are correct as a function of time for the dynamic test.

FIG. 12 is a plot showing a trace of the East and North position of the mobile antenna as estimated by the prototype AR system in CDGPS mode for the dynamic test from after the integer ambiguities were declared converged.

FIG. 13 is a plot showing the standard deviations of the East (blue), North (green), and Up (red) position estimates of the mobile antenna based on the filter covariance estimates from the prototype AR system in CDGPS mode for the dynamic test from just before CDGPS measurement updates.

FIG. 14 is a plot showing the standard deviations of the East (blue), North (green), and Up (red) position estimates of the mobile antenna based on the filter covariance estimates from the prototype AR system in CDGPS mode for the dynamic test from just after CDGPS measurement updates.

FIG. 15 is a plot showing a trace of the East and North position of the mobile antenna as estimated by the prototype AR system in coupled CDGPS and INS mode for the dynamic test from after the integer ambiguities were declared converged.

FIG. 16 is a plot showing the standard deviations of the East (blue), North (green), and Up (red) position estimates of the IMU based on the filter covariance estimates from the prototype AR system in coupled CDGPS and INS mode for the dynamic test from just before CDGPS measurement updates.

FIG. 17 is a plot showing the standard deviations of the East (blue), North (green), and Up (red) position estimates of the IMU based on the filter covariance estimates from the prototype AR system in coupled CDGPS and INS mode for the dynamic test from just after CDGPS measurement updates.

FIG. 18 is a plot showing the attitude estimates from the prototype AR system in coupled CDGPS and INS mode for the dynamic test.

FIG. 19 is a plot showing the expected standard deviation of the rotation angle between the true attitude and the estimated attitude based on the filter covariance estimates from the prototype AR system in coupled CDGPS and INS mode for the dynamic test.

FIG. 20 is a plot showing the norm of the difference between the position of the webcam as estimated by the prototype AR system in coupled CDGPS and INS mode and the calibrated VNS solution from PTAM for the dynamic test.

FIG. 21 is a plot showing the rotation angle between the attitude of the webcam as estimated by the prototype AR system in coupled CDGPS and INS mode and the calibrated VNS solution from PTAM for the dynamic test.

FIG. 22 is a plot showing a trace of the East and North position of the mobile antenna as estimated by the prototype AR system in coupled CDGPS, INS, and VNS mode for the dynamic test from after the integer ambiguities were declared converged.

FIG. 23 is plot showing the standard deviations of the East (blue), North (green), and Up (red) position estimates of the IMU based on the filter covariance estimates from the prototype AR system in coupled CDGPS, INS, and VNS mode for the dynamic test from just before CDGPS measurement updates.

FIG. 24 is a plot showing the standard deviations of the East (blue), North (green), and Up (red) position estimates of the IMU based on the filter covariance estimates from the prototype AR system in coupled CDGPS, INS, and VNS mode for the dynamic test from just after CDGPS measurement updates.

FIG. 25 is a plot showing the attitude estimates from the prototype AR system in coupled CDGPS, INS, and VNS mode for the dynamic test.

FIG. 26 is a plot showing the standard deviation of the rotation angle between the true attitude and the estimated attitude based on the filter covariance estimates from the prototype AR system in coupled CDGPS, INS, and VNS mode for the dynamic test.

FIG. 27 is a block diagram of a navigation system in accordance with yet another embodiment of the present invention.

FIG. 28 is a block diagram of a navigation system according to an embodiment of the invention.

FIG. 29 is a three-dimensional, globally referenced map reconstructed using the navigation system of FIG. 28 according to an embodiment of the invention.

FIG. 30 is a plot comparing results using this invention to a prior system and a theoretically ideal system according to an embodiment of the invention.

FIG. 31 is a three-dimensional, globally referenced map reconstructed using the navigation system of FIG. 28 and incorporating prior or known information according to an embodiment of the invention.

FIG. 32 is a three-dimensional, globally referenced map reconstructed using the navigation system of FIG. 28 and incorporating both prior or known information and current information (e.g., information with no prior positional data associated with it) according to an embodiment of the invention.

FIG. 33 is a plot comparing results using this invention incorporating prior or known information to a prior system according to an embodiment of the invention.

FIG. 34 is a process for determining the pose of an apparatus using the navigation system of FIG. 28.

FIG. 35 illustrates a system for gathering, storing, and using three-dimensional maps and point feature position information according to an embodiment of the invention.

FIG. 36 illustrates a controller for use with the system of FIG. 35.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

A system and method for using carrier-phase-based satellite navigation and visual navigation to recover absolute and accurate position and orientation (together known as “pose”) without an a priori map of visual features is presented. “Absolute” means that an object's pose is determined relative to a global coordinate frame. Satellite navigation means that one or more Global Navigation Satellite Systems (GNSS) are employed. A priori map of visual features means that the system has no prior knowledge of its visual environment; i.e., it has no prior association of visual features with known coordinates. Visual features means artificial or natural landmarks or markers. A minimal implementation of such a system would be composed of a single camera, a single GNSS antenna, and a carrier-phase-based GNSS receiver that are rigidly connected.

To reach the ultimate promise of AR envisioned by Wellner, an AR system should ideally be accurate, available, inexpensive and easy to use. The AR system should provide absolute camera pose with centimeter-level or better positioning accuracy and sub-degree-level attitude accuracy. For a positioning error of 1 cm and an attitude error of half a degree, a virtual object 1 m in front of the camera would have at most a registration error of approximately 1.9 cm in position. The AR system should be capable of providing absolute camera pose at the above accuracy in any space, both indoors and out. The AR system should be priced in a reasonable range for a typical consumer. The AR system should be easy for users to either hold up in front of them or wear on their head. The augmented view should also be updated in real-time with no latency by propagating the best estimate of the camera pose forward in time through a dynamics model.

The present invention can be used for a variety of purposes, such as robust navigation, augmented reality and/or 3-dimensional rendering. The invention can be used to enable accurate and robust navigation, including recovery of orientation, even in GNSS-denied environments (i.e., indoors or urban). In GNSS denied environments, the motion model of the system can be improved through the addition of measurements from an inertial measurement unit (IMU) including acceleration and angular rate measurements. The inclusion of an IMU aids in reducing the drift of the pose solution from the absolute reference in GNSS-denied environments. The highly accurate absolute pose provided by the invention can be used to overlay virtual objects into a camera's or user's field of view and accurately register these to the real-world environment. “Register” means how closely the system can place the virtual objects to their desired real-world pose. The invention can be used to accurately render digital representations of real-world objects by viewing the object to be rendered with a camera and moving around the object. “Accurately render” means that the size, shape, and global coordinates of the real objects are captured.

The present invention couples CDGPS with monocular visual simultaneous localization and mapping (SLAM). Visual SLAM is ideally situated as a complementary navigation technique to CDGPS-based navigation. This combination of navigation techniques is special in that neither one acting alone can observe globally-referenced attitude, but their combination allows globally-referenced attitude to be recovered. Visual SLAM alone provides high-accuracy relative pose in areas rich with nearby visually recognizable features. These nearby feature rich environments include precisely the environments where GPS availability is poor or non-existent. During periods of GPS availability, CDGPS can provide the reference to a global coordinate system that visual SLAM lacks. During periods of GPS unavailability, visual SLAM provides pose estimates that drift much more slowly, relative to absolute coordinates, than all but the highest-quality IMUs. An INS with an inexpensive IMU could be combined with this solution for additional robustness, particularly during periods of GPS unavailability to further reduce the drift of the pose estimates. This fusion of navigation techniques has the potential to satisfy the ultimate promise of AR.

One example of an application that would benefit from the AR system described above is construction. Currently, construction workers must carefully compare building plans with measurements on site to determine where to place beams and other structural elements, among other tasks. Construction could be expedited with the ability to visualize the structure of a building in its exact future location while building the structure. In particular, Shin identified 8 of 17 construction tasks in [8] that could be performed more efficiently by employing AR technologies.

Another potential application of this AR system is utility work. Utility workers need to identify existing underground structure before digging to avoid damaging existing infrastructure and prevent accidents that may cause injury. AR would enable these workers to “see” current infrastructure and easily avoid it without having to interpret schematics and relate that to where they are trying to dig.

There are many other interesting consumer applications in areas like gaming, social media, and tourism that could be enabled by a low-cost, general purpose AR platform providing robust, high-accuracy absolute pose of the camera. An ideal AR system would be usable for all these applications and could operate in any space, both indoors and out. Much like a smart-phone, the AR system could provide an application programming interface (API) that other application specific software could use to request pose information and push augmented visuals to the screen.

In contrast to other approaches that combine GPS and visual SLAM in a limited fashion, the present invention provides methods to fully fuse GPS and visual SLAM that would enable convincing absolute registration in any space, both indoors and out. One added benefit to this coupling is the recovery of absolute attitude without the use of an IMU. A sufficient condition for observability of the locations of visual features and the absolute pose of the camera without the use of an IMU is presented and proven. Several potential filter architectures are presented for combining GPS, visual SLAM, and an INS and the advantages of each are discussed. These filter architectures include an original filter-based visual SLAM method that is a modified version of the method presented by Mourikis et al. in [23].

In one embodiment, a filter that combines CDGPS, bundle-adjustment-based visual SLAM, and an INS is described which, while not optimal, is capable of demonstrating the potential of this combination of navigation techniques. A prototype AR system based on this filter is detailed and shown to obtain accuracy that would enable convincing absolute registration. With some modification to the prototype AR system so that visual SLAM is coupled tighter to the navigation system, this AR system could operate in any space, indoors and out. Further prototypes of the AR system could be miniaturized and reduced in cost with little effect on the accuracy of the system in order to approach the ideal AR system.

Unlike prior systems, the present invention allows for absolute position and attitude (i.e. pose) of a device to be determined solely from a camera and carrier-phase-based GNSS measurements. This combination of measurements is unique in that neither one alone can observe absolute orientation, but proper combination of these measurements allows for absolute orientation to be recovered. Moreover, no other technology has suggested coupling carrier-phase GNSS measurements with vision measurements in such a way that the absolute pose of the device can be recovered without any other measurements. Other techniques that fuse GNSS measurements and vision measurements are able to get absolute position (as the current invention does), but not absolute attitude as well. Thus, the current invention is significant in that it offers a way to recover absolute and precise pose from two, and only two, commonly-used sensors; namely, a camera and a GNSS receiver.

The current invention solves the problem of attaining highly-accurate and robust absolute pose with only a camera and a GNSS receiver. This technique can be used with inexpensive cameras and inexpensive GNSS receivers that are currently commercially available. Therefore, this technique enables highly-accurate and robust absolute pose estimation with inexpensive systems for robust navigation, augmented reality, and 3-Dimensional rendering.

The current invention has an advantage over other technologies because it can determine a device's absolute pose with only a camera and GNSS receiver. Other technologies must rely on other sensors (such as an IMU and magnetometer) to provide absolute attitude, and even then, this attitude is not as accurate due to magnetic field modeling errors and sensor drift.

In GNSS-denied environments, the system's estimated pose will drift with respect to the absolute coordinate frame. This limitation can be slowed but not eliminated with an inertial measurement unit (IMU). There is also a physical limitation imposed by the size of the GNSS antenna on how much the system can be miniaturized.

Coupled visual SLAM and GPS will now be discussed. In recent years, vision-aided inertial navigation has received much attention as a method for resolving the scale-factor ambiguity inherent to monocular visual SLAM. With the scale-factor ambiguity resolved, high-accuracy relative navigation has been achieved. This method has widely been considered an alternative to GPS based absolute pose techniques, which have problems navigating in urban canyons and indoors. Few researcher have coupled visual SLAM with GPS, and those who have only did so in a limited fashion.

These two complementary navigation techniques and inertial measurements can be coupled with the goal of obtaining highly accurate absolute pose in any area of operation, indoors and out. As will be described below, absolute pose can be recovered by combining visual SLAM and GPS alone. This combination of measurements is special in that neither one acting alone can observe absolute attitude, but their combination allows absolute attitude to be recovered. Estimation methods will also be described that details the unique aspects of the visual SLAM problem from an estimation standpoint. Estimation strategies are detailed and compared for the problems of stand-alone visual SLAM and coupled visual SLAM, GPS, and inertial sensors.

Consider a rigid body on which is rigidly mounted a calibrated camera. The body frame of the rigid body will be taken as the camera reference frame and denoted as C. Its origin and x and y axes lie in the camera's image plane; its z axis points down the camera bore-sight. A reference point x^{r}=[x^{r}, y^{r}, z^{r}]^{T} is fixed on the rigid body. When expressed in the camera frame, x^{r} is written

$${x}_{𝒞}^{r} = {[ {x}_{𝒞}^{r} , {y}_{𝒞}^{r} , {z}_{𝒞}^{r} ]}^{T}$$

and is constant. Consider a scene viewed by the camera that consists of a collection of M static point features in a local reference frame [symbol] . The jth point feature has constant coordinates in frame

$$ℒ \text{:} {x}_{ℒ}^{{p}_{j}} = [ {x}_{ℒ}^{{p}_{j}} , {y}_{ℒ}^{{p}_{j}} , {z}_{ℒ}^{{p}_{j}} ] .$$

The camera moves about the static point features and captures N keyframes, which are images of the M point features taken from distinct views of the scene. A distinct view is defined as a view of the scene from a distinct location. Although not required by the definition, these distinct views may also have differing attitude so long as the M point features remain in view of the camera. Each keyframe has a corresponding reference frame [symbol] ᵢ, which is defined to be aligned with the camera frame at the instant the image was taken, and image frame [symbol] ᵢ, which is defined as the plane located 1 m in front of the camera lens and normal to the camera bore-sight. It is assumed that the M point features are present in each of the N keyframes and can be correctly and uniquely identified.

To determine the projection of the M point features onto the image frames of the N keyframes, the point features are first expressed in each [symbol] ᵢ. This operation is expressed as follows:

[symbol]

=R( [symbol] )( [symbol] − [symbol] ), for i=1,2, . . . ,N & j=1,2, . . . ,M (1)

where [symbol] is the quaternion representation of the attitude of the camera for the ith keyframe relative to the [symbol] frame, R(•) is the rotation matrix corresponding to the argument, and [symbol] is the position of the origin of the camera (hereafter the camera position) for the ith keyframe expressed in the [symbol] frame. For any attitude representation, [symbol] represents a rotation from the [symbol] frame to the [symbol] frame.

A camera projection function p(•) converts a vector expressed in the camera frame [symbol] ᵢ into a two-dimensional projection of the vector onto the image frame [symbol] ᵢ as:

$${s}_{{𝒥}_{i}}^{{p}_{j}} = [ \begin{matrix}{α}_{{𝒥}_{i}}^{{p}_{j}} \\ {β}_{{𝒥}_{i}}^{{p}_{j}}\end{matrix} ] = p ( {x}_{{𝒞}_{i}}^{{p}_{j}} ) , for i = 1 , 2 , … , N \& j = 1 , 2 , … , M \qquad ( 2 )$$

The set of these projected coordinates for each point feature and each keyframe constitute the measurements provided by a feature extraction algorithm operating on these keyframes.

Suppose that, in addition to these local measurements, measurements of the position of the reference point on the rigid body are provided in a global reference frame [symbol] at each keyframe, denoted as [symbol] . The position of the reference point in [symbol] is related to the pose of the camera through the equation:

[symbol]

= [symbol] +R( [symbol] ) [symbol] , for i=1,2, . . . ,N (3)

The local frame [symbol] is fixed with respect to [symbol] and is related to [symbol] by a similarity transform. A vector expressed in [symbol] can be expressed in [symbol] through the equation:

[symbol]

=λR( [symbol] )( [symbol] + [symbol] ) (4)

where [symbol] , [symbol] and λ are the translation, rotation, and scale-factor that characterize the similarity transform from [symbol] to [symbol] .

The globally-referenced structure from motion problem can be formulated as follows: Given the measurements [symbol] and [symbol] for i=1, 2, . . . , N and j=1, 2, . . . M, estimate the camera pose for each frame (parameterized by [symbol] and [symbol] for i=1, 2, . . . , N), the location of each point feature ( [symbol] for j=1, 2, . . . , M), and the similarity transform relating [symbol] and [symbol] (parameterized by [symbol] , [symbol] and λ).

The goal of the following analysis is to define a set of sufficient conditions under which these quantities are observable. To start, the projection function from Eq. 2 is taken to be a perspective projection and weak local observability is tested. A proof of weak local observability only demonstrates that there exists a neighborhood around the true value inside which the solution is unique, but not necessarily a globally unique solution. Stronger observability results are then proven under the more restrictive assumption that the projection is orthographic.

A perspective projection, also known as a central projection, projects a view of a three-dimensional scene onto an image plane through rays connecting three-dimensional locations and a center of projection. This is the type of projection that results from a camera image. A perspective projection can be expressed mathematically, assuming a calibrated camera, as:

$$p ( {x}_{𝒞} ) = \frac{1}{{z}_{𝒞}} [ \begin{matrix}{x}_{𝒞} \\ {y}_{𝒞}\end{matrix} ] \qquad ( 5 )$$

To demonstrate weak local observability, the measurements from Eqs. 2 and 3 were linearized about the true values of the camera poses and the feature locations in [symbol] . The resulting matrix was tested for full column rank under a series of scenarios. This test is a necessary and sufficient condition for weak local observability, which means the solution is unique within a small neighborhood about the true values of the quantities to be estimated but not necessarily globally unambiguous.

The weak local observability tests revealed that with as few as three keyframes of three point features the problem is fully locally observable provided the following conditions are satisfied: (1) The three feature points are not collinear; (2) The positions of the camera for each frame are not collinear; and (3) The positions of the reference point for each frame are not collinear.

An orthographic projection projects a view of a three-dimensional scene onto an image plane through rays parallel to the normal of the image plane. Although this projection does not describe how images are formed in a camera, this is a good approximation to a perspective projection in a small segment of the image, so long as the distance from the camera to the point features is much larger than the distance between the point features [34]. An orthographic projection can be expressed mathematically as:

$$p ( {x}_{𝒞} ) = [ \begin{matrix}{x}_{𝒞} \\ {y}_{𝒞}\end{matrix} ] \qquad ( 6 )$$

A theorem for global observability of this problem can be stated as follows:
Theorem 2.1.1. Assume that p(•) represents an orthographic projection. Given [symbol] and [symbol] for M=4 non-coplanar point features and N=3 distinct keyframes such that the [symbol] are not collinear and the [symbol] are not collinear, the similarity transform between [symbol] and [symbol] and the quantities [symbol] , [symbol] , and [symbol] for i=1, 2, 3 and j=1, 2, 3, 4 can be uniquely determined.

To prove Theorem 2.1.1, consider the structure from motion (SFM) theorem given as:

Given three distinct orthographic projections of four non-coplanar points in a rigid configuration, the structure and motion compatible with the three views are uniquely determined up to a reflection about the image plane [35].
The reflection about the image plane can be discarded, as it exists behind the camera. Thus, the SFM theorem states that a unique solution for [symbol] , [symbol] , and [symbol] can be found using only [symbol] for i=1, 2, 3 and j=1, 2, 3, 4. The SFM theorem was proven by Ullman using a closed-form solution procedure [35].

The remainder of Theorem 2.1.1 is proven using the closed-form solution for finding a similarity transformation presented by Horn in [36]. Horn demonstrated that the similarity transform between two coordinate systems can be uniquely determined based on knowledge of the location of three non-collinear points in both coordinate systems. In the case of Theorem 2.1.1, this result allows the similarity transform between [symbol] and [symbol] to be recovered from the three locations of the reference point in the two frames, since the locations [symbol] for i=1, 2, 3 are given and the reference points [symbol] can be computed from:

[symbol]

= [symbol] +R( [symbol] )^{T} [symbol] , for i=1,2,3 (7)

Theorem 2.1.1 provides a sufficient condition for global observability of the locations of the point features and the pose of the camera in [symbol] . This demonstrates that absolute pose can be recovered from the coupling of GPS, which provides the measurements of [symbol] , and visual SLAM in spite of neither being capable of determining absolute attitude alone. Interestingly, this means that an AR system that fully couples GPS and visual SLAM does not need to rely on an IMU for absolute attitude. This system would therefore not be susceptible to disturbances in the magnetic field, which can cause large pointing errors in the magnetometers in IMUs.

While the conditions specified in Theorem 2.1.1 are sufficient, they are certainly not necessary. Ullman mentions in his proof of the SFM theorem that under certain circumstances a unique solution still exists even if the four point features are coplanar [35]. The inclusion of GPS measurements may also have an effect on the required conditions for observability. While the weak local observability results from above do not prove the existence of a globally unambiguous solution, the results suggest that it may be possible to get by with just three point features. However, the present invention employs visual SLAM algorithms that track hundreds or even thousands of points, so specifying the absolute minimum conditions under which a solution exists is not of concern.

The optimal approach to any causal estimation problem would be to gather all the measurements collected up to the current time and produce an estimate of the state from this entire batch by minimizing a cost function whenever a state estimate is desired [37]. The most commonly employed cost function is the weighted square of the measurement error in which case the estimation procedure is referred to as least-squares. In the case of linear systems, the batch least-squares estimation procedure simply involves gathering the measurements into a single matrix equation and performing a generalized matrix inversion [38]. In the case of nonlinear systems, the batch least-squares estimation procedure is somewhat more involved. Computation of the nonlinear least-squares solution typically involves linearization of the measurements about the current best estimate of the state, performing a generalized matrix inversion, and iteration of the procedure until the estimate settles on a minimum of the cost function [38]. While this approach is optimal, it often becomes enormously computationally intensive as more measurements are gathered and is thus often impractical for real-time applications.

This issue led to the development of the Kalman filter [39, 40], which is also optimal for linear systems where all noises are white and Gaussian distributed. The Kalman filter is a sequential estimation method that summarizes the information gained up to the current time as a multivariate Gaussian probability distribution. This development eliminated the need to process all the measurements at once, thus providing a more computationally-efficient process for real-time estimation.

The use of the Kalman filter was later extended to nonlinear systems by linearizing the system about the current best estimate of the state, as was done for the batch solution procedure. This method was coined the extended Kalman filter (EKF). However, errors in the linearization applied by the EKF cause the filter to develop a bias and make the filter sub-optimal [41]. Iteration over the measurements within a certain time window can be performed to reduce the resulting bias without resorting to a batch process over all the measurements [41]. However, it is typically assumed that the linearization is close enough that these errors are small and this small bias is acceptable in order to enable real-time estimation. Non-Gaussianity can also be a problem with EKFs due to propagation of the distribution through nonlinear functions. Other filtering methods have also been developed to better handle issues of non-Gaussianity caused by nonlinearities [42, 43].

As explained previously, batch estimation methods are typically dismissed in favor of sequential methods for real-time application because of the inherent computational expense of batch solutions. However, the unique nature of visual SLAM makes batch estimation appealing even for real-time application [44]. These unique aspects of the visual SLAM problem are:

High Dimensionality: The images on which visual SLAM operates inherently have high dimensionality. Each image has hundreds or thousands of individual features that can be identified and tracked between images. These tracked features each introduce their own position as parameters that must be estimated in order for the features to be used for navigation. If all of the hundreds or thousands of image features from all the images in a video stream are to be used for navigating, then the problem quickly becomes infeasible for real-time applications based on computational requirements even for a sequential estimation method. Therefore, compromises must be made regarding either the number of features tracked, the frame rate, or both. This compromise is different for batch and sequential estimators; this point will be explained in detail in below.

Inherent Sparsity: Linearized measurement equations in the visual SLAM problem have a banded structure in the columns corresponding to the feature locations when measurements taken from multiple frames are processed together. Sparse matrix structures such as this result in drastic computational savings when properly exploited. This inherent sparsity collapses if one tries to summarize data as in a recursive estimator.

Superfluity of Dynamic Constraints: While dynamic constraints on the camera poses from different frames do provide information to aid in estimation, this additional information is unnecessary for visual SLAM and may not be as valuable as preserving sparsity. Removing these dynamic constraints creates a block diagonal structure in the linearized measurement equations for a batch estimator in the columns corresponding to the camera poses. This sparse structure can be exploited by the batch estimator for additional computational savings. Thus, more features can be tracked by the batch estimator for the same computational expense by ignoring dynamic constraints.

Spatial Correlation: Since visual features must be in view of the camera to be useful for determining the current camera pose, past images that no longer contain visual features currently in view of the camera provide little or no information about the current camera pose. Thus, the images with corresponding camera poses and features that are not in the neighborhood of the current camera pose can be removed from the batch estimation procedure, reducing the size of both the state vector and the measurement vector in a batch solution procedure.

Two primary methodologies have been applied to the visual SLAM problem; each addresses the constraint of limited computational resources in fundamentally different ways. These methodologies are filter-based visual SLAM and bundle-adjustment-based visual SLAM. Each of these methods and the concessions made to reduce their computational expense are described below.

Filter-based visual SLAM employs a sequential-type estimator that marginalizes out past camera poses and the corresponding feature measurements by summarizing the information gained as a multi-variate probability distribution (typically Gaussian) of the current pose. For most problems, this marginalization of past poses maintains a small state vector and prevents the computational cost of the filter from growing. This is not the case for visual SLAM where each image could add many new features whose location must be estimated and maintained in the state vector.

Typical filter-based visual SLAM algorithms have computational complexity that is cubic with the number of features tracked due to the need for adding the feature locations to the state vector and propagating the state covariance through the filter [37]. To reduce computational expense, filter-based visual SLAM imposes limits on the number of features extracted from the images, thus preventing the state vector from becoming too large. Examples of implementations of filter-based visual SLAM can be found in [23-26].

Mourikis Method Of the filter-based visual SLAM methods reported in literature, the method designed by Mourikis et al. [23] is of particular interest. Mourikis created a measurement model for the feature measurements that expresses these measurements in terms of constraints on the camera poses for multiple images or frames. This linearized measurement model for a single feature over multiple frames is expressed as:

$$\begin{matrix}{z}_{{p}_{j}} = {s}^{{p}_{j}} - {\hat{s}}^{{p}_{j}} \\ {{= \frac{\partial {s}^{{p}_{j}}}{\partial X} ]}_{\overline{X} , {\overline{x}}^{{p}_{j}}} δ X + \frac{\partial {s}^{{p}_{j}}}{\partial {x}^{{p}_{j}}} ]}_{\overline{X} , {\overline{x}}^{{p}_{j}}} δ {x}^{{p}_{j}} + {w}_{{p}_{j}} \\ = {H}_{{p}_{j} , X} δ X + {H}_{{p}_{j} , {x}^{{p}_{j}}} δ {x}^{{p}_{j}} + {w}_{{p}_{j}}\end{matrix} \qquad ( 8 )$$

where spj is formed by stacking the feature measurements [symbol] from Eq. 2 for each frame being processed, X is the state vector which includes the camera poses for the frames being processed, ŝ^{p}^{ⱼ} is the expected value of the feature measurements based on the a priori state X̅, δX and δx^{p}^{ⱼ} are the errors in the a priori state and feature location respectively, and wₚ_{ⱼ} is white Gaussian measurement noise with a diagonal covariance matrix. The estimate of the feature location x^{p}^{ⱼ} is simply computed from the feature measurements and camera pose estimates from other frames that were not used in Eq. 8, but have already been collected and added to the state.

The measurement model in Eq. 8, however, still contains the error in the estimated feature locations. To obtain a measurement model that contains only the error in the state, Mourikis transformed Eq. 8 by left multiplying by a matrix, Aₚ_{ⱼ}^{T}, that spans the left null space of Hₚⱼₓpⱼ to obtain:

Aₚ_{ⱼ}^{T}zₚ_{ⱼ}=z′ₚ_{ⱼ}=Hₚ_{ⱼ}_{,x}′δX+wₚ_{ⱼ}′ (9)

This operation reduces the number of equations from 2N_{f}, where N_{f} is the number of frames used in Eq. 8, to 2N_{f}−3, since the rank of Hₚ_{ⱼ}ₓpⱼ is 3. This assumes that N_{f}>1, since the null space of Hₚ_{ⱼ}ₓpⱼ would be empty otherwise. The remaining 3 equations, which are thrown out, are of the form:

H^{T}ₚⱼₓpⱼ zₚⱼ=zₚⱼ^{r}=H_{pj,X}^{r} [symbol] X+ [symbol] ^{r}δx^{pj}+wₚⱼ^{r} (10)

Since no guarantee can be made that Hₚ_{ⱼ}_{,X}^{r} in Eq. 10 will be zero, this procedure sacrifices information about the state by ignoring these 3 equations.

Therefore, the Mourikis implementation does not require the feature positions to be added to the state, but requires a limited number of camera poses to be added to the state instead. Once a threshold on the number of camera poses in the state is reached, a third of the camera poses are marginalized out of the state after processing the feature measurements associated with those frames using Eq. 9. This approach has computational complexity that is only linear with the number of features, but is cubic with the number of camera poses in the state. The number of camera poses maintained in the state can be made much smaller than the number of features, so this method is significantly more computationally efficient than traditional filter based visual SLAM. Thus, this method allows more features to be tracked than with traditional filter-based visual SLAM for the same computational expense.

Modified Mourikis Method: The Mourikis method has the undesirable qualities that (1) it throws away information that could be used to improve the state estimate, and (2) the measurement update cannot be performed on a single frame. These drawbacks can be eliminated by recognizing that the feature locations are simply functions of the camera poses from the state in this method. This means that the error in the feature location can be expressed as:

$${δ {x}^{{p}_{j}} = \frac{\partial {x}^{{p}_{j}}}{\partial X} ]}_{\overline{X}} δ X \qquad ( 11 )$$

These partial derivatives are quite complex and may need to be computed numerically. This allows the measurement equations to be expressed entirely in terms of the state vector by substituting Eq. 11 into Eq. 8, so no information needs to be discarded and the measurement update can be performed using a single frame.

This modified version of the Mourikis method has a state vector that can be partitioned into two sections. The first portion of the state contains the current camera pose. The second portion of the state contains the camera poses for frames that are specially selected to be spatially diverse. These specially selected frames are referred to as keyframes.

Measurements from the keyframes are used to compute the estimates of the feature locations and are not processed by the filter. The estimates of the feature locations can be updated in a thread separate from the filter whenever processing power is available using the current best estimate of the keyframe poses from the state vector. New features are also identified in the keyframes as allowed by available processing power. This usage of keyframes is inspired by the bundle-adjustment-based visual SLAM algorithm developed by Klein and Murray [45], which will be detailed below.

When a new frame is captured, this method first checks if this frame should be added to the list of keyframes. If so, then the current pose is appended to the end of the state vector and the measurements from the frame are not processed by the filter. Otherwise, the linearized measurement equations are formed from Eqs. 8 and 11 and used to update the state.

To prevent the number of keyframes from growing without bound, the keyframes are removed from the state whenever the system is no longer in the neighborhood where the keyframe was taken. This condition can be detected by a set of heuristics that compare the keyframe pose and the current pose of the system to see if the two are still close enough to keep the keyframe in the state. When a keyframe is removed, the current best estimate and covariance of the associated pose and the associated measurements can be saved for later use. If the system returns to the neighborhood again, then the keyframes from that neighborhood can be reloaded into the state. This should enable loop closure, which most visual SLAM implementations have difficulty accomplishing.

Bundle-adjustment-based visual SLAM, in contrast to filter-based visual SLAM, does not marginalize out the past poses. Bundle Adjustment (BA) is a batch nonlinear least-squares algorithm that collects measurements of features from all of the frames collected and processes them together. Implementing this process as a batch solution allows the naturally sparse structure of the visual SLAM problem to be exploited and eliminates the need to compute state covariances. This allows BA to obtain computational complexity that is linear in the number of features tracked [44, 46].

This approach is optimal, but computing global BA solutions for visual SLAM is a computationally intensive process that cannot be performed at the frame-rate of the camera. As such, BA-based visual SLAM only selects certain “keyframes” to incorporate into the global BA solution, which is computed only occasionally or as processing power is available [37]. Pose estimates for each frame can then be computed directly using the feature positions obtained from the global BA solution and the measured feature coordinates in the image. BA-based visual SLAM typically does not compute covariances, which are not required for BA and would increase the computational cost significantly.

Parallel Tracking and Mapping: The predominant BA-based visual SLAM algorithm was developed by Klein and Murray [45] and is called parallel tracking and mapping (PTAM). PTAM is capable of tracking thousands of features and estimating relative pose up to an arbitrary scale-factor at 30 Hz frame-rates on a dual-core computer. PTAM is divided into two threads designed to operate in parallel. The first thread is the mapping thread, which performs BA to compute a map of the environment and identifies new point features in the images. The second thread is the tracking thread, which identifies point features from the map in new frames, computes the camera pose for the new frames, and determines if new frames should be added to the list of keyframes or discarded. PTAM is only designed to operate in small workspaces, but can be adapted to larger workspaces by trimming the map in the same way described for the modified Mourikis method above.

The two methodologies for visual SLAM, filter-based and BA-based, have been discussed, but the question remains as to which approach gives the best performance for visual SLAM. Filter-based visual SLAM has the advantage of processing every camera frame, but imposes severe limits on the number of point features tracked due to cubic computational complexity. The modified Mourikis method attains linear computational complexity with the number of tracked features, but has cubic computational complexity with the number of poses in the state. Filter-based methods also suffer from linearization errors during the marginalization of frames. BA-based visual SLAM has several advantages over filter-based visual SLAM including linear computational complexity in the number of tracked features and the elimination of linearization errors through iteration over the entire set of data, but must reduce the number of frames incorporated into the batch processing to achieve real-time operation.

TABLE 1
Ranking of Visual SLAM Methodologies

| Estimator | | | | Computational |
|---|---|---|---|---|
| Type | Methodology | Accuracy | Robustness | Efficiency |
| Batch | Bundle Adjustment | 1 | 1 | 1 |
| Sequential | Traditional SLAM | 3 | 3 | 3 |
| | Modified Mourikis | 2 | 2 | 2 |

Strasdat et al. performed a comparative analysis of the performance of both visual SLAM methodologies which revealed that BA-based visual SLAM is the optimal choice based on the metric of accuracy per computational cost [37]. The primary argument that Strasdat et al. present was that accuracy is best increased by tracking more features. Their results demonstrated that after adding a few keyframes from a small region of operation only extremely marginal benefit was obtained by adding more frames. Based on this fact, BA was able to obtain better accuracy per computational cycle than the filter due to the difference in computational complexity with the number of features tracked. Strasdat et al. did not consider any method like the modified Mourikis method in their analysis, which would have significant improvements in accuracy per computational cost over traditional filter-based methods. However, there is no reason to expect the modified Mourikis method would outperform BA. To summarize this analysis, Table 1 shows a ranking of these methods for the metrics of accuracy, robustness, and computational efficiency.

Now consider adding GPS and inertial measurements to the visual SLAM problem. The addition of GPS measurements links the pose estimate to a global coordinate system, as proven above. Inertial measurements from a three-axis accelerometer and a three-axis gyro help to smooth out the solution between measurement updates and limit the drift of this global reference during periods when GPS is unavailable.

Although BA proved to be the optimal method for visual SLAM alone, this may not be the case for combined visual SLAM, GPS, and inertial sensors. Filtering is generally the preferred technique for navigating with GPS and inertial sensors for good reason. Inertial measurements are typically collected at a rate of 100 Hz or greater to accurately reconstruct the dynamics of the system between measurements. Taking inertial measurements much less frequently would defeat the purpose of having the measurements, so they should not be ignored to reduce the number of measurements. The matrices resulting from a combined GPS and inertial sensors navigation system are also not sparse like in visual SLAM, so the computational efficiency associated with sparseness cannot be exploited. This means that a solely batch estimation algorithm is computationally infeasible for this problem. Therefore, a hybrid batch sequential or entirely sequential method that obtains high accuracy and robustness with low computational cost is desired.

One potential method for coupling these navigation techniques is to process the keyframes using BA and process the measurements from the other frames, GPS, and inertial sensors through a filter without adding the feature locations to the filter state. Specifically, BA would estimate the feature locations and keyframe poses based on the visual feature measurements from the keyframes and a priori keyframe pose estimates provided by the filter. Adding these a priori keyframe pose estimates to the BA cost function does not destroy sparseness because the a priori keyframe poses are represented as independent from one another. The BA solution for the feature locations will also be expressed in the same global reference frame as the a priori keyframe pose estimates. The filter would process all GPS measurements in a standard fashion and use the inertial measurements to propagate the state forward in time between measurements. Frames not identified as keyframes would also be processed by the filter using the estimated feature locations from BA.

An important detail in this approach is precisely how the feature locations from BA are used to process the non-keyframes in the filter. Using the BA estimated feature locations in the filter measurement equations without representing their covariance will cause issues with the filter covariance estimate being overly optimistic. This overly optimistic covariance will then feed back into BA whenever a new keyframe is added and could cause divergence of the estimated pose. This is clearly unacceptable, so the covariance of the estimated feature locations should be computed for use in the filter. However, computing this covariance matrix can only be done at considerable computational expense, which cuts against the main benefit of using BA. To reduce the computational load of computing these covariance matrices in BA, the covariance matrix of each individual feature may be computed efficiently by ignoring cross-covariances between camera poses and other features. This approximation will be somewhat optimistic, but this could be accounted for by slightly inflating the measurement noise.

By separating the estimation of the feature locations and keyframe poses from the filter, the coupling between the current state, keyframe poses, and feature measurements is not fully represented. The estimator essentially ignores the cross-covariances between these quantities. This prevents GPS and IMU measurements from aiding BA, except by providing a better a priori estimate of the keyframe poses. While this feature of the estimator is undesirable, it may not significantly degrade performance.

Another approach to this problem would be to transition entirely to a filter implementation, which allows full exploitation of the coupling between the states. One could implement this approach using either the traditional visual SLAM approach or the modified Mourikis method for visual SLAM presented above. The filter would process all GPS measurements in a standard fashion and use the inertial measurements to propagate the state forward in time between measurements. However, the traditional visual SLAM approach has no benefits over the modified Mourikis method and has much greater computational cost, so there is no advantage to considering it here.

Table 2 shows an incomplete ranking of a full batch solution, the hybrid batch-sequential method employing BA for visual SLAM, and the entirely sequential approach employing the modified Mourikis method for visual SLAM. While the computational complexity for all the methods is known, the accuracy and robustness of the two proposed methods are unknown at this time. The hybrid method using BA has the advantage of being able to track more features and maintain more keyframes for the same computational cost compared to the sequential method, though this advantage is somewhat diminished by the need to compute a covariance matrix. On the other hand, the hybrid method does not represent the coupling between the current state, the keyframe poses, and the feature locations and thus sacrifices this information for computational efficiency. The sequential method properly accounts for this coupling.

TABLE 2
Ranking of Combined Visual SLAM, GPS, and Inertial Sensors
Methodologies

| Estimator | | | | Computational |
|---|---|---|---|---|
| Type | Methodology | Accuracy | Robustness | Efficiency |
| Batch | Full Batch | 1 | 1 | 3 |
| Sequential | BA SLAM + Filter | ? | ? | 1 |
| | Modified Mourikis | ? | ? | 2 |

It is difficult to tell which method will perform better for the same computational cost without implementing and testing these methods. The following discussion presents a navigation filter and prototype AR system that implements a looser coupling of these navigation techniques as a first step towards the goal of implementing the methodologies discussed herein.

Assuming a mobile AR system with internet access is given that rigidly connects a GPS receiver, a camera, and an IMU, a navigation system estimating absolute pose of the AR system can be designed that couples CDGPS, visual SLAM, and an INS. Potential optimal strategies for fusing measurements from these navigation techniques were discussed previously. These strategies, however, all require a tighter coupling of the visual SLAM algorithm with the GPS observables and inertial measurements than can be obtained using stand-alone visual SLAM software. Thus, these methods necessitate creation of a new visual SLAM algorithm or significant modification to an existing stand-alone visual SLAM algorithm. In keeping with a staged developmental approach, the prototype system whose results are reported herein implements a looser coupling of the visual SLAM algorithm with the GPS observables and inertial measurements. In particular, the discussion herein instead considers a navigation filter that employs GPS observables measurements, IMU accelerometer measurements and attitude estimates, and relative pose estimates from a stand-alone visual SLAM algorithm. While this implementation does not allow the navigation system to aid visual SLAM, it still demonstrates the potential of such a system for highly-accurate pose estimation. Additionally, the accuracy of both globally-referenced position and attitude are improved over a coupled CDGPS and INS navigation system through the incorporation of visual SLAM in this framework.

The measurement and dynamics models that are used in creating a navigation filter will now be described. An overview of the navigation system developed herein will be described that includes a block diagram of the overall system and the definition of the state vector of the filter. Next, the measurement models for the GPS observables, IMU accelerometer measurements and attitude estimates, and visual SLAM relative pose estimates are derived and linearized about the filter state. Finally, the dynamics models of the system both with and without accelerometer measurements from the IMU are presented.

The navigation system presented herein is an improved version of that presented in [47]. This prior version of the system did not incorporate visual SLAM measurements nor did it represent attitude estimates properly in the filter. The navigation system described herein utilizes five different reference frames. These reference frames are: (1) Earth-Centered, Earth-Fixed (ECEF) Frame; (2) East, North, Up (ENU) Frame; (3) Camera (C) Frame; (4) Body (B) Frame; and (5) Vision (V) Frame.

The Earth-Centered, Earth-Fixed (ECEF) Frame is one of the standard global reference frames whose origin is at the center of the Earth and rotates with the Earth. The East, North, Up (ENU) Frame is defined by the local east, north, and up directions which can be determined by simply specifying a location in ECEF as the origin of the frame. The Camera (C) Frame is centered on the focal point of the camera with the z-axis pointing down the bore-sight of the camera, the x-axis pointing toward the right in the image frame, and the y-axis completing the right-handed triad. The Body (B) Frame is centered at a point on the AR system and rotates with the AR system. This reference frame is assigned differently based on the types measurements employed by the filter. When INS measurements are present, this frame is centered on the IMU origin and aligned with the axes of the IMU to simplify the dynamics model given below. If there are visual SLAM measurements and no INS measurements, then this frame is the same as the camera frame. This is the most sensible definition of the body frame, since estimating the camera pose is the goal of this navigation filter. If only GPS measurements are present, then this frame is centered on the phase center of the mobile GPS antenna because attitude cannot be determined by the system. The Vision (V) Frame is arbitrarily assigned by the visual SLAM algorithm during initialization. The vision frame is related to ECEF by a constant, but unknown, similarity transform—a combination of translation, rotation, and scaling.

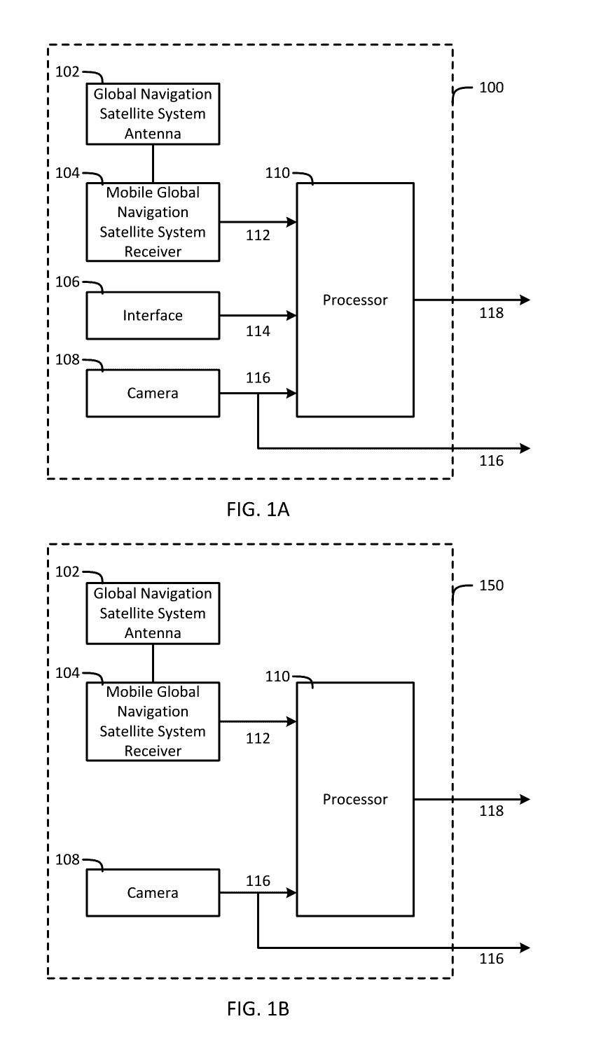

Now referring to FIGS. 1A and 1B, block diagrams of an apparatus (navigation system) 100 and 150 in accordance with two embodiments of the present invention are shown. The apparatus 100 in FIG. 1A uses an interface that provides a second set of carrier-phase measurements, in part, to determine the absolute position and absolute attitude of the apparatus 100. In contrast, the apparatus 150 in FIG. 1B uses a precise orbit and clock data for the global navigation satellite system, in part, to determine the absolute position and absolute attitude of the apparatus 150.

FIG. 1A shows a block diagram of an apparatus (navigation system) 100 in accordance with one embodiment of the present invention. The navigation system 100 includes a first global navigation satellite system antenna 102, a mobile global navigation satellite system receiver 104 connected to the first global navigation satellite system antenna 102, an interface 106, a camera 108 and a processor 110 communicably coupled to the mobile global navigation satellite system receiver 104, the interface 106 and the camera 108. The mobile global navigation satellite system receiver 104 produces a first set of carrier-phase measurements 112 from a global navigation satellite system (not shown). The interface 106 (e.g., a wired network interface, wireless transceiver, etc.) receives a second set of carrier-phase measurements 114 based on a second global navigation satellite system antenna (not shown) at a known location from the global navigation satellite system (not shown). The global navigation satellite system can be a global system (e.g., GPS, GLONASS, Compass, Galileo, etc.), regional system (e.g., Beidou, DORIS, IRNSS, QZSS, etc.,), national system, military system, private system or a combination thereof. The camera 108 produces an image 116 and can be a video camera, smart-phone camera, web-camera, monocular camera, stereo camera, or camera integrated into a portable device. Moreover, the camera 108 can be two or more cameras. The processor 110 determines an absolute position and an attitude (collectively 118) of the apparatus 100 solely from three or more sets of data and a rough estimate of the absolute position of the apparatus without any prior association of visual features with known coordinates. Each set of data includes the image 116, the first set of carrier-phase measurements 112, and the second set of carrier-phase measurements 114.

The processor 110 may also use a prior map of visual features to determine the absolute position and attitude 118 of the apparatus 100. The rough estimate of the absolute position of the apparatus 100 can be obtained using a first set of pseudorange measurements from the mobile global navigation satellite system receiver 104 in each set of data, or using both the first set of pseudorange measurements and a second set of pseudorange measurements from the second global navigation satellite system antenna (not shown). The rough estimate of the absolute position of the apparatus 100 may also be obtained using a prior map of visual features, a set of coordinates entered by a user when the apparatus 100 is at a known location, a radio frequency finger-printing, or a cell phone triangulation. The first set and second set of carrier-phase measurements 112 and 114 can be from two or more global navigation satellite systems. Moreover, the first set and second set of carrier-phase measurements 112 and 114 can be from signals at two or more different frequencies. The interface 106 can be communicably coupled to communicably coupled to the global navigation satellite system receiver at a known location via a cellular network, a wireless wide area wireless network, a wireless local area network or a combination thereof.

FIG. 1B shows a block diagram of an apparatus (navigation system) 150 in accordance with one embodiment of the present invention. The navigation system 150 includes a global navigation satellite system antenna 102, a mobile global navigation satellite system receiver 104 connected to the global navigation satellite system antenna 102, a camera 108 and a processor 110 communicably coupled to the mobile global navigation satellite system receiver 104 and the camera 108. The mobile global navigation satellite system receiver 104 produces a set of carrier-phase measurements 112 from a global navigation satellite system (not shown) with signals at multiple frequencies. The global navigation satellite system can be a global system (e.g., GPS, GLONASS, Compass, Galileo, etc.), regional system (e.g., Beidou, DORIS, IRNSS, QZSS, etc.,), national system, military system, private system or a combination thereof. The camera 108 produces an image 116 and can be a video camera, smart-phone camera, web-camera, monocular camera, stereo camera, or camera integrated into a portable device. Moreover, the camera 108 can be two or more cameras. The processor 110 determines an absolute position and an attitude (collectively 118) of the apparatus 150 solely from three or more sets of data, a rough estimate of the absolute position of the apparatus 150 and a precise orbit and clock data for the global navigation satellite system without any prior association of visual features with known coordinates. Each set of data includes the image 116 and the first set of carrier-phase measurements 112.

The processor 110 may also use a prior map of visual features to determine the absolute position and attitude 118 of the apparatus 100. The rough estimate of the absolute position of the apparatus 150 can be obtained using a first set of pseudorange measurements from the mobile global navigation satellite system receiver 104 in each set of data. The rough estimate of the absolute position of the apparatus 150 may also be obtained using a prior map of visual features, a set of coordinates entered by a user when the apparatus 100 is at a known location, a radio frequency finger-printing, or a cell phone triangulation.

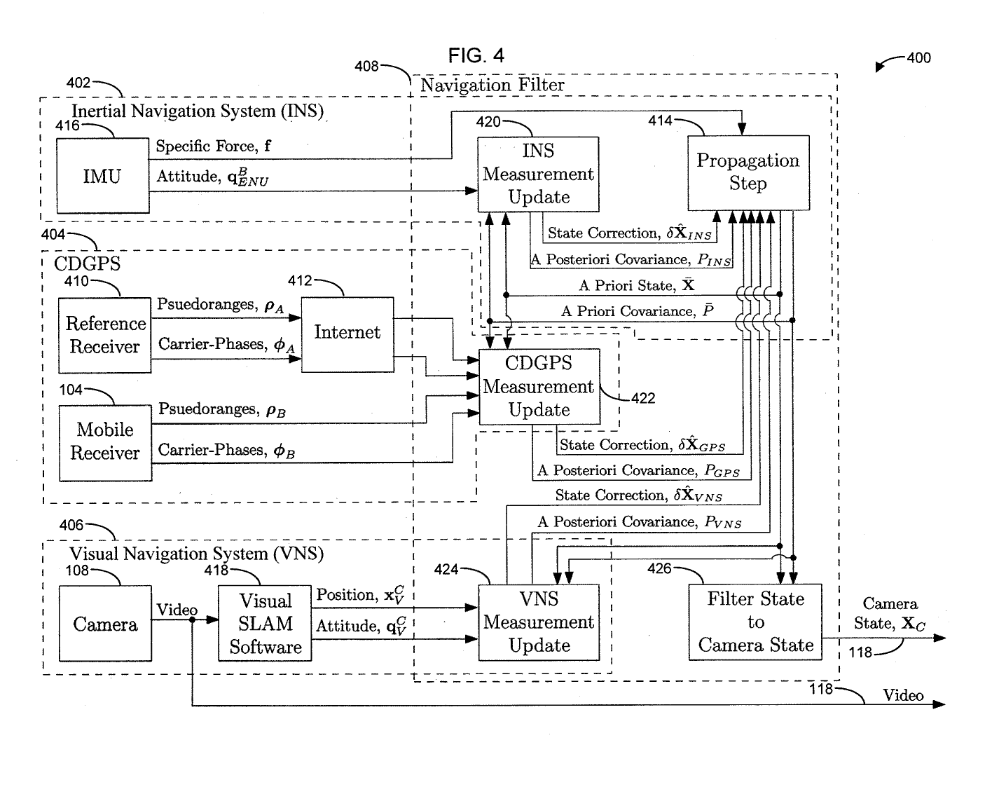

With respect to FIGS. 1A and 1B and as will be explained in reference to FIG. 4, the navigation system 100 and 150 may also include: (1) a visual simultaneous localization and mapping module (not shown) communicably coupled between the camera 108 and the processor 110, and/or (2) an inertial measurement unit (not shown) (e.g., a single-axis accelerometer, a dual-axis accelerometer, a three-axis accelerometer, a three-axis gyro, a dual-axis gyro, a single-axis gyro, a magnetometer, etc.) communicably coupled to the processor 110. The inertial measurement unit may also include a thermometer.

In addition, the processor 110 may include a propagation step module, a global navigation satellite system measurement update module communicably coupled to the mobile global navigation satellite system receiver 104, the interface 106 (FIG. 1A only) and the propagation step module, a visual navigation system measurement update module communicably coupled to the camera 108 and the propagation step module, and a filter state to camera state module communicably coupled to the propagation step module that provides the absolute position and attitude 118. The processor 110 may also include a visual simultaneous localization and mapping module communicably coupled between the visual navigation system measurement update module and the camera 108. In addition, an inertial measurement unit can be communicably coupled to the propagation step module, and an inertial navigation system update module can be communicably coupled to the inertial measurement unit, the propagation step module and the global navigation satellite system measurement update module.

The navigation system 100 may include a power source (e.g., battery, solar panel, etc.) connected to the mobile global navigation satellite system receiver 104, the camera 108 and the processor 110. A display (e.g., a computer, a display screen, a lens, a pair of glasses, a wrist device, a handheld device, a phone, a personal data assistant, a tablet, etc.) can be electrically connected or wirelessly connected to the processor 110 and the camera 108. The components will typically be secured together using a structure, frame or enclosure. Moreover, the mobile global navigation satellite system receiver 104, the interface 106 (FIG. 1A only), the camera 108 and the processor 110 can be integrated together into a single device.

The processor 110 is capable of operating in a post-processing mode or a real-time mode, providing at least centimeter-level position and degree-level attitude accuracy in open outdoor locations. In addition, the processor 110 can provide an output (e.g., absolute position and attitude 118, images 116, status information, etc.) to a remote device. The navigation system 100 and 150 is capable of transitioning indoors and maintains highly-accurate global pose for a limited distance of travel without global navigation satellite system availability. The navigation system 100 and 150 can be used as a navigation device, an augmented reality device, a 3-Dimensional rendering device or a combination thereof.

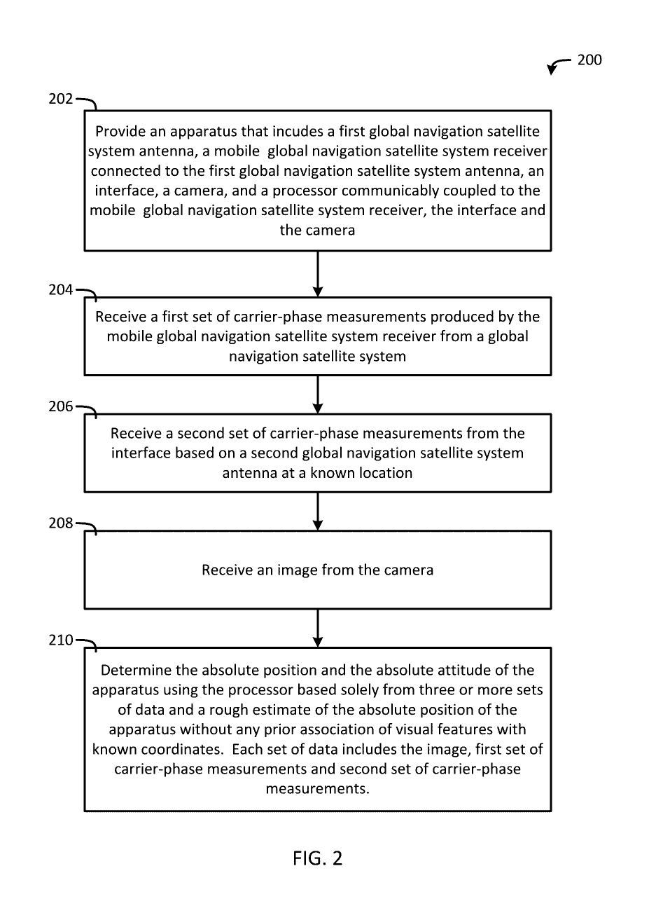

Now referring to FIG. 2, a method 200 for determining an absolute position and an attitude of an apparatus in accordance with the embodiment of the present invention of FIG. 1A is shown. An apparatus that includes a first global navigation satellite system antenna, a mobile global navigation satellite system receiver connected to the first global navigation satellite system antenna, an interface, a camera, and a processor communicably coupled to the mobile global navigation satellite system receiver, the interface and the camera is provided in block 202. A first set of carrier-phase measurements produced by the mobile global navigation satellite system receiver from a global navigation satellite system are received in block 204. A second set of carrier-phase measurements are received from the interface based by a second global navigation satellite system antenna at a known location in block 206. An image is received from the camera in block 208. The absolute position and the attitude of the apparatus are determined in block 210 using the processor based solely from three sets of data and a rough estimate of the absolute position of the apparatus without any prior association of visual features with known coordinates. Each set of data includes the image, the first set of carrier-phase measurements and the second set of carrier-phase measurements. The method can be implemented using a non-transitory computer readable medium encoded with a computer program that when executed by a processor performs the steps. Details regarding these steps and additional steps are discussed in detail below.

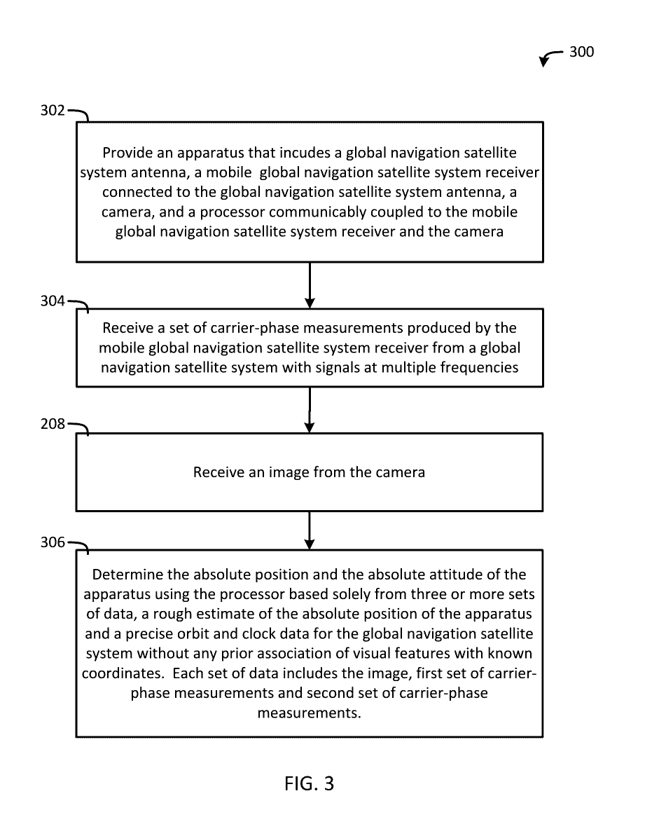

Now referring to FIG. 3, a method 300 for determining an absolute position and an attitude of an apparatus in accordance with the embodiment of the present invention of FIG. 1B is shown. An apparatus that includes a global navigation satellite system antenna, a mobile global navigation satellite system receiver connected to the global navigation satellite system antenna, a camera, and a processor communicably coupled to the mobile global navigation satellite system receiver and the camera is provided in block 302. A set of carrier-phase measurements produced by the mobile global navigation satellite system receiver from a global navigation satellite system with signals at multiple frequencies are received in block 304. An image is received from the camera in block 208. The absolute position and the attitude of the apparatus are determined in block 306 using the processor based solely from three or more sets of data, a rough estimate of the absolute position of the apparatus and a precise orbit and clock data for the global navigation satellite system without any prior association of visual features with known coordinates. Each set of data includes the image and the set of carrier-phase measurements. The method can be implemented using a non-transitory computer readable medium encoded with a computer program that when executed by a processor performs the steps. Details regarding these steps and additional steps are discussed in detail below.

Referring now to FIG. 4, a block diagram of a navigation system 400 in accordance with another embodiment of the present invention is shown. This block diagram identifies the subsystems within the navigation system as a whole by encircling the corresponding blocks with a colored dashed line. These colors are red for the INS 402, blue for CDGPS 404, and green for the visual navigation system (VNS) 406. The navigation filter 408 is responsible for combining the measurements from these independent subsystems to estimate the state of the AR system. Blocks within the navigation filter 408 are encircled by a black dashed line. The sensors for the system are all aligned in a single column on the far left side of FIG. 4. The outputs from the navigation system 400 are the state 118 of the camera 108, which includes the absolute pose from the filter state to camera state module or process 426, and the video 116 from the camera 108.

This type of navigation system can be implemented on a large scale with minimal infrastructure. The required sensors for this navigation system are all located on the AR system, except for the reference receiver, and none of the sensors require the area of operation to be prepared in any way. The reference receiver 410 is a GPS receiver at a known location that provides GPS observables measurements to the system via the Internet 412. A single reference receiver 410 can provide measurements to an unlimited number of systems at distances as large as 10 km away from the reference receiver 410 for single-frequency CDGPS and even further for dual-frequency CDGPS. This means that only a sparsely populated network of reference receivers 410 is required to service an unlimited number of navigation systems similar to this one over a large area.

The navigation system described herein has several modes of operation depending on what measurements are provided to it. These modes are CDGPS-only 404, CDGPS 404 and INS 402, CDGPS 404 and VNS 406, and CDGPS 404, VNS 406, and INS 402. This allows testing and comparison of the performance of the different subsystems. Whenever measurements from a subsystem are not present, the portion of the block diagram corresponding to that subsystem shown in FIG. 4 is removed and the state vector is modified to remove any states specific to that subsystem. In the case that INS 402 measurements are not present, the propagation step block 414 is modified to use an INS-free dynamics model instead of being entirely removed.

A typical CDGPS navigation filter 404 has a state of the form:

X_{CDGPS}=[(X_{ECEF}^{B})^{T}(V_{ECEF})^{T}(N)^{T}]^{T} (12)

where x_{ECEF}^{B} and v_{ECEF}^{B} are the position and velocity of the origin of the B-frame in ECEF and N is the vector of CDGPS carrier-phase integer ambiguities. The carrier-phase integer ambiguities are constant and arise as part of the CDGPS solution, which is described in detail below.

Adding an INS 402 that provides accelerometer measurements and attitude estimates to the CDGPS navigation filter 404 necessitates the addition of the accelerometer bias, ba, and the attitude of the B-frame relative to ECEF, q_{ECEF}^{B}, to the state. The resulting state for coupled CDGPS 404 and INS 402 is:

X_{CDGPS/INS}=[(x_{ECEF}^{B})^{T}(v_{ECEF}^{B})^{T}(bₐ)^{T}(q_{ECEF}^{B})^{T}(N)^{T}]^{T} (13)

If, instead of an INS 402, a VNS 406 that provides relative pose estimates in some arbitrary V-frame is coupled to the CDGPS filter 404, then the constant similarity transform between the V-frame and ECEF must be added to the state in addition to the attitude of the B-frame relative to ECEF. The need for the arbitrarily assigned Vframe could be eliminated if the navigation filter 408 provided the VNS 406 with estimates of the absolute pose at each camera frame, as shown above, but this is not the case for the navigation system presented herein. The resulting state for coupled CDGPS 404 and VNS 406 is

X_{CDGPS/INS}=[(x_{ECEF}^{B})^{T}(v_{ECEF}^{B})^{T}(q_{ECEF}^{B})^{T}(x_{ECEF}^{V})^{T}(q_{V}^{ECEF})^{T}λ(N)^{T}]^{T} (14)

where x_{ECEF}^{V}, q_{V}^{ECEF}, and λ are the translation, rotation, and scale-factor respectively which parameterize the similarity transform relating the V-frame and ECEF.

The state vector for the full navigation filter 408 that couples CDGPS 404, VNS 406, and INS 402 is obtained by adding the accelerometer bias to the state for coupled CDGPS 404 and VNS 406 from Eq. 14. This results in:

$$( 15 )$$

$$X = {X}_{CDGPS / VNS / INS} = {[ \begin{matrix}{( {x}_{ECEF}^{B} )}^{T} & {( {v}_{ECEF}^{B} )}^{T} & {( {b}_{α} )}^{T} & {( {q}_{ECEF}^{B} )}^{T} & {( {x}_{ECEF}^{V} )}^{T} & {( {q}_{V}^{ECEF} )}^{T} & λ & {( N )}^{T}\end{matrix} ]}^{T}$$

This state vector will be used throughout the remainder of this description. It should be noted that the models for the other modes of the navigation filter 408, CDGPS-only 404, CDGPS 404 and INS 402, and CDGPS 404 and VNS 406, can be obtained from the models for the full navigation filter 408 by simply ignoring the terms in the linearized models corresponding to states not present in that mode's state vector.

Each of the state vectors can be conveniently partitioned to obtain:

$$X = [ \begin{matrix}x \\ N\end{matrix} ] \qquad ( 16 )$$

where x contains the real-valued part of the state and N contains the integer-valued portion of the state, which is simply the vector of CDGPS carrier-phase integer ambiguities. This partitioning of the state will be used throughout the development of the filter, since it is convenient for solving for the state after measurement updates.

Attitude of both the AR system and the V-frame is represented using quaternions in the state vector. Quaternions are a non-minimal attitude representation that is constrained to have unit norm. To enforce this constraint in the filter, the quaternions q_{ECEF}^{B} and q_{V}^{ECEF} are replaced in the state with a minimal attitude representation, denoted as δe_{ECEF}^{B} and δe_{V}^{ECEF} respectively, during measurement updates and state propagation [48]. This is accomplished through the use of differential quaternions. These differential quaternions represent a small rotation from the current attitude to give an updated estimate of the attitude through the equation:

q′=δq(δe) [symbol] q (17)

where q′ is the updated attitude estimate and δq(δe) is the differential quaternion.

As a matter of notation, the state itself or elements of the state vector when substituted into models will be denoted with either a bar, (•̅), for a priori estimates or a hat, (\hat{•}), for a posteriori estimates. Any term representing the state or an element of the state without these accents is the true value of that parameter. When the state or an element of the state has a delta in front of it, δ(•), this represents a linearized correction term to the current value of the state. The same accent rules that apply to the state also apply to delta states.

The signal tracking loops of a GPS receiver produce a set of three measurements, typically referred to as observables, which are used in computing the receivers position-velocity-time (PVT) solution. These observables are pseudorange, beat carrier-phase, and Doppler frequency. In SPS GPS, the pseudorange and Doppler frequency measurements are used to compute the position and velocity of the receiver respectively. The carrier-phase measurement, which is the integral of the Doppler frequency, is typically ignored or not even produced.

Carrier-phase can be measured to millimeter-level accuracy, but there exists an inherent range ambiguity that is difficult to resolve in general. CDGPS is a technique that arose to reduce the difficulty in resolving this ambiguity. This is accomplished by differencing the measurements between two receivers, a reference receiver (RX A) 410 at a known location and a mobile receiver (RX B) 104, and between two satellites. The resulting measurements are referred to as double-differenced measurements. Differencing the measurements eliminates many of the errors in the measurements and results in integer ambiguities that can be determined much quicker than their real-valued counterparts by enforcing the integer constraint. The downside to this process is that only relative position between the antennas of the two receivers can be determined to centimeter-level or better accuracy. However, the reference receiver can be placed at a surveyed location so that its absolute position can be nearly perfectly known ahead of time. As such, the analysis presented herein will assume that the coordinates of the reference receiver are known. Further information on the GPS measurement models and CDGPS in general can be found in [49-52].

The navigation filter 408 forms double-differenced measurements for both pseudorange and carrier-phase measurements from the civil GPS signal at the L1 frequency. Differencing the pseudorange measurements is not strictly necessary, but simplifies the filter development and reduces the required state vector. Time alignment of the pseudorange and carrier-phase measurements from both receivers must be obtained to form the double-differenced measurements. It is highly unlikely that the receiver time epochs when the pseudorange and carrier-phase measurements are taken for both receivers would correspond to the same true time. Therefore, these measurements must be interpolated to the same time instant before the double-differenced measurements are formed. This is typically performed using the Doppler frequency and the SPS GPS time solution, which are already reported by the receivers.

The undifferenced pseudorange and carrier-phase models for RX B are:

ρ_{B}ⁱ(k)=rᵢ^{B}(k)+c(δt_{RX,}_{_{B}}(k)−δt_{SV}_{ᵢ}(k))+I_{B}ⁱ(k)+T_{B}ⁱ(k)+M_{B}ⁱ(k)+ω_{ρ,B}ⁱ(k) (18)

λ_{L1}φ_{B}ⁱ(k)=r_{B}ⁱ(k)+c(δt_{RX}_{_{B}}(k)−δt_{SV}_{ₖ}(k))+λ_{L1}(γ_{B}ⁱ−ψᵢ)−I_{B}ⁱ(k)+T_{B}ⁱ(k)+m_{B}ⁱ(k)+ω_{φ,B}ⁱ (19)

where ρ_{B}ⁱ(k) and φ_{B}ⁱ(k) are the pseudorange and carrier-phase measurements in meters and cycles respectively from RX B for the ith satellite vehicle (SV), r_{B}ⁱ(k) is the true range from RX B to the ith SV, c is the speed of light, δt_{RX}_{_{B}}(k) is the receiver clock offset for RX B, δt_{SV}_{ᵢ}(k) is the satellite clock offset for the ith SV, I_{B}ⁱ(k) and T_{B}ⁱ(k) are the Ionosphere and Troposphere delays respectively, M_{B}ⁱ(k) and m_{B}ⁱ(k) are the multipath errors on the pseudorange and carrier-phase measurements respectively, λ_{L1} is the wavelength of the GPS L1 frequency, γ_{B}ⁱ is the initial carrier-phase of the signal when the ith SV was acquired by RX B, ψⁱ is the initial broadcast carrier-phase from the ith SV, and w_{ρ,B}ⁱ(k) and w_{φ,B}ⁱ(k) are zero-mean Gaussian white noise on the pseudorange and carrier-phase measurements respectively. The model for RX A is identical to this one with the appropriate values referenced to RX A instead.

The true range to the ith SV from RX B can be written as:

r_{B}ⁱ(k)=∥x_{ECEF}^{SV}^{ᵢ}(k)−x_{ECEF}^{RX}^{_{B}}(k)∥ (20)

where x_{ECEF}^{SV}^{ᵢ}(k) is the position of the ith SV at the time the signal was transmitted and x_{ECEF}^{RX}^{_{B}}(k) is the position of the phase center of the GPS antenna at the time the signal was received. The position of the satellites can be computed from the broadcast ephemeris data on the GPS signal. The position of the phase center of the GPS antenna is related to the pose of the system through the equation:

x_{ECEF}^{RX}^{_{B}}(k)=x_{ECEF}^{B}(k)+R(q_{ECEF}^{B}(k))x_{B}^{GPS} (21)

where x_{B}^{GPS} is the position of the phase center of the GPS antenna in the B-frame.

The standard deviation of the pseudorange and carrier-phase measurement noises depend on the configuration of the tracking loops of the GPS receiver and the received carrier-to-noise ratio of the signal. Based on a particular tracking loop configuration, these standard deviations can be expressed in terms of the standard deviation of the pseudorange and carrier-phase measurements for a signal at some reference carrier-to-noise ratio through the relations:

$$\begin{matrix}E [ {( {w}_{ρ , B}^{i} ( k ) )}^{2} ] = {( {σ}_{ρ , B}^{i} ( k ) )}^{2} = {σ}_{ρ}^{2} ( {( \frac{C}{{N}_{0}} )}_{ref} ) ( \frac{{( C / {N}_{0} )}_{ref}}{{( C / {N}_{0} )}_{B}^{i} ( k )} ) & ( 22 ) \\ E [ {( {w}_{φ , B}^{i} ( k ) )}^{2} ] = {( {σ}_{φ , B}^{i} ( k ) )}^{2} = {σ}_{φ}^{2} ( {( \frac{C}{{N}_{0}} )}_{ref} ) ( \frac{{( C / {N}_{0} )}_{ref}}{{( C / {N}_{0} )}_{B}^{i} ( k )} ) & ( 23 )\end{matrix}$$

where (C/N₀)_{ref} is the reference carrier-to-noise ratio in linear units, (C/N₀)_{B}ⁱ(k) is the received carrier-to-noise ratio of the signal from the ith SV by RX B in linear units, and σₚ((C/N₀)_{ref}) and δ_{φ}((C/N₀)_{ref}) are the standard deviations of the pseudorange and carrier-phase measurements respectively for the particular tracking loop configuration at the reference carrier-to-noise ratio. Reasonable values for σₚ((C/N₀)_{ref}) and σ_{φ}((C/N₀)_{ref}) at a reference carrier-to-noise ratio of 50 dB-Hz are 1 m and 2.5 mm respectively. The standard deviation of the pseudorange and carrier-phase measurement noise for RX A follows this same relation assuming that the tracking loop configurations are the same. It should be noted that the pseudorange and carrier-phase measurements are only negligibly correlated with one another and they are not correlated between receivers or SVs.

The pseudorange and carrier-phase measurements from Eqs. 18 and 19 are first differenced between the two receivers. This requires that both receivers be tracking the same set of satellites, which may be a subset of the satellites tracked by each receiver alone. The resulting single-differenced measurements are modeled as:

Δ_{ρAB}ⁱ(k)=Δr_{AB}ⁱ(k)+c(δt_{RX}_{_{A}}(k)−δt_{RX}_{_{B}}(k))+ΔM_{AB}ⁱ(k)+Δω_{ρ,AB}ⁱ(k) (24)

λ_{L1}Δφ_{AB}ⁱ(k)=Δr_{AB}ⁱ(k)+c(δt_{RX}_{_{A}}(k)−δt_{RX}_{_{B}}(k))+λ_{L1}(γ_{A}ⁱ−γ_{B}ⁱ)+Δm_{AB}ⁱ(k)+Δω_{φ,AB}ⁱ(k) (25)

where the single-difference operator Δ is defined as:

Δ(•)_{AB}=(•)_{A}−(•)_{B} (26)

The single-differenced pseudorange and carrier-phase measurement noises are still independent zero-mean Gaussian white noises, but the standard deviation is now:

E[(Δω_{ρ,AB}ⁱ(k))²]=(σ_{ρ,AB}ⁱ(k))²=(σ_{ρ,A}ⁱ(k))²+(σ_{ρ,B}ⁱ(k))² (27)

E[(Δω_{φ,AB}ⁱ(k))²]=(σ_{φ,AB}ⁱ(k))²=(σ_{φ,A}ⁱ(k))²+(σ_{φ,B}ⁱ(k))² (28)

Differencing these measurements between the two receivers eliminated several error sources in the measurements. First, the satellite clock offset was eliminated, since this is common to both measurements. This error can also be removed by computing the satellite clock offset from the broadcast ephemeris data on the GPS signal, although these estimates are not perfect. Second, Ionosphere and Troposphere delays were eliminated under the assumption that the two receivers are close enough to one another that the signal traveled through approximately the same portion of the atmosphere. This assumption is the primary limitation on the maximum distance between the two receivers. As this baseline distance increases and this assumption is violated, the performance of CDGPS degrades. For a single-frequency CDGPS algorithm, the maximum baseline for centimeter-level positioning accuracy is about 10 km. Dual-frequency CDGPS algorithms can estimate the ionospheric delay at each receiver and remove it independent of the baseline distance, which can increase this baseline distance limit significantly.

Another effect of performing this first difference is the elimination of the initial broadcast carrier-phase of the satellite. This was one of the contributing factors to the carrier-phase ambiguity. However, the ambiguity on the single-differenced measurements is still real-valued.

Of the satellites tracked by both receivers, one satellite is chosen as the “reference” satellite which is denoted with the index 0. The single differenced measurements from this reference satellite are subtracted from those from all other satellites tracked by both receivers to form the double-differenced measurements. These double-differenced measurements are modeled as:

$$\begin{matrix}\begin{matrix}∇ {Δρ}_{AB}^{i 0} ( k ) = Δ {ρ}_{AB}^{i} ( k ) - {Δρ}_{AB}^{0} ( k ) \\ = ∇ Δ {r}_{AB}^{i 0} ( k ) + ∇ Δ {M}_{AB}^{i 0} ( k ) + ∇ Δ {w}_{ρ , AB}^{i 0} ( k )\end{matrix} & ( 29 ) \\ \begin{matrix}{λ}_{L 1} ∇ {Δφ}_{AB}^{i 0} ( k ) = {λ}_{L 1} ( Δ {φ}_{AB}^{i} ( k ) - {Δφ}_{AB}^{0} ( k ) ) \\ = ∇ Δ {r}_{AB}^{i 0} ( k ) + {λ}_{L 1} {N}_{AB}^{i 0} + \\ ∇ Δ {m}_{AB}^{i 0} ( k ) + ∇ Δ {w}_{φ , AB}^{i 0} ( k )\end{matrix} & ( 30 )\end{matrix}$$

where N_{AB}ⁱ⁰ are the carrier-phase integer ambiguities and the double-difference operator is defined as:

∇Δ(•)_{AB}^{ij}=Δ(•)_{AB}ⁱ−Δ(•)_{AB}^{j} (31)

The double-differenced pseudorange and carrier-phase measurement noises are still zero-mean Gaussian white noises, but the standard deviation is now:

E[(∇Δω_{ρ,AB}ⁱ⁰(k))²]=(σ_{ρ,AB}ⁱ⁰(k))²=(σ_{ρ,AB}ⁱ(k))²+(σ_{ρ,AB}⁰(k))² (32)

E[(∇Δω_{φ,AB}ⁱ⁰(k))²]=(σ_{φ,AB}ⁱ⁰(k))²=(σ_{φ,AB}ⁱ(k))²+(σ_{φ,AB}⁰(k))² (33)

This second difference also created cross-covariance terms given by:

E[(∇Δω_{ρ,AB}ⁱ⁰(k)∇Δω_{ρ,AB}ⁱ⁰(k)]=(σ_{ρ,AB}^{i0,j0}(k))²=(σ_{ρ,AB}⁰(k))², for i≠j (34)

E[(∇Δω_{φ,AB}ⁱ⁰(k)∇Δω_{φ,AB}ⁱ⁰(k)]=(σ_{φ,AB}^{i0,j0}(k))²=(σ_{φ,AB}⁰(k))², for i≠j (35)

This suggests that the satellite with the lowest single-differenced measurement noise should be chosen as the reference satellite to minimize the double-differenced measurement covariance.

Taking this second difference had two primary effects on the measurements. First, the receiver clock bias for both receivers was eliminated, since the biases are common to all single-differenced measurements. This means that the receiver clock biases no longer need to be estimated by the filter. Second, the ambiguities on the carrier-phase measurements are now integer-valued. This simplification only occurs if the receivers are designed such that the beat carrier-phase measurement is referenced to the same local carrier replica or local carrier replicas that only differ by an integer number of cycles. Under this assumption, the terms γ_{A}ⁱ−γ_{A}⁰ and γ_{B}ⁱ−γ_{B}⁰ are both integers and, thus, their difference is an integer.

This integer ambiguity is also constant provided that the phase-lock loops (PLLs) in both receivers for both satellites do not slip cycles. If any of these four carrier-phases drop or gain any cycles, then the integer ambiguity will no longer be the same and the CDGPS solution will suffer. For satellites above 10 or 15 degrees in elevation, cycle slips are rare if there are no obstructions blocking the line-of-sight signal. However, cycle slip robustness is still an important issue for both receiver design and CDGPS algorithm design.

The only remaining error source in the double-differenced measurements, besides noise, is the double-differenced multipath error. The worst-case carrier-phase multipath error is only on the order of centimeters, while the pseudorange multipath error can be as high as 31 m. This means that multipath will not significantly degrade performance of CDGPS once the carrier-phase integer ambiguities have been determined, since the pseudorange measurements have almost no effect on the pose solution at this point. However, pseudorange multipath errors can cause difficulty during the initial phase when the integer ambiguities are being determined. Multipath errors are also highly correlated in time, which further complicates the issue. Additionally, carrier-phase multipath may cause cycle slips, which cuts against robustness of the system. Multipath errors can largely be removed by masking out low elevation satellites, but any tall structures in the area of operation may create multipath reflections. In the end, the integer ambiguities will converge to the correct value, but it will take significantly longer and the carrier-phase may slip cycles in the presence of severe multipath.

Eqs. 29 and 30 are linearized about the a priori estimate of the real-valued portion of the state assuming that multipath errors are not present. The resulting linearized double-differenced measurements are:

$$\begin{matrix}\begin{matrix}{z}_{ρ}^{i 0} ( k ) = ∇ {Δρ}_{AB}^{i 0} ( k ) - ∇ Δ {\overline{r}}_{AB}^{i 0} ( k ) \\ = {( {\hat{r}}_{ECEF}^{0 , B} ( k ) - {\hat{r}}_{ECEF}^{i , B} ( k ) )}^{T} δ {x}_{ECEF}^{B} ( k ) + 2 {( {\hat{r}}_{ECEF}^{0 , B} ( k ) - {\hat{r}}_{ECEF}^{i , B} ( k ) )}^{T} \\ [ ( R ( {\overline{q}}_{ECEF}^{B} ( k ) ) {x}_{B}^{GPS} ) x ] δ {e}_{ECEF}^{B} ( k ) + ∇ Δ {w}_{ρ , AB}^{i 0} ( k )\end{matrix} & ( 36 ) \\ \begin{matrix}{z}_{φ}^{i 0} ( k ) = {λ}_{L 1} ∇ {Δφ}_{AB}^{i 0} ( k ) - ∇ Δ {\overline{r}}_{AB}^{i 0} ( k ) \\ = {( {\hat{r}}_{ECEF}^{0 , B} ( k ) - {\hat{r}}_{ECEF}^{i , B} ( k ) )}^{T} δ {x}_{ECEF}^{B} ( k ) + \\ 2 {( {\hat{r}}_{ECEF}^{0 , B} ( k ) - {\hat{r}}_{ECEF}^{i , B} ( k ) )}^{T} [ ( R ( {\overline{q}}_{ECEF}^{B} ( k ) ) {x}_{B}^{GPS} ) x ] \\ δ {e}_{ECEF}^{B} ( k ) + {λ}_{L 1} {N}_{AB}^{i 0} + ∇ Δ {w}_{φ , AB}^{i 0} ( k )\end{matrix} & ( 37 )\end{matrix}$$

where ∇Δr_{AB}⁻ⁱ⁰(k) is the expected double-differenced range based on satellite ephemeris and the a priori state estimate, \hat{r}_{ECEF}^{i,B}(k) is the unit vector pointing to the ith SV from δx_{ECEF}^{B}(k) is the a prosteriori correction to the position estimate, [(•)×] is the cross-product equivalent matrix of the argument, and δe_{ECEF}^{B}(k) is the minimal representation of the differential quaternion representing the a posteriori correction to the attitude estimate.

If both receivers are tracking the same M+1 satellites, then M linearized double-differenced measurements are obtained of the form given in Eqs. 36 and 37. Gathering these M equations into matrix form gives:

$$[ \begin{matrix}{z}_{ρ} ( k ) \\ {z}_{φ} ( k )\end{matrix} ] = [ \begin{matrix}{H}_{ρ , x} ( k ) & 0 \\ {H}_{φ , x} ( k ) & {H}_{φ , N}\end{matrix} ] [ \begin{matrix}δ x ( k ) \\ N\end{matrix} ] + [ \begin{matrix}∇ Δ {w}_{ρ} \\ ∇ Δ {w}_{φ}\end{matrix} ] \qquad ( 38 )$$

where δx(k) is the a posteriori correction to the real-valued component of the state and

$$\begin{matrix}\begin{matrix}{H}_{ρ , x} ( k ) = {H}_{φ , x} ( k ) \\ = [ \begin{matrix}\frac{\partial ∇ {Δρ}_{AB}^{10}}{\partial {x}_{ECEF}^{B}} {\vert}_{\tilde{X} ( k )} & {0}_{1 \times 6} & \frac{\partial ∇ {Δρ}_{AB}^{10}}{\partial δ {e}_{ECEF}^{B}} {\vert}_{\tilde{X} ( k )} & {0}_{1 \times 7} \\ ⋮ & ⋮ & ⋮ & ⋮ \\ \frac{\partial ∇ {Δρ}_{AB}^{M 0}}{\partial {x}_{ECEF}^{B}} {\vert}_{\tilde{X} ( k )} & {0}_{1 \times 6} & \frac{\partial ∇ {Δρ}_{AB}^{M 0}}{\partial δ {e}_{ECEF}^{B}} {\vert}_{\tilde{X} ( k )} & {0}_{1 \times 7}\end{matrix} ]\end{matrix} & ( 39 ) \\ {H}_{φ , N} = {λ}_{L 1} I & ( 40 )\end{matrix}$$

where I is the identity matrix. The partial derivatives in Eq. 39 can be determined from Eq. 36 as:

$$\begin{matrix} \frac{\partial ∇ Δ {ρ}_{AB}^{i 0}}{\partial {x}_{ECEF}^{B}} {\vert}_{\tilde{X} ( k )} = {( {\hat{r}}_{ECEF}^{0 , B} ( k ) - {\hat{r}}_{ECEF}^{i , B} ( k ) )}^{T} & ( 41 ) \\ \frac{\partial ∇ Δ {ρ}_{AB}^{i 0}}{\partial δ {e}_{ECEF}^{B}} {\vert}_{\hat{X} ( k )} = 2 {( {\hat{r}}_{ECEF}^{0 , B} ( k ) - {\hat{r}}_{ECEF}^{i , B} ( k ) )}^{T} [ ( R ( {\overline{q}}_{ECEF}^{B} ( k ) ) {x}_{B}^{GPS} ) x ] & ( 42 )\end{matrix}$$

The covariance matrices for the double-differenced measurement noise can be assembled from Eqs. 32, 33, 34, and 35 as:

$$\begin{matrix}\begin{matrix}{R}_{ρ} ( k ) = E [ ∇ Δ {w}_{ρ} ( k ) ∇ Δ {w}_{ρ}^{T} ( k ) ] \\ = [ \begin{matrix}{( {σ}_{ρ , AB}^{10} ( k ) )}^{2} & {( {σ}_{ρ , AB}^{0} ( k ) )}^{2} & … & {( {σ}_{ρ , AB}^{0} ( k ) )}^{2} \\ {( {σ}_{ρ , AB}^{0} ( k ) )}^{2} & {( {σ}_{ρ , AB}^{20} ( k ) )}^{2} & … & {( {σ}_{ρ , AB}^{0} ( k ) )}^{2} \\ ⋮ & & ⋱ & ⋮ \\ {( {σ}_{ρ , AB}^{0} ( k ) )}^{2} & … & & {( {σ}_{ρ , AB}^{M 0} ( k ) )}^{2}\end{matrix} ]\end{matrix} & ( 43 ) \\ \begin{matrix}{R}_{φ} ( k ) = E [ ∇ Δ {w}_{φ} ( k ) ∇ Δ {w}_{φ}^{T} ( k ) ] \\ = [ \begin{matrix}{( {σ}_{φ , AB}^{10} ( k ) )}^{2} & {( {σ}_{φ , AB}^{0} ( k ) )}^{2} & … & {( {σ}_{φ , AB}^{0} ( k ) )}^{2} \\ {( {σ}_{φ , AB}^{0} ( k ) )}^{2} & {( {σ}_{φ , AB}^{20} ( k ) )}^{2} & … & {( {σ}_{φ , AB}^{0} ( k ) )}^{2} \\ ⋮ & & ⋱ & ⋮ \\ {( {σ}_{φ , AB}^{0} ( k ) )}^{2} & … & & {( {σ}_{φ , AB}^{M 0} ( k ) )}^{2}\end{matrix} ]\end{matrix} & ( 44 )\end{matrix}$$

An INS 402 is typically composed of an IMU 416 with a three-axis accelerometer, a three-axis gyro, and a magnetometer. The accelerometer measurements are useful for propagating position forward in time and estimation of the gravity vector. Estimation of the gravity vector can only be performed using a low-pass filter of the accelerometer measurements under the assumption that the IMU 416 is not subject to long-term sustained accelerations. This is typically the case for pedestrian and vehicular motion over time constants of a minute or longer. The magnetometer can also be used to estimate the direction of magnetic north under the assumption that magnetic disturbances are negligible or calibrated out of the system. However, a low-pass filter with a large time constant must also be applied to the magnetometer measurements to accurately estimate the direction of magnetic north, since the Earth's magnetic field is extremely weak.

Once the gravity vector and direction of magnetic north have been determined, the IMU 416 is capable of estimating its attitude relative to the local ENU frame after correcting for magnetic declination. Due to the long time constant filters, the attitude estimate must be propagated using the angular velocity measurements from the gyro to provide accurate attitude during dynamics. This means that the attitude estimated by the IMU 416 is highly correlated with the angular velocity measurements.

The navigation filter 408 presented herein relies on the accelerometer measurements and attitude estimates from the IMU 416. The accelerometer measurements aid in propagating the state forward in time, while the IMU 416 estimated attitude provides the primary sense of absolute attitude for the system. As demonstrated above, coupled GPS and visual SLAM is capable of estimating absolute attitude, but this navigation filter 408 has difficulty doing so without an IMU 416 because of the need to additionally estimate the similarity transform between ECEF and the V-frame. Therefore, the navigation filter 408 must rely on the IMU 416 estimated attitude. Since the angular velocity measurements are highly correlated with the IMU 416 estimated attitude, the angular velocity measurements are discarded.

The accelerometer measurements from the IMU 416 are modeled as follows:

$$f ( k ) = {R ( {q}_{ECEF}^{B} ( k ) )}^{T} ( {\dot{v}}_{ECEF}^{B} ( k ) + 2 [ {ω}_{E} x ] {v}_{ECEF}^{B} ( k ) ) + R ( {q}_{B}^{ENU} ( k ) ) [ \begin{matrix}0 \\ 0 \\ g ( k )\end{matrix} ] + {b}_{a} ( k ) + {v}_{a}^{′} ( k ) \qquad ( 45 )$$

where f(k) is the accelerometer measurement, ω_{E} is the angular velocity vector of the Earth, υₐ′(k) is zero-mean Gaussian white noise with a diagonal covariance matrix, and g(k) is the gravitational acceleration of Earth at the position of the IMU 416 that is approximated as:

$$g ( k ) = \frac{{G}_{E}}{{‖ {x}_{ECEF}^{B} ( k ) ‖}^{2}} \qquad ( 46 )$$

where G_{E} is the gravitational constant of Earth. This accelerometer measurement model is similar to the model in [53]. Equation 45 can be solved for the acceleration of the IMU 416 expressed in ECEF to obtain:

$${\dot{v}}_{ECEF}^{B} ( k ) = R ( {q}_{ECEF}^{B} ( k ) ) ( f ( k ) - {b}_{a} ( k ) ) + R ( {q}_{ECEF}^{ENU} ( k ) ) [ \begin{matrix}0 \\ 0 \\ - g ( k )\end{matrix} ] - 2 [ {ω}_{E} x ] {v}_{ECEF}^{B} ( k ) + {v}_{a} ( k ) \qquad ( 47 )$$

where νₐ(k) is a rotated version of υₐ′(k) and thus identically distributed. These measurements will be used in the dynamics model below.

The attitude estimates from the IMU are modeled as follows:

$$\begin{matrix}{\tilde{q}}_{ENU}^{B} ( k ) = {q}_{ENU}^{ECEF} ( k ) ⊗ {q}_{ECEF}^{B} ( k ) + {w}_{q}^{{I}^{′}} ( k ) \\ = {q}_{ENU}^{ECEF} ( k ) ⊗ δ {q}_{ECEF}^{B} ( k ) ⊗ {\overline{q}}_{ECEF}^{B} ( k ) + {w}_{q}^{{I}^{′}} ( k )\end{matrix} \qquad ( 48 )$$

where \tilde{q}_{ENU}^{B}(k) is the IMU attitude estimate and w_{q}^{l}′(k) is zero-mean Gaussian white noise with a diagonal covariance matrix. Modeling the noise on the attitude estimates as white is not strictly correct as there will be strongly time-correlated biases in the attitude estimates from the IMU 416, but these time-correlated errors are assumed small. The quaternion q_{ENU}^{ECEF}(k) can be computed from the a priori estimate of the position of the IMU 416. This dependence on the position, however, will be ignored for linearization, since it is extremely weak. In linearizing Eq. 48, the following relation is defined based on the quaternion left ([•]) and right ({•}) multiplication matrices:

$$[ \begin{matrix}{H}_{{q}_{0} , {δ ( {q}_{0} )}_{ECEF}^{B}}^{I} ( k ) & {H}_{{q}_{0} , δ {e}_{ECEF}^{B}}^{I} ( k ) \\ {H}_{e , {δ ( {q}_{0} )}_{ECEF}^{B}}^{I} ( k ) & {H}_{∈ , δ {e}_{ECEF}^{B}}^{I} ( k )\end{matrix} ] = [ {q}_{ENU}^{ECEF} ( k ) ] \{ {\overline{q}}_{ECEF}^{B} ( k ) \} \qquad ( 49 )$$

The linearized attitude measurement can then be expressed in minimal form as:

$$\begin{matrix}{z}_{q}^{I} ( k ) = {\tilde{e}}_{ENU}^{B} ( k ) - {\overline{e}}_{ENU}^{B} ( k ) \\ = [ \begin{matrix}{H}_{q , x}^{I} & 0\end{matrix} ] [ \begin{matrix}δ x \\ N\end{matrix} ] + {w}_{q}^{I} ( k )\end{matrix} \qquad ( 50 )$$

where \tilde{e}_{ENU}^{B}(k) and \overline{\tilde{e}}_{ENU}^{B}(k) are the measured and expected values of the vector portion of the quaternion qB ENU(k) respectively, w_{g}^{l}(k) is the last three elements of w_{q}^{l}′(k), and)

H_{e,x}^{I}(k)=[0_{3×9}H_{q,δe}_{_{ECEF}}_{^{B}}(k)0_{3×7}] (51)

The covariance matrix for these attitude estimates is:

R_{q}^{I}=(σ_{q}^{I})²I (52)

A reasonable value for σ_{q}^{I} is 0.01, which corresponds to an attitude error of approximately 2°. Since the IMU 416 considered here includes a magnetometer, the IMU's estimate of attitude does not drift.

A BA-based stand-alone visual SLAM algorithm 418 is employed to provide relative pose estimates of the system [45]. These estimates are represented in the V-frame, which has an unknown translation, orientation, and scale-factor relative to ECEF that must be estimated. The visual SLAM algorithm 418 does not provide covariances for its relative pose estimates to reduce computational expense of the algorithm. Therefore, all noises for the visual SLAM estimates are assumed to be independent. Although this is not strictly true, it is not an unreasonable approximation.

The position estimates from the visual SLAM algorithm 418 are modeled as:

\tilde{x}_{V}^{C}(k)=λR(q_{V}^{ECEF})(x_{ECEF}^{B}(k)+R(q_{ECEF}^{B}(k))x_{B}^{C}−x_{ECEF}^{V})+w_{P}^{V}(k) (53)

where \tilde{x}_{V}^{C}(k) is the position estimate of the camera in the V-frame, x_{B}^{C} is the position of the camera lens in the B-frame, and wₚ^{V}(k) is zero-mean Gaussian white noise with a diagonal covariance matrix given by:

Rₚ^{V}=(σₚ^{V})²I (54)

The value of σₚ^{V} depends heavily on the depth of the scene features tracked by the visual SLAM algorithm 418. A reasonable value of σₚ^{V} for a depth of a few meters is 1 cm.

The measurement model from Eq. 53 is linearized about the a priori state estimate to obtain:

$$\begin{matrix} \begin{matrix}{z}_{p}^{V} ( k ) = {\tilde{x}}_{V}^{C} ( k ) - \overline{λ} ( k ) R ( {\overline{q}}_{V}^{ECEF} ( k ) ) \\ ( {\overline{x}}_{ECEF}^{B} ( k ) + R ( {\overline{q}}_{ECEF}^{B} ( k ) ) {x}_{B}^{C} - {\overline{x}}_{ECEF}^{V} ( k ) ) \\ = [ \begin{matrix}{H}_{p , x}^{V} & 0\end{matrix} ] [ \begin{matrix}δ x \\ N\end{matrix} ] + {w}_{p}^{V} ( k )\end{matrix} \\ where & ( 55 ) \\ {H}_{p , x}^{V} ( k ) = {[ \begin{matrix}{( \overline{λ} ( k ) R ( {\overline{q}}_{V}^{ECEF} ( k ) ) )}^{T} \\ {0}_{6 \times 3} \\ {( 2 \overline{λ} ( k ) R ( {\overline{q}}_{V}^{ECEF} ( k ) ) [ ( R ( {\overline{q}}_{ECEF}^{B} ( k ) ) {x}_{B}^{C} ) x ] )}^{T} \\ {( - \overline{λ} ( k ) R ( {\overline{q}}_{V}^{ECEF} ( k ) ) )}^{T} \\ {( 2 \overline{λ} ( k ) [ \begin{matrix}( R ( {\overline{q}}_{V}^{ECEF} ( k ) ) \\ ( {\overline{x}}_{ECEF}^{B} ( k ) + R ( {\overline{q}}_{ECEF}^{B} ( k ) ) {x}_{B}^{C} - {\overline{x}}_{ECEF}^{V} ( k ) ) ) x\end{matrix} ] )}^{T} \\ {( \begin{matrix}R ( {\overline{q}}_{V}^{ECEF} ( k ) ) \\ ( {\overline{x}}_{ECEF}^{B} ( k ) + R ( {\overline{q}}_{ECEF}^{B} ( k ) ) {x}_{B}^{C} - {\overline{x}}_{ECEF}^{V} ( k ) )\end{matrix} )}^{T}\end{matrix} ]}^{T} & ( 56 )\end{matrix}$$

The attitude estimates from the visual SLAM algorithm 418 are modeled as:

$$\begin{matrix}{\overline{q}}_{V}^{C} ( k ) = {q}_{V}^{ECEF} ⊗ {q}_{ECEV}^{B} ( k ) ⊗ {q}_{B}^{C} + {w}_{q}^{V ′} ( k ) \\ = δ {q}_{V}^{ECEF} ( k ) ⊗ {\overline{q}}_{V}^{ECEF} ( k ) ⊗ δ {q}_{ECEF}^{B} ( k ) ⊗ {\overline{q}}_{ECEF}^{B} ( k ) ⊗ {q}_{B}^{C} + {w}_{q}^{V ′} ( k )\end{matrix} \qquad ( 57 )$$

where \tilde{q}_{V}^{C}(k) is the attitude estimate of the camera relative to the V-frame, q_{B}^{C} is the attitude of the camera 108 relative to the B-frame, and w_{q}^{V}′(k) is zero-mean Gaussian white noise with a diagonal covariance matrix. In linearizing Eq. 57, the following relations are defined based on the quaternion left and right multiplication matrices:

$$\begin{matrix}[ \begin{matrix}{H}_{q 0 , {δ ( q 0 )}_{ECEF}^{B}}^{V} ( k ) & {H}_{q 0 , δ {e}_{ECEF}^{B}}^{V} ( k ) \\ {H}_{e , {δ ( q 0 )}_{ECEF}^{B}}^{V} ( k ) & {H}_{e , δ {e}_{ECEF}^{B}}^{V} ( k )\end{matrix} ] = [ {\overline{q}}_{V}^{ECEF} ( k ) ] \{ {\overline{q}}_{ECEF}^{B} ( k ) \} \{ {q}_{B}^{C} ( k ) \} & ( 58 ) \\ [ \begin{matrix}{H}_{q 0 , {δ ( q 0 )}_{V}^{ECEF}}^{V} ( k ) & {H}_{q 0 , δ {e}_{V}^{ECEF}}^{V} ( k ) \\ {H}_{e , {δ ( q 0 )}_{V}^{ECEF}}^{V} ( k ) & {H}_{e , δ {e}_{V}^{ECEF}}^{V} ( k )\end{matrix} ] = [ {\overline{q}}_{V}^{ECEF} ( k ) ] \{ {\overline{q}}_{ECEF}^{B} ( k ) \} \{ {q}_{B}^{C} ( k ) \} & ( 59 )\end{matrix}$$

The linearized attitude measurement can then be expressed in minimal form as:

$$\begin{matrix}{z}_{q}^{V} ( k ) = {\overline{e}}_{V}^{C} ( k ) - {\overline{e}}_{V}^{C} ( k ) \\ = [ {H}_{q , x}^{V} 0 ] [ \begin{matrix}δ x \\ N\end{matrix} ] + {w}_{q}^{V} ( k )\end{matrix} \qquad ( 60 )$$

where \tilde{e}_{V}^{C}(k) and ē_{V}^{C}(k) are the measured and expected values of the vector portion of the quaternion q_{V}^{C}(k) respectively, w_{q}^{V}(k) is the last three elements of w_{q}^{V}′(k), and

H_{q,x}^{V}(k)=[0_{3×9}H_{e,δe}_{_{ECEF}}_{^{B}}^{V}(k)0_{3×3}H_{e,δe}_{_{V}}_{^{ECEF}}^{V}(k)0_{3×1}] (61)

The covariance matrix for these attitude estimates is:

R_{q}^{V}=(σ_{q}^{V})²I (62)

A reasonable value for σₚ^{V} is 0.005, which corresponds to an attitude error of approximately 1°.

Two separate dynamics models are used in the navigation filter 408 depending on whether or not INS 402 measurements are provided to the filter 408. The first is an INS Dynamics Model. The second is an INS-Free Dynamics Model.

Whenever INS 402 measurements are present, the navigation filter 408 uses the accelerometer measurements from the IMU 416 to propagate the position and velocity of the system forward in time using Eq. 47. The accelerometer bias is modeled as a first-order Gauss-Markov process. Angular velocity measurements from the IMU 416 cannot be used for propagation of the attitude of the system since the filter 408 uses attitude estimates from the IMU 416, which are highly correlated with the angular velocity measurements. Therefore, the attitude is held constant over the propagation step with some added process noise to account for the unmodeled angular velocity. All other parameters in the real-valued portion of the state are constants and are modeled as such. The integer ambiguities are excluded from the propagation step, since they are constants anyways. However, the cross-covariance between the real-valued portion of the state and the integer ambiguities is propagated forward properly. This is explained in greater detail below.

The resulting dynamics model for the state is:

$$f ( x ( t ) , u ( t ) , t ) = [ \begin{matrix}{v}_{ECEF}^{B} ( t ) \\ R ( {q}_{ECEF}^{B} ( t ) ) ( f ( t ) - {b}_{a} ( t ) ) + R ( {q}_{ECEF}^{ENU} ( t ) ) [ \begin{matrix}0 \\ 0 \\ - g ( t )\end{matrix} ] \\ - 2 [ {ω}_{E} \times ] {v}_{ECEF}^{B} ( t ) \\ 0 \\ 0 \\ 0 \\ 0 \\ 0\end{matrix} ] \qquad ( 63 )$$

where u(t) is the input vector given by

$$u ( t ) = [ \begin{matrix}f ( t ) \\ - g ( t )\end{matrix} ] \qquad ( 64 )$$

Process noise is added to the dynamics model to account for un-modeled effects and is given by:

$$D ( t ) {v}^{′} ( t ) = [ \begin{matrix}{0}_{3 \times 9} \\ {I}_{9 \times 9} \\ {0}_{7 \times 9}\end{matrix} ] [ \begin{matrix}{v}_{a} ( t ) \\ {v}_{b} ( t ) \\ {v}_{ω} ( t )\end{matrix} ] \qquad ( 65 )$$

The process noise covariance is:

$${Q}^{′} ( t ) = E [ {v}^{′} ( t ) {v}^{′ T} ( t ) ] = [ \begin{matrix}{σ}_{a}^{2} I & 0 & 0 \\ 0 & {σ}_{b}^{2} I & 0 \\ 0 & 0 & \frac{1}{4} {σ}_{ω}^{2} I\end{matrix} ] \qquad ( 66 )$$

The term ¼σ_{ω}² comes from the following relation which can be derived from quaternion kinematics under the initial condition that δe_{ECEF}^{B}=0

δė_{ECEF}^{B}(t)=½ω(t)=ν_{ω}(t) (67)

where ω(t) is the angular velocity vector of the system which is modeled as zero-mean Gaussian white noise with a diagonal covariance matrix. The values of σₐ and σ_{b} from Eq. 66 depend on the quality of the IMU and can typically be found on the IMU's specifications provided by the manufacturer. On the other hand, σ_{ω} depends on the expected dynamics of the system.

Since the IMU 416 measurements are reported at a rate of 100 Hz, the propagation interval, Δt, is at most 10 ms. This interval is small enough that the dynamics model can be assumed constant over the interval and higher order terms in Δt are negligible compared to lower order terms.

Under this assumption, the dynamics model is then integrated over the propagation interval to form a difference equation of the form:

x(k+1)≈x(k)+Δtf(x(k),u(k),tₖ)+Γ(k)v(k) (68)

where v(k) is the discrete-time zero-mean Gaussian white process noise vector, and

$$Γ ( k ) = [ \begin{matrix}{I}_{12 \times 12} \\ {0}_{7 \times 12}\end{matrix} ] \qquad ( 69 )$$

The partial derivative of the difference equation from Eq. 68 is taken with respect to the state and evaluated at the a posteriori state estimate at time tₖ to obtain the state transition matrix:

$$( 70 )$$

$$F ( k ) = I + Δ t \times [ \begin{matrix}{0}_{3 \times 3} & {I}_{3 \times 3} & {0}_{3 \times 3} & {0}_{3 \times 3} & {0}_{3 \times 7} \\ {0}_{3 \times 3} & - 2 [ {ω}_{E} \times ] & - R ( {\hat{q}}_{ECEF}^{B} ( k ) ) & 2 [ \begin{matrix}( R ( {\hat{q}}_{ECEF}^{B} ( k ) ) \\ ( f ( k ) - {\hat{b}}_{a} ( k ) ) \times \end{matrix} ] & {0}_{3 \times 7} \\ {0}_{13 \times 3} & {0}_{13 \times 3} & {0}_{13 \times 3} & {0}_{13 \times 3} & {0}_{13 \times 7}\end{matrix} ]$$

This linearization neglects the extremely weak coupling of the position of the system to the terms R(q_{ECEF}^{ENU}(k)) and g(k). This covariance matrix is given by:

$$Q ( k ) = E [ v ( k ) {v}^{T} ( k ) ] = [ \begin{matrix}{Q}_{( 1 , 1 )} ( k ) & {Q}_{( 1 , 2 )} ( k ) & 0 & 0 \\ {Q}_{( 1 , 2 )}^{T} ( k ) & {Q}_{( 2 , 2 )} ( k ) & {Q}_{( 2 , 3 )} ( k ) & {Q}_{( 2 , 4 )} ( k ) \\ 0 & {Q}_{( 2 , 3 )}^{T} ( k ) & {Q}_{( 3 , 3 )} ( k ) & 0 \\ 0 & {Q}_{( 2 , 4 )}^{T} ( k ) & 0 & {Q}_{( 4 , 4 )} ( k )\end{matrix} ] \qquad ( 71 )$$

where the terms in Q (k) are as follows:

Q_{(1,1)}(k)=⅓Δt³σₐ²I (72)

Q_{(1,2)}(k)=½Δt²σₐ²I (73)

Q_{(2,2)}(k)=(Δtσₐ²+⅓Δt³σ_{b}²)I+⅓Δt³σ_{ω}²×[(R(\hat{q}_{ECEF}^{B}(k))(f(k)−\hat{b}ₐ(k))×][(R(\hat{q}_{ECEF}^{B}(k))(f(k)−bₐ(k))×]^{T}≈Δtσₐ²I (74)

Q_{(2,3)}(k)=−Δt²σ_{b}²R(\hat{q}_{ECEF}^{B}(k)) (75)

Q_{(2,4)}(k)=¼Δt²σ_{ω}²[(R(\hat{q}_{ECEF}^{B}(k))(f(k)−\hat{b}ₐ(k))×] (76)

Q_{(3,3)}(k)=Δtσ_{b}²I (77)

Q_{(4,4)}(k)=¼Δtσ_{ω}²I (78)

Whenever INS measurements are not present, the INS-free dynamics model reverts to a velocity-random-walk model for the velocity in place of the accelerometer measurements. This is necessary because no other information about the dynamics of the system is available. All other states are propagated using models identical to those for the INS dynamics model. The accelerometer bias would typically not be represented in this model because this model would only be used if there were no accelerometer measurements and thus no need to have the bias in the state vector. However, it is maintained here primarily for notational consistency. The filter 408 could also revert to this model if the accelerometer measurements were temporarily lost for whatever reason and it was desirable to maintain the accelerometer bias in the state.

The resulting dynamics model for the state is simply:

$$f ( x ( t ) , u ( t ) , t ) = [ \begin{matrix}{v}_{ECEF}^{B} ( t ) \\ 0 \\ 0 \\ 0 \\ 0 \\ 0 \\ 0\end{matrix} ] \qquad ( 79 )$$

with additive process noise given by:

$$D ( t ) {v}^{′} ( t ) = [ \begin{matrix}{0}_{3 \times 9} \\ {I}_{9 \times 9} \\ {0}_{7 \times 9}\end{matrix} ] [ \begin{matrix}{v}_{\dot{v}} ( t ) \\ {v}_{b} ( t ) \\ {v}_{ω} ( t )\end{matrix} ] \qquad ( 80 )$$

The process noise covariance is assumed to be:

$${Q}^{′} ( t ) = E [ {v}^{′} ( t ) {v}^{′ T} ( t ) ] = [ \begin{matrix}{σ}_{\dot{v}}^{2} I & 0 & 0 \\ 0 & {σ}_{b}^{2} I & 0 \\ 0 & 0 & \frac{1}{4} {σ}_{ω}^{2} I\end{matrix} ] \qquad ( 81 )$$

where σ_{\dot{ν}} and σ_{ω} depend on the expected dynamics of the system and σ_{b} can be obtained from the IMU's specifications.

These propagation steps occur much less often than with the INS dynamics model. For a CDGPS-only filter 404, the propagation interval could be as large as 1 s, since many receivers only report observables at 1 s intervals. Therefore, the assumptions about the interval being small that were made for the INS dynamics model cannot be made here. However, this dynamics model is in fact linear and can be integrated directly to obtain the difference equation:

x(k+1)=F(k)x(k)+Γ(k)v(k) (82)

where Γ(k) is the same as in Eq. 69. It can easily be shown that the state transition matrix and discrete-time process noise covariance for this dynamics model are:

$$\begin{matrix} F ( k ) = [ \begin{matrix}{I}_{3 \times 3} & Δ {tI}_{3 \times 3} & {0}_{3 \times 13} \\ {0}_{3 \times 3} & {I}_{3 \times 3} & {0}_{3 \times 13} \\ {0}_{13 \times 3} & {0}_{13 \times 3} & {I}_{13 \times 3}\end{matrix} ] \\ and & ( 83 ) \\ Q ( k ) = E [ v ( k ) {v}^{T} ( k ) ] = [ \begin{matrix}\frac{1}{3} Δ {t}^{3} {σ}_{\dot{v}}^{2} I & \frac{1}{2} Δ {t}^{2} {σ}_{\dot{v}}^{2} I & 0 & 0 \\ \frac{1}{2} Δ {t}^{2} {σ}_{\dot{v}}^{2} I & Δ t {σ}_{\dot{v}}^{2} I & 0 & 0 \\ 0 & 0 & Δ t {σ}_{b}^{2} I & 0 \\ 0 & 0 & 0 & \frac{1}{4} Δ t {σ}_{ω}^{2} I\end{matrix} ] & ( 84 )\end{matrix}$$

The navigation filter 408 will now be described. Measurement and dynamics models for a mobile AR system employing double-differenced GPS observables measurements, IMU accelerometer measurements and attitude estimates, and relative pose estimates from a stand-alone visual SLAM algorithm 418 were derived above. With these measurement and dynamics models, a navigation filter 408 for the AR system is designed that couples CDGPS 404, visual SLAM 418, and an INS 402. This navigation filter 408 is capable of providing at least centimeter-level position and degree-level attitude accuracy in open outdoor areas. If the visual SLAM algorithm 418 was coupled tighter to the GPS and INS measurements, then this system could also transition indoors and maintain highly-accurate global pose for a limited time without GPS availability. The current filter only operates in post-processing, but could be made to run in real time.

This discussion below presents a square-root EKF (SREKF) implementation of such a navigation filter 408. The discussion includes how the filter state is encoded as measurement equations while accommodating the use of quaternions and a mixed real-integer valued state. Then, the measurement update and propagation steps are outlined. The method for handling changes in the satellites tracked by the GPS receivers is also discussed.

In square-root filter implementations, the state estimate and state covariance are represented by a set of measurement equations. These measurement equations express the filter state as a measurement of the true state with added zero-mean Gaussian white noise that has a covariance matrix equal to the state covariance. After normalizing these measurements so that the noise has a covariance matrix of identity, the state measurement equations are given by:

z_{X}(k)=Rₓₓ(k)X(k)+w_{X}(k) (85)

where z_{X}(k) are the state measurements, R_{XX} (k) is the upper-triangular Cholesky factorization of the inverse of the state covariance P⁻¹(k), and w_{X}(k) is the normalized zero-mean Gaussian white noise.

For the filter 408 reported herein, these equations are expressed slightly differently to properly handle the integer portion of the state and the elements of the state which are quaternion attitude representations. To handle the integer portion of the state, the state is simply partitioned into real-valued and integer components as mentioned above. This partitioning is useful in solving for the state after measurement update and propagation steps, which is described below. To handle the quaternions properly, the filter 408 must ensure that the quaternions are constrained to have unity magnitude, as required by the definition of a quaternion, during measurement update 420 (INS), 422 (CDGPS), 424 (VNS) and propagation steps 414. This constraint is enforced by expressing the quaternions in the state instead as differential quaternions, which can be reduced to a minimal attitude representation that does not require the unity magnitude constraint through a small angle assumption [48]. These differential quaternions represent a small rotation from the current best estimate of the corresponding quaternion as seen in Eq. 17.

Based on these considerations, the resulting state measurement equations are:

$$[ \begin{matrix}{z}_{x} ( k ) \\ {z}_{N} ( k )\end{matrix} ] = [ \begin{matrix}{R}_{xx} ( k ) & {R}_{xN} ( k ) \\ 0 & {R}_{NN} ( k )\end{matrix} ] [ \begin{matrix}x ( k ) \\ N\end{matrix} ] + [ \begin{matrix}{w}_{x} ( k ) \\ {w}_{N} ( k )\end{matrix} ] \qquad ( 86 )$$

where the quaternion elements of x(k) are stored separately and replaced by differential quaternions in minimal form. This set of equations is used in the filter 408 in place of Eq. 85, which is used in the standard SREKF.

Equation 86 is updated in the filter 408 as new measurements are collected through a measurement update step and as the filter propagates the state forward in time through a propagation step 414. Whenever the state estimate and state covariance are desired, they can be computed from Eq. 86 as follows:

1. The integer valued portion of the state is first determined through an integer least squares (ILS) solution algorithm taking z_{N}(k) and R_{NN}(k) as inputs. Details on ILS can be found in [54, 63, 64]. The discussion herein uses a modified version of MILES [54] which returns both the optimal integer set, N₀ₚₜ(k), and a tight lower bound on the probability that the integer set is correct, P_{low}(k).

2. Once the optimal integer set is determined, the expected value of the real-valued portion of the state can be determined through the equation:

E[x(k)]=Rₓₓ⁻¹(k)(zₓ(k)−R_{xN}(k)−R_{xN}(k)Nₒₚₜ(k) (87)

3. The quaternion elements of the state must be updated in a second step, since they are not represented directly in the state measurement equations. Their corresponding differential quaternions, which were computed in Eq. 87, are used to update the quaternions through Eq. 17. The differential quaternions must also be zeroed out in the state measurement equations so that this update is only performed once. This is accomplished for each differential quaternion through the equation:

zₓ′(k)=zₓ(k)−R_{xδe}(k)E[δe] (88)

where R_{xδe}(k) is the matrix containing the columns of Rₓₓ(k) corresponding to the differential quaternion. Updating the quaternions this way after every measurement update and propagation step prevents the differential quaternions from becoming large and violating the small angle assumption.

4. The covariance matrix can be computed through the equation:

$$P ( k ) = {( {[ \begin{matrix}{R}_{xx} ( k ) & {R}_{xN} ( k ) \\ 0 & {R}_{NN} ( k )\end{matrix} ]}^{T} [ \begin{matrix}{R}_{xx} ( k ) & {R}_{xN} ( k ) \\ 0 & {R}_{NN} ( k )\end{matrix} ] )}^{- 1} \qquad ( 89 )$$

The elements of the filter state are initialized as follows:

x_{ECEF}^{B} and V_{ECEF}^{B} are initialized from the pseudorange-based navigation solution already computed by the mobile GPS receiver 104.
bₐ is initialized to zero.
q_{ECEF}^{B} is initialized with the IMU's estimate of attitude.
x_{ECEF}^{V}, q_{V}^{ECEF}, and λ are initialized by comparing the visual SLAM solution to the coupled CDGPS and INS solution, which must be computed first, over the entire dataset. First, the quaternion q_{V}^{ECEF} can be computed as the difference between the attitude estimate from the visual SLAM solution and the coupled CDGPS and INS solution at a particular time. Second, the range to the reference GPS antenna can be plotted for both solutions based on initial guesses for x_{ECEF}^{V} and λ of x_{ECEF}^{B} and 1 and the value for q_{V}^{ECEF} that was already determined. After subtracting out the mean range from both solutions, the scale-factor can be computed as the ratio of amplitudes of the two traces. This assumes that the navigation system moved at some point during the dataset. Third, the position x_{ECEF}^{V} can be computed as the difference between the ECEF positions of the two solutions at a particular time.
N is initialized to zero.

Measurements are grouped by subsystem and processed in the measurement update step in the order they arrive using the models described above. Table 3 provides a list of the equations for the measurement models as a reference. The measurement update step proceeds in the same fashion.

A summary of this procedure is as follows:

1. The linearized measurements are formed by subtracting the expected value of the measurements based on the a priori state and the non-linear measurement model from the actual measurements. Equation numbers for the non-linear measurement models are listed in Table 3 for each measurement.

2. The linearized measurements and measurement models are then normalized using the Cholesky factorization of the inverse of the measurement covariance. Equation numbers for the linearized measurement models and measurement covariances are listed in Table 3 for each measurement.

TABLE 3
List of Equations for Measurement Models

| | | Non-linear | Linearized | | |
|---|---|---|---|---|---|
| | | Model | Model | | Covariance |
| Subsystem | Measurement | h(•) | Hₓ | H_{N} | R |
| CDGPS | Double- | Eq. 29 | Eq. 39 | 0 | Eg. 43 |
| | differenced | | | | |
| | Pseudorange | | | | |
| | Double- | Eg. 30 | Eg. 39 | Eq. 40 | Eg. 44 |
| | differenced | | | | |
| | carrier-phase | | | | |
| INS | attitude estimate | Eq. 48 | Eq. 51 | 0 | Eq. 52 |
| VNS | position estimate | Eq. 53 | Eq. 56 | 0 | Eq. 54 |
| | attitude estimate | Eq. 57 | Eq. 61 | 0 | Eq. 62 |

3. The a priori estimate x(k) is subtracted out of the state measurement equations to obtain the a priori delta-state measurement equations as:

$$[ \begin{matrix}δ {\overline{z}}_{x} ( k ) \\ {\overline{z}}_{N} ( k )\end{matrix} ] = [ \begin{matrix}{\overline{R}}_{xx} ( k ) & {\overline{R}}_{xN} ( k ) \\ 0 & {\overline{R}}_{NN} ( k )\end{matrix} ] [ \begin{matrix}δ x ( k ) \\ N\end{matrix} ] + [ \begin{matrix}{w}_{x} ( k ) \\ {w}_{N} ( k )\end{matrix} ] \qquad ( 90 )$$

where δz̅ₓ(k) is given by

δz̅ₓ(k)=z̅ₓ(k)−R̅ₓₓ(k)x̅(k) (91)

4. The normalized measurement equations are stacked above Eq. 90. Using a QR factorization, the a posteriori delta-state measurement equations are then obtained in the same form as Eq. 90.

5. Adding back in the a priori estimate x̅(k) to the a posteriori delta-state measurement equations results in the a posteriori state measurement equations in the same form as Eq. 86.

6. The a posteriori state and state covariance are then determined through the procedure specified above.

Before performing a CDGPS measurement update 422, the satellites tracked by the reference receiver 410 and mobile GPS receiver 104 are checked to see if the reference satellite should be changed or if any satellites should be dropped from or added to the list of satellites used in the measurement update. These changes necessitate modifications to the a priori state measurement equations prior to the CDGPS measurement update 422 to account for changes in the definition of the integer ambiguity vector.

To obtain the lowest possible covariance for the double-differenced measurements, the reference satellite should be chosen as the satellite with the largest carrier-to-noise ratio. This roughly corresponds to the satellite at the highest elevation for most GPS antenna gain patterns. The highest elevation satellite will change as satellite geometry changes. Thus, a procedure for changing the reference satellite is desired. It is assumed that the new reference satellite was already in the list of tracked satellites before this measurement update step 422.

Before swapping the reference satellite, the portion of the a priori state measurement equations corresponding to the integer ambiguities is given as:

$$\begin{matrix}{\overline{z}}_{N} ( k ) = [ \begin{matrix}{\overline{z}}_{N}^{1} ( k ) \\ ⋮ \\ {\overline{z}}_{N}^{i} ( k ) \\ ⋮ \\ {\overline{z}}_{N}^{M} ( k )\end{matrix} ] \\ = {\overline{R}}_{NN} ( k ) N + {w}_{N} ( k ) \\ = [ \begin{matrix}{\overline{R}}_{NN}^{11} ( k ) & … & {\overline{R}}_{NN}^{1 i} ( k ) & … & {\overline{R}}_{NN}^{1 M} ( k ) \\ 0 & ⋱ & ⋮ & & ⋮ \\ 0 & 0 & {\overline{R}}_{NN}^{ii} ( k ) & … & {\overline{R}}_{NN}^{iM} ( k ) \\ 0 & 0 & 0 & ⋱ & ⋮ \\ 0 & 0 & 0 & 0 & {\overline{R}}_{NN}^{MM} ( k )\end{matrix} ] [ \begin{matrix}{N}^{10} \\ ⋮ \\ {N}^{i 0} \\ ⋮ \\ {N}^{M 0}\end{matrix} ] + {w}_{N} ( k )\end{matrix} \qquad ( 92 )$$

where the ith SV is the new reference satellite. Recall that the integer ambiguities can be decomposed into:

N^{j0}=N^{j}−N⁰, for j=1, . . . ,M (93)

where N^{j} is the real-valued ambiguity on the single-differenced carrier-phase measurement for the jth SV. Therefore, the integer ambiguities with the ith SV as the reference can be related to the integer ambiguities with the original reference SV through the equation:

$${N}^{ji} = \{ \begin{matrix}{N}^{j 0} - {N}^{i 0} ; & j \neq 0 , i \\ - {N}^{i 0} ; & j = 0\end{matrix} \qquad ( 94 )$$

Using this relation, Eq. 92 can be rewritten with integer ambiguities referenced to the ith SV by modifying R̅_{NN}(k) and N as:

$$\begin{matrix}{\overline{z}}_{N} ( k ) = {\overline{R}}_{NN}^{′} ( k ) {N}^{′} + {w}_{N} ( k ) \\ = [ \begin{matrix}{\overline{R}}_{NN}^{11} ( k ) & … & {\overline{R}}_{NN}^{1 ( i - 1 )} ( k ) & {\overline{R}}_{NN}^{10} ( k ) & {\overline{R}}_{NN}^{1 ( i + 1 )} ( k ) & … & {\overline{R}}_{NN}^{1 M} ( k ) \\ 0 & ⋱ & ⋮ & ⋮ & ⋮ & & ⋮ \\ 0 & 0 & {\overline{R}}_{NN}^{( i - 1 ) ( i - 1 )} ( k ) & {\overline{R}}_{NN}^{( i - 1 ) 0} ( k ) & {\overline{R}}_{NN}^{( i - 1 ) ( i + 1 )} ( k ) & … & {\overline{R}}_{NN}^{( i - 1 ) M} ( k ) \\ 0 & 0 & 0 & {\overline{R}}_{NN}^{00} ( k ) & {\overline{R}}_{NN}^{0 ( i + 1 )} ( k ) & … & {\overline{R}}_{NN}^{0 M} ( k ) \\ 0 & 0 & 0 & {\overline{R}}_{NN}^{( i + 1 ) 0} ( k ) & {\overline{R}}_{NN}^{( i + 1 ) ( i + 1 )} ( k ) & … & {\overline{R}}_{NN}^{( i + 1 ) M} ( k ) \\ 0 & 0 & 0 & ⋮ & 0 & ⋱ & ⋮ \\ 0 & 0 & 0 & {\overline{R}}_{NN}^{M 0} ( k ) & 0 & 0 & {\overline{R}}_{NN}^{MM} ( k )\end{matrix} ] \times \\ [ \begin{matrix}{N}^{1 i} \\ ⋮ \\ {N}^{( i - 1 ) i} \\ {N}^{0 i} \\ {N}^{( i + 1 ) i} \\ ⋮ \\ {N}^{Mi}\end{matrix} ] + {w}_{N} ( k )\end{matrix} \qquad ( 95 )$$

where all elements of R̅_{NN}′(k) are equal to the corresponding elements in R̅_{NN}(k) except for the ith column. Note that the terms in the ith row have been given different superscripts, but these terms are all equal to the corresponding elements of R̅_{NN}(k) except for R̅_{NN}⁰⁰(k). The elements of the ith column are given by the following equation:

$${\overline{R}}_{NN}^{j 0} ( k ) = \{ \begin{matrix}- {\sum }_{l = j}^{M} {\overline{R}}_{NN}^{jl} ( k ) ; & j \neq 0 , i \\ - {\sum }_{l = i}^{M} {\overline{R}}_{NN}^{il} ( k ) ; & j = 0\end{matrix} \qquad ( 96 )$$

The cross-term between the real-valued and integer-valued portions of the state in the a priori state measurement equation, R̅_{xN}(k), must also be modified to account for this change in the integer ambiguity vector. Once again, only the ith column of R̅_{xN}(k) changes in value during this procedure. The elements of the ith column, using the same indexing scheme as before, are given by:

$${\overline{R}}_{xN}^{j 0} ( k ) = - {\sum }_{l = 1}^{M} {\overline{R}}_{xN}^{jl} ( k ) \qquad ( 97 )$$

Whenever one of the GPS receivers 104 or 410 is no longer tracking a particular satellite, the corresponding integer ambiguity must be removed from the filter state. If this satellite is the reference satellite, then the reference satellite must first be changed following the procedure described above so that only one integer ambiguity involves the measurements from the satellite to be removed. The satellite no longer tracked by both receivers 104 and 410 will be referred to as the ith SV for the remainder of this section.

The integer ambiguity for the ith SV can be removed by first shifting the ith integer ambiguity to the beginning of the state and swapping columns in R̅ₓₓ(k), R̅_{xN}(k), and R̅_{NN}(k) accordingly. After performing a QR factorization, the following equations are obtained:

$$[ \begin{matrix}{\overline{z}}_{N}^{i ′} ( k ) \\ {\overline{z}}_{x}^{′} ( k ) \\ {\overline{z}}_{N}^{′} ( k )\end{matrix} ] = [ \begin{matrix}{\overline{R}}_{{N}^{i 0} {N}^{i 0}}^{′} ( k ) & {\overline{R}}_{{N}^{i 0} x}^{′} ( k ) & {\overline{R}}_{{N}^{i 0} N}^{′} ( k ) \\ 0 & {\overline{R}}_{xx}^{′} ( k ) & {\overline{R}}_{xN}^{′} ( k ) \\ 0 & 0 & {\overline{R}}_{NN}^{′} ( k )\end{matrix} ] [ \begin{matrix}{N}^{i 0} \\ x ( k ) \\ {N}^{′}\end{matrix} ] + [ \begin{matrix}\begin{matrix}{w}_{{N}^{i 0}} ( k ) \\ {w}_{x} ( k )\end{matrix} \\ {w}_{N}^{′} ( k )\end{matrix} ] \qquad ( 98 )$$

The first equation and the integer ambiguity Nⁱ⁰ can simply be removed with minimal effect on the rest of the state. If Nⁱ⁰ were real-valued, then there would be no information lost regarding the values of the other states by this method. Since Nⁱ⁰ is constrained to be an integer, some information is lost in this reduction. However, this method minimizes the loss in information to only that which is necessary for removal of the ambiguity from the state.

Adding a satellite is necessary whenever a new satellite is being tracked by both receivers. This procedure is much simpler than removing satellites from the state, since all that is necessary is to append the new ambiguity to the state and add a column of zeros and a row containing the prior to the a priori state measurement equations. Since no a priori information is available about the integer ambiguity for the new satellite, a defuse prior is used in its place in the a priori state measurement equations. The defuse prior assumes that the new integer ambiguity has an expected value of 0 and infinite variance, which can be represented with a 0 in information form. The resulting appended a priori state measurement equations are:

$$\begin{matrix}[ \begin{matrix}{\overline{z}}_{x} ( k ) \\ {\overline{z}}_{N} ( k ) \\ 0\end{matrix} ] = [ \begin{matrix}{\overline{R}}_{xx} ( k ) & {\overline{R}}_{xN} ( k ) & 0 \\ 0 & {\overline{R}}_{NN} ( k ) & 0 \\ 0 & 0 & 0\end{matrix} ] [ \begin{matrix}x ( k ) \\ N \\ {N}^{( M + 1 ) 0}\end{matrix} ] + [ \begin{matrix}{w}_{x} ( k ) \\ {w}_{N} ( k ) \\ {w}_{{N}^{( M + 1 ) 0}} ( k )\end{matrix} ] \\ = [ \begin{matrix}{\overline{z}}_{x} ( k ) \\ {\overline{z}}_{N}^{′} ( k )\end{matrix} ] \\ = [ \begin{matrix}{\overline{R}}_{xx} ( k ) & {\overline{R}}_{xN}^{′} ( k ) \\ 0 & {\overline{R}}_{NN}^{′} ( k )\end{matrix} ] [ \begin{matrix}x ( k ) \\ {N}^{′}\end{matrix} ] + [ \begin{matrix}{w}_{x} ( k ) \\ {w}_{N}^{′} ( k )\end{matrix} ]\end{matrix} \qquad ( 99 )$$

Between measurement updates, the state measurement equations are propagated forward in time using either the INS or INS-free dynamics model previously derived, depending on whether or not accelerometer measurements from the IMU 416 are available. A propagation step 414 is triggered by either an accelerometer measurement or a measurement update at a different time from the time index of the current filter state. Table 4 provides a list of equations for the dynamics models as a reference.

TABLE 4
List of Equations for the Dynamics Models

| | Difference | State Transition | Process Noise |
|---|---|---|---|
| | Equation | Matrix | Covariance |
| Type | x(k + 1) | F(k) | Q(k) |
| INS | Eq. 68 | Eq. 70 | Eq. 71 |
| INS-Free | Eq. 82 | Eq. 83 | Eq. 84 |

A summary of this procedure is as follows:

1. The a priori estimate x̅(k+1) is computed from the state difference equation evaluated at the a posteriori estimate x̅(k) and the time interval of the propagation step, Δt. Equation numbers for the state difference equations are listed in Table 4 for both dynamics models.

2. The a posteriori state measurement equations at the beginning of the propagation interval are stacked below the process noise measurement equation given as:

zᵥ(k)=0=Rᵥᵥ(k)v(k)+wᵥ(k) (100)

where Rᵥᵥ(k) is the Cholesky factorization of the inverse of the process noise covariance. Equation numbers for the process noise covariances are listed in Table 4 for both dynamics models.

3. x(k+1) is substituted for x(k) in the stacked process noise and state measurement equations through the linearized dynamics equation. The linearized dynamics equation is simply the difference equation evaluated at the a posteriori estimate \hat{x}(k) plus the term F(k)(x(k)−\hat{x}(k)). Equation numbers for the state transition matrix, F(k), are listed in Table 4 for both dynamics models.

4. Using a QR factorization, the a priori state measurement equations at the end of the propagation interval are obtained in the same form as Eq. 86. If the a priori state covariance is desired, then it can be computed through the procedure specified above.

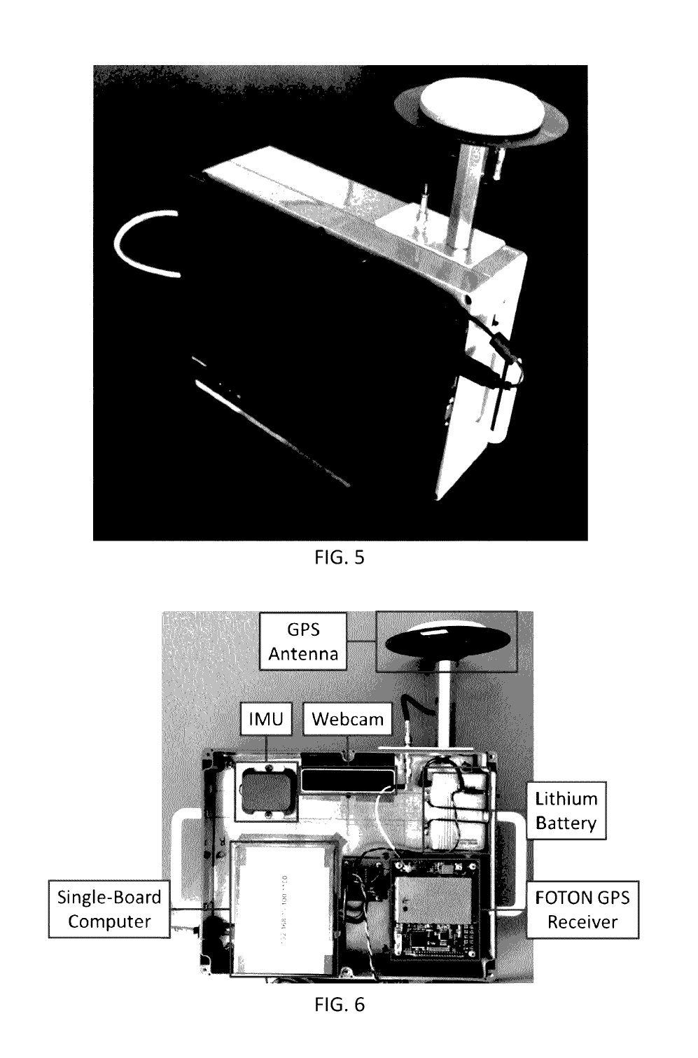

A prototype AR system based on the navigation filter 408 defined above was designed and built to demonstrate the accuracy of such a system. FIG. 5 shows a picture of the prototype AR system in accordance with one embodiment of the present invention, which is composed of a tablet computer attached to a sensor package. A webcam points out the side of the sensor package opposite from the tablet computer to provide a view of the real world that is displayed on the tablet computer and augmented with virtual elements. The tablet computer could thus be thought of as a “window” into the AR environment; a user looking “through” the tablet computer would see an augmented representation of the real world on the other side of the AR system. However, the navigation filter and augmented visuals are currently only implemented in post-processing. Therefore, the tablet computer simply acts as a data recorder at present. This prototype AR system is an advanced version of that presented in [47].

The hardware and software used for the sensor package in the prototype AR system will now be described. This sensor package can be divided into three navigation “subsystems”, CDGPS, INS, and VNS, which are detailed separately in the following sections. For reference, a picture of the sensor package for the prototype augmented reality system of FIG. 5 with each of the hardware components labeled is shown in FIG. 6. Each of the labeled components, except the Lithium battery, are detailed in the hardware section for their corresponding subsystem.

The CDGPS subsystem 404 is represented in the block diagram in FIG. 4 by the boxes encircled by a blue dashed line. The sensors for the CDGPS subsystem 404 are the mobile GPS receiver 104 and the reference GPS receiver 410, which is not part of the sensor package. The reference GPS receiver 410 used for the tests detailed below was a CASES software-defined GPS receiver developed by The University of Texas at Austin and Cornell University. CASES can report GPS observables and pseudorange-based navigation solutions at a configurable rate, which was set to 5 Hz for the prototype AR system. These data can be obtained from CASES over the Internet 412. Further information on CASES can be found in [55]. For the tests detailed below, CASES operated on data collected from a high-quality Trimble antenna located at a surveyed location on the roof of the W. R. Woolrich Laboratories at The University of Texas at Austin. The mobile GPS receiver, which is part of the sensor package, is composed of the hardware and software described below.

The mobile GPS receiver used for the prototype AR system was the FOTON software-defined GPS receiver developed by The University of Texas at Austin and Cornell University. FOTON is a dual-frequency receiver that is capable of tracking GPS L1 C/A and L2C signals, but only the L1 C/A signals were used in the prototype AR system. FOTON can be seen in the lower right-hand corner of FIG. 6. The workhorse of FOTON is a digital signal processor (DSP) running the GRID software receiver, which is described below.

The single-board computer (SBC) is used for communications between FOTON and the tablet computer. FOTON sends data packets to the SBC over a serial interface. These data packets are then buffered by the SBC and sent to the tablet computer via Ethernet. The SBC is not strictly necessary and could be removed from the system in the future if a direct interface between FOTON and the tablet computer were created.

The SBC is located under the metal cover in the lower left-hand corner of FIG. 6. This metal cover was placed over the SBC because the SBC was emitting noise in the GPS band that was reaching the antenna and causing significant degradation of the received carrier-to-noise ratio. The addition of the metal cover largely eliminated this problem.

The GPS antenna used for the prototype AR system was a 3.5″ GPS L1/L2 antenna from Antcom [56]. This antenna can be seen in the upper right-hand corner of FIG. 6. This antenna has good phase-center stability, which is necessary for CDGPS, but is admittedly quite large. Reducing the size of the antenna much below this while maintaining good phase-center stability is a difficult antenna design problem that has yet to be solved. Therefore, the size of the antenna is currently the largest obstacle to miniaturizing the sensor package for an AR system employing CDGPS.

As mentioned above, the GRID software receiver, which was developed by The University of Texas at Austin and Cornell University, runs on the FOTON's DSP [57, 58]. GRID is responsible for:

1. Performing complex correlations between the digitized samples from FOTON's radio-frequency front-end at an intermediate frequency and local replicas of the GPS signals.

2. Acquiring and tracking the GPS signals based on these complex correlations.

3. Computing the GPS observables measurements and pseudorange-based navigation solutions.

GPS observables measurements and pseudorange-based navigation solutions can be output from GRID at a configurable rate, which was set to 5 Hz for the prototype AR system.

Carrier-phase cycle slips are a major problem in CDGPS-based navigation because cycle slips result in changes to the integer ambiguities on the double-differenced carrier-phase measurements. Thus, cycle slip prevention is paramount for CDGPS. GRID was originally developed for Ionospheric monitoring. As such, GRID has a scintillation robust PLL and databit prediction capability, which both help to prevent cycle slips [55].

The INS subsystem 402 is represented in the block diagram in FIG. 4 by the boxes encircled by a red dashed line. The sensors for the INS subsystem 402 are contained within a single IMU 416 located on the sensor package. This IMU 416 is detailed below.

The IMU 416 used for the prototype AR system was the XSens MTi, which can be seen in the center of the left-hand side of FIG. 4. This IMU 416 is a complete gyroenhanced attitude and heading reference system (AHRS). It houses four sensors, (1) a magnetometer, (2) a three-axis gyro, (3) a three-axis accelerometer, and (4) a thermometer. The MTi also has a DSP running a Kalman filter, referred to as the XSens XKF, that determines the attitude of the MTi relative to the north-west-up (NWU) coordinate system, which is converted to ENU for use in the navigation filter 408.

In addition to providing attitude, the MTi also provides access to the highly stable, temperature-calibrated (via the thermometer and high-fidelity temperature models) magnetometer, gyro, and accelerometer measurements. The MTi can output these measurements and the attitude estimate from the XKF at a configurable rate, which was set to 100 Hz for the prototype AR system. In order to obtain a time stamp for the MTi data, the MTi measurements were triggered by FOTON, which also reported the GPS time the triggering pulse was sent.

As mentioned above, the XSens XKF is a Kalman filter that runs on the MTi's DSP and produces estimates of the attitude of the MTi relative to NWU. This Kalman filter determines attitude by ingesting temperature-calibrated (via the MTi's thermometer and high-fidelity temperature models) magnetometer, gyro, and accelerometer measurements from the MTi to determine magnetic North and the gravity vector. If the XKF is given magnetic declination, which can be computed from models of the Earth's magnetic field and the position of the system, then true North can be determined from magnetic North. Knowledge of true North and the gravity vector is sufficient for full attitude determination relative to NWU. This estimate of orientation is reported in the MTi specifications as accurate to better than 2° RMS for dynamic operation. However, magnetic disturbances and long-term sustained accelerations can cause the estimates of magnetic North and the gravity vector respectively to develop biases.

The VNS subsystem 406 is represented in the block diagram in FIG. 4 by the boxes encircled by a green dashed line. The VNS subsystem 406 uses video from a webcam 108 located on the sensor package to extract navigation information via a stand-alone BA-based visual SLAM algorithm 418. This webcam 108 and the visual SLAM software 418 are detailed below.

The webcam 108 used for the prototype AR system was the FV Touchcam N1, which can be seen in the center of FIG. 6. The Touchcam N1 is an HD webcam capable of outputting video in several formats and frame-rates including 731P-format video at 22 fps and WVGA-format video at 30 fps. The Touchcam N1 also has a wide angle lens with a 78.1° horizontal field of view.

The visual SLAM algorithm 418 used for the prototype AR system was PTAM developed by Klein and Murray [45]. PTAM is capable of tracking thousands of point features and estimating relative pose up to an arbitrary scale-factor at 30 Hz frame-rates on a dual-core computer. Further details on PTAM can be found above and [45].

Time alignment of the relative pose estimates from PTAM with GPS time was performed manually, since the webcam video does not contain time stamps traceable GPS time. This time alignment was performed by comparing the relative pose from PTAM and the coupled CDGPS and INS solution over the entire dataset. The initial guess for the GPS time of the first relative pose estimate from PTAM is taken as the GPS time of the first observables measurement of the dataset. The time rate offset is assumed to be zero, which is a reasonable assumption for short datasets. From a plot of the range to the reference GPS antenna assuming initial guesses for x_{ECEF}^{V}, q_{V}^{ECEF}, and λ of x_{ECEF}^{B}, [1 0 0 0]^{T} and 1 respectively, the time offset between GPS time and the initial guess for PTAM's solution can be determined by aligning the changes in the range to the reference GPS receiver in time. Note that the traces in this plot will not align because x_{ECEF}^{V}, q_{V}^{ECEF}, and λ have yet to be determined. However, the times when the range to the reference GPS receiver changes can be aligned. Better guesses for x_{ECEF}^{V}, q_{V}^{ECEF}, and λ can be determined from the initialization procedure described above once the data has been time aligned.

The test results for the prototype augmented reality system will now be described. The prototype AR system described above was tested in several different modes of operation to demonstrate the accuracy and precision of the prototype AR system. These modes were CDGPS, coupled CDGPS and INS, and coupled CDGPS, INS, and VNS. Testing these modes incrementally allows for demonstration of the benefits of adding each additional navigation subsystem to the prototype AR system. These results demonstrate the positioning accuracy and precision of the CDGPS subsystem 404. Next, results from the coupled CDGPS and INS mode are presented for the dynamic scenario. The addition of the INS 402 provides both absolute attitude information and inertial measurements to smooth out the position solution between CDGPS measurements. The coupled CDGPS and INS solution is also compared to the VNS solution after determining the similarity transform between the V-frame and ECEF. Finally, results from the complete navigation system, which couples CDGPS 404, INS 402, and VNS 406, are given for the dynamic scenario. These results demonstrate significant improvement of performance over the coupled CDGPS and INS solution in both absolute positioning and absolute attitude.

In CDGPS mode, the prototype AR system only processes measurements from the CDGPS subsystem 404. Therefore, attitude cannot be estimated by the navigation filter in this mode. However, this mode is useful for demonstrating the positioning accuracy and precision attained by the CDGPS subsystem 404. The following sections present test results for both static and dynamic tests of the system in this mode.

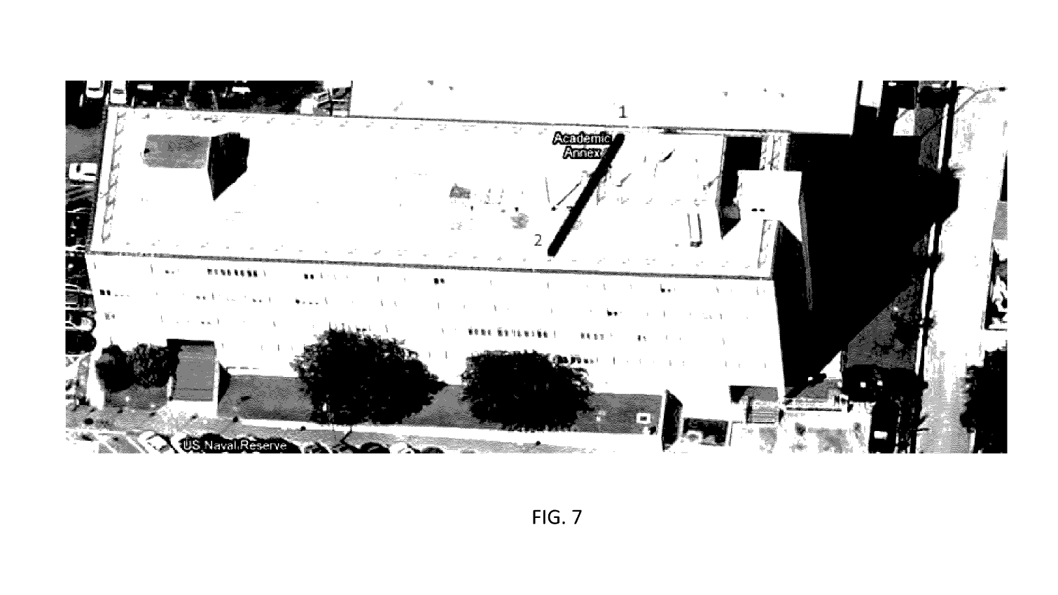

FIG. 7 is a photograph showing the approximate locations of the two antennas used for the static test. Antenna 1 is the reference antenna, which is also used as the reference antenna for the dynamic test. The two antennas were separated by a short baseline distance and located on top of the W. R. Woolrich Laboratories (WRW) at The University of Texas at Austin. This baseline distance between the two receivers was measured by tape measure to be approximately 21.155 m [47]. Twenty minutes of GPS observables data was collected at 5 Hz from receivers connected to each of the antennas. This particular dataset had data from 11 GPS satellites with one of the satellites rising 185.2 s into the dataset and another setting 953 s into the dataset.

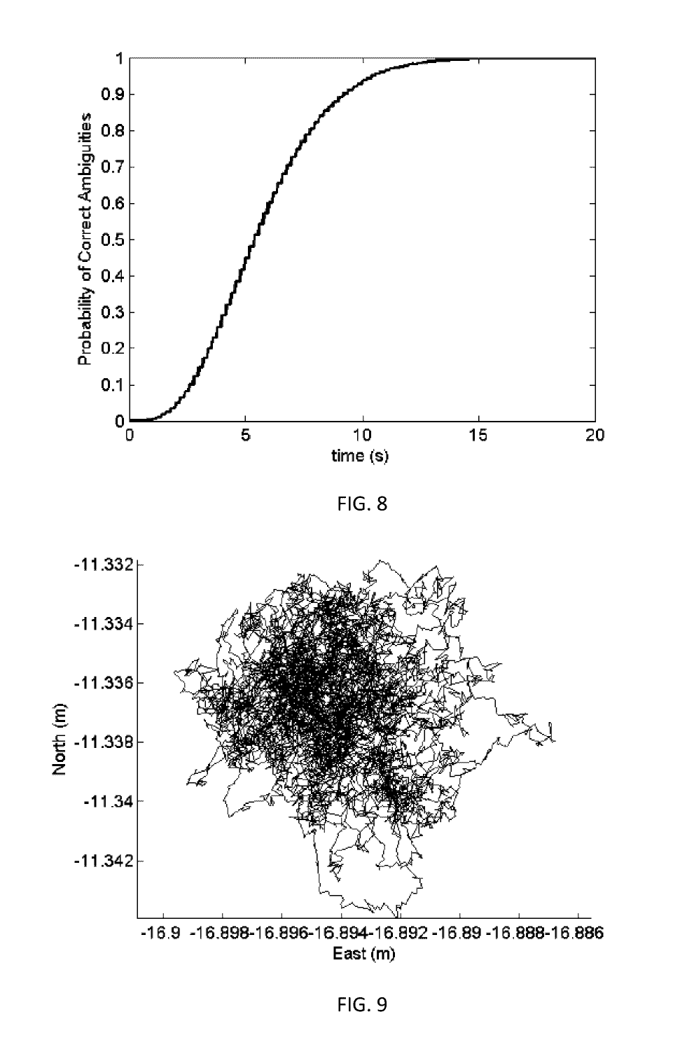

FIG. 8 shows a lower bound on the probability that the integer ambiguities have converged to the correct solution for the first 31 s of the static test. A probability of 0.999 was used as the metric for declaring that the integer ambiguities have converged to the correct values and was attained 15.8 s into the test. The integer ambiguities actually converged to the correct values and remained at the correct values after the first 10.6 s of the test, even with a satellite rising and another setting during the dataset. This demonstrates that the methods for handling adding and dropping of integer ambiguities to/from the filter state outlined above are performing as expected.

Although the true convergence of the integer ambiguities occurred prior to reaching the 0.999 lower bound probability metric for this test, other tests not presented herein revealed that this is all too often not the case for the CDGPS algorithm as implemented as described herein. This is likely due to ignoring the time correlated multipath errors on the double-differenced GPS observables measurements. The GPS antennas and receivers used for the prototype system do not have good multipath rejection capabilities. Therefore, future versions of the prototype system will need to better handle multipath errors on the double-differenced GPS observables measurements to enable confidence in the convergence metric. This could be accomplished through the use of receiver processing techniques to mitigate the effects of multipath on the GPS observables.

A trace of the East and North coordinates of the mobile antenna relative to the reference antenna, whose location is known in ECEF, as estimated by the prototype AR system in CDGPS mode is shown in FIG. 9 for the static test. Only position estimates from after the integer ambiguities were declared converged are shown in FIG. 9. These position estimates all fit inside a 2 cm by 2 cm by 4 cm rectangular prism in ENU centered on the mean position, which demonstrates the precision of the CDGPS subsystem 404. The mean of the position estimates expressed in the ENU-frame centered on the reference antenna was E[x_{ENU}^{B}]=[−16.8942 11.3368 −5.8082] m. This results in an estimated baseline distance of 21.1583 m, which is almost exactly the measured baseline distance of 21.155 m. This difference between the estimated and measured baselines is well within the expected error of the measured baseline, thus demonstrating the accuracy of the CDGPS subsystem 404.

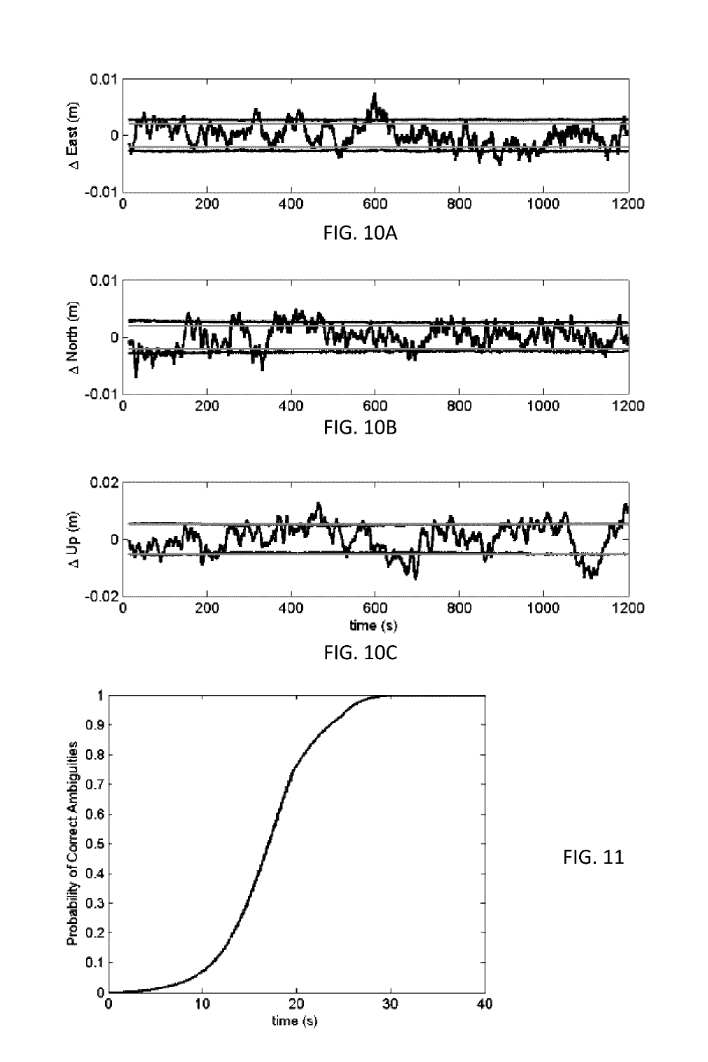

To further illustrate the precision of the CDGPS subsystem 404, FIGS. 10A, 10B and 10C show plots of the deviations (in blue) of the East position estimates (FIG. 10A), North position estimates (FIG. 10B), and Up position estimates (FIG. 10C) from the mean over the entire dataset from after the integer ambiguities were declared converged. The +/−1 standard deviation bounds are also shown in FIGS. 10A, 10B and 10C based on both the filter covariance estimate (in red) and the actual standard deviation (in green) of the position estimates over the entire dataset. The actual standard deviations were σ_{E}=0.002 m, σ_{N}=0.002 m, and σ_{U}=0.0051 m. As can be seen from FIGS. 10A, 10B and 10C, the filter covariance estimates closely correspond to the actual covariance of the data over the entire dataset, which is a highly desirable quality that arises because the noise on the GPS observables measurements is well modeled.

The dynamic test was performed using the same reference antenna, identified as 1 in FIG. 7, as the static test. The prototype AR system, which was also on the roof of the WRW for the entire dataset, remained stationary for the first four and a half minutes of the dataset to ensure that the integer ambiguities could converge before the system began moving. This is not strictly necessary, but ensured that good data was collected for analysis. After this initial stationary period, the prototype AR system was walked around the front of a wall for one and a half minutes before returning to its original location. Virtual graffiti was to be augmented onto the real-world view of the wall provided by the prototype AR system's webcam. This approximately 6 minute dataset contained data from 10 GPS satellites with one of the satellites rising 320.4 s into the dataset.

One of the satellites was excluded from the dataset because it was blocked by the wall when the system began moving, which caused a number of cycle slips prior to the mobile GPS receiver loosing lock on the satellite. Most cycle slips are prevented by masking out low elevation satellites, but environmental blockage such as this can pose significant problems. Therefore, a cycle slip detection and recovery algorithm would be useful for the AR system and is an area of future work.

FIG. 11 shows a lower bound on the probability that the integer ambiguities have converged to the correct solution for the first 40 s of the dynamic test. The integer ambiguities were declared converged by the filter after a probability of 0.999 was attained 31.4 s into the test. This took almost twice as long as for the static test because this dataset only had data from 8 GPS satellites during this interval while the static test had data from 10 GPS satellites. The integer ambiguities actually converged to the correct value and remained at the correct value after the first 10.6 s of the test, which only coincidentally corresponds to actual convergence time for the static test.

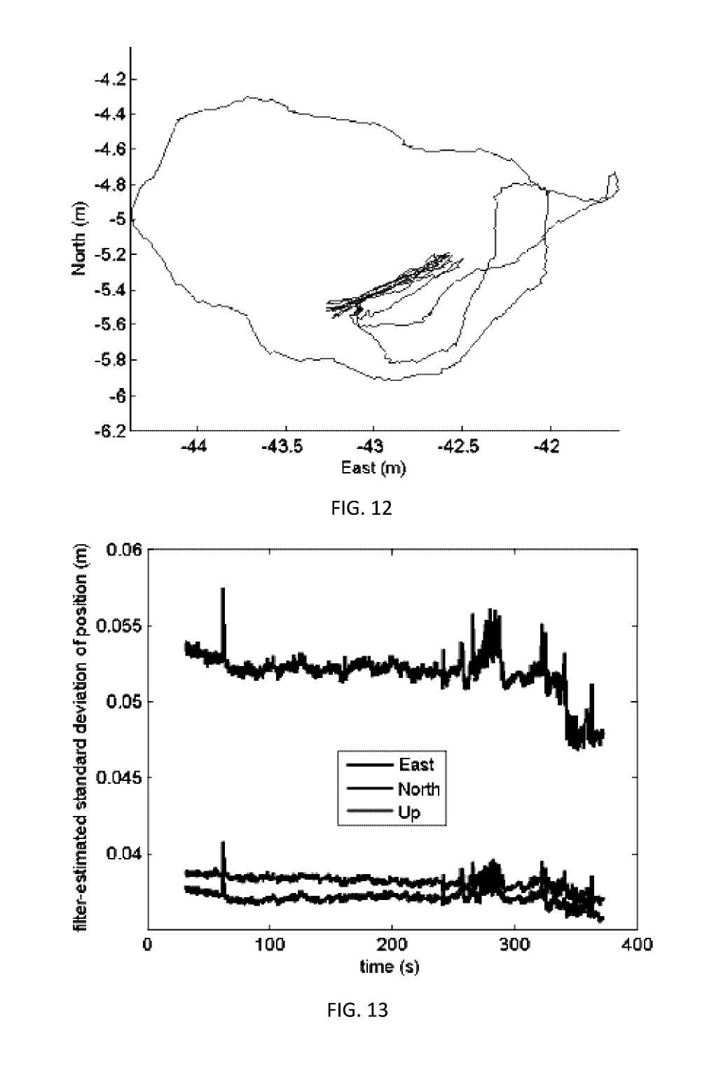

A trace of the East and North coordinates of the mobile antenna relative to the reference antenna as estimated by the prototype AR system in CDGPS mode is shown in FIG. 12 for the dynamic test. Only position estimates from after the integer ambiguities were declared converged are shown in FIG. 12. The system began at a position of roughly [−43.077, −5.515, 6.08] m before being picked up, shaken from side to side a few times, and carried around while looking toward a wall that was roughly north of the original location. Position estimates were output from the navigation filter at 30 Hz, while GPS measurements were only obtained at 5 Hz. The INS-free dynamics model described above is used to propagate the solution between GPS measurements. This dynamics model knows nothing about the actual dynamics of the system. Therefore, the positioning accuracy suffers during motion of the system. The position estimate is also not very smooth, which may cause any augmented visuals based on this position estimate to shake relative to the real world. Therefore, a better dynamics model is desired in order to preserve the illusion of realism of the augmented visuals during motion.

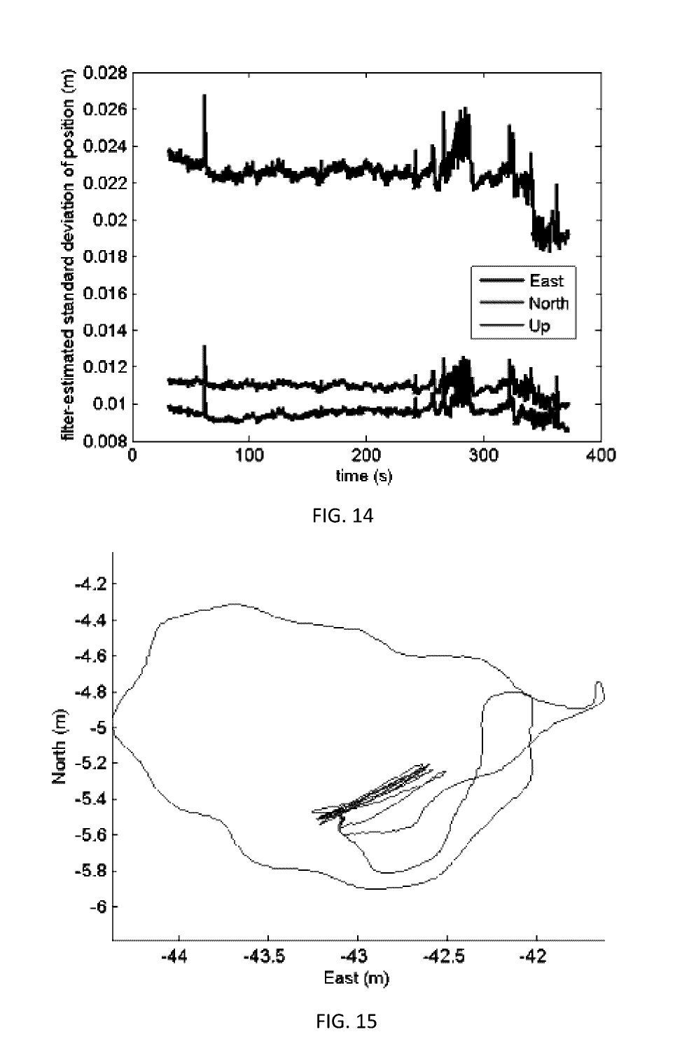

To illustrate the precision of the estimates, FIGS. 13 and 14 show the standard deviations of the ENU position estimates of the mobile antenna based on the filter covariance estimates from the prototype AR system in CDGPS mode from just before and just after CDGPS measurement updates 422 respectively. Taking standard deviations of the position estimates from these two points in the processing demonstrates the best and worst case standard deviations for the system. These standard deviations are an order of magnitude larger than those for the static test because the standard deviation of the velocity random walk term in the dynamics model was increased from 0.001 m/s^{3/2} (roughly stationary) to 0.5 m/s^{3/2}, which is a reasonable value for human motion. Velocity random walk essentially models the acceleration as zero-mean Gaussian white noise with an associated covariance. This is typically a good model for human motion provided that the associated covariance is representative of the true motion. Assuming that the chosen velocity random walk covariance is representative of the true motion, the position estimates are accurate to centimeter-level at all times, as can be seen in FIGS. 13 and 14.

The addition of an INS 402 to the system allows for determination of attitude relative to ECEF and a better dynamics model that leverages accelerometer measurements to propagate the state between CDGPS measurements. This mode produces precise and globally-referenced pose estimates that can be used for AR. However, the IMU attitude solution is susceptible local magnetic disturbances and long-term sustained accelerations, which may cause significant degradation of performance. This will be illustrated in the following sections, which provide results for the dynamic test described above.

A trace of the East and North coordinates of the mobile antenna relative to the reference antenna as estimated by the prototype AR system in coupled CDGPS and INS mode is shown in FIG. 15 for the dynamic test. Only position estimates from after the integer ambiguities were declared converged, which occurred at the same time as in CDGPS mode, are shown in FIG. 15. From comparing FIGS. 15 and 12, it can be seen that the addition of the INS 402 resulted in a much more smoothly varying estimate of the position. While accuracy of the position estimates is very important for AR to reduce the registration errors, accurate position estimates that have a jerky trajectory will result in virtual elements that shake relative to the background. If the magnitude of this shaking is too large, then the illusion of realism of the virtual object will be broken.

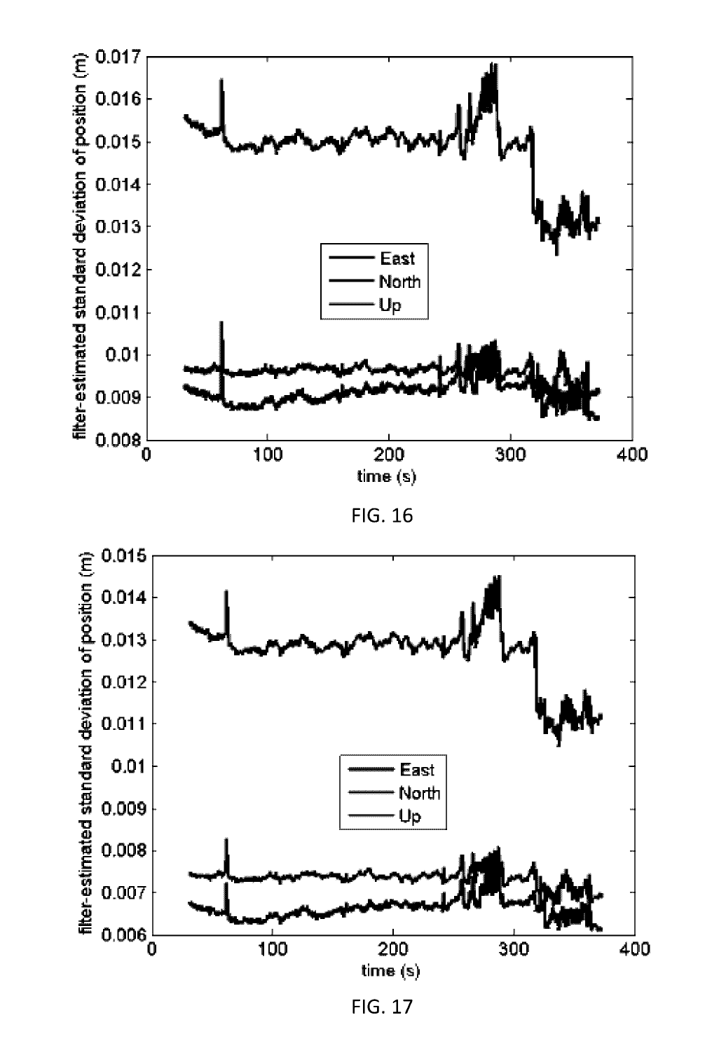

To illustrate the precision of the position estimates, FIGS. 16 and 17 show the standard deviations of the ENU position estimates of the IMU based on the filter covariance estimates from the prototype AR system in coupled CDGPS and INS mode from just before and just after CDGPS measurement updates 422 respectively. The standard deviations taken from before the CDGPS measurement updates 422 for this mode are significantly smaller than those from the CDGPS mode, shown in FIG. 13, as expected. This is due to the improvement in the dynamics model of the filter enabled by the accelerometer measurements from the IMU 416. In fact, the reduction in process noise enabled by the IMU accelerometer measurements lowers the standard deviations to the point that the standard deviations taken from before the CDGPS measurement updates 422 for this mode are slightly smaller than those from after the CDGPS measurement updates 422 for CDGPS mode, shown in FIG. 14.

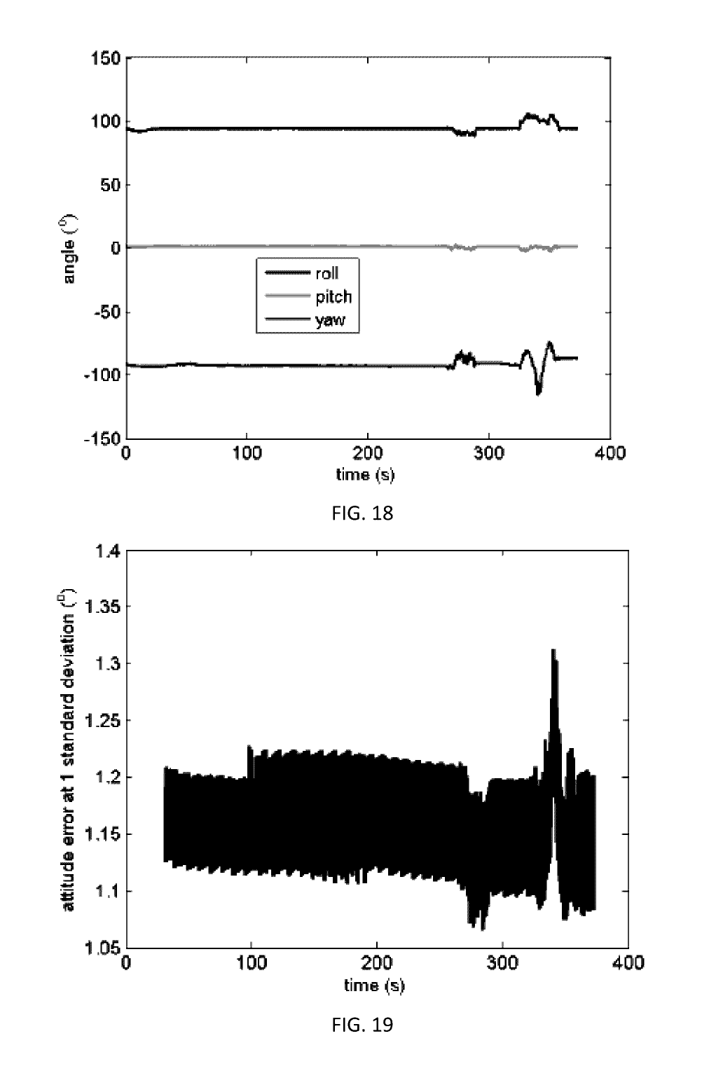

The attitude estimates, expressed as standard yaw-pitch-roll Euler angle sequences, from the prototype AR system in coupled CDGPS and INS mode are shown in FIG. 18 for the dynamic test. It was discovered during analysis of this dataset that the IMU estimated attitude had a roughly constant 26.5° bias in yaw, likely due to a magnetic disturbance throwing off the IMU's estimate of magnetic North. The discovery of the bias is detailed below. This bias was removed from the IMU data and the dataset reprocessed such that all results presented herein do not contain this roughly constant portion of the bias. In future versions of the prototype AR system, it is thus desirable to eliminate the need of a magnetometer to estimate attitude. This can be accomplished through a tighter coupling of CDGPS 404 and VNS 406, as previously explained.

To illustrate the precision of the attitude estimates, FIG. 19 shows the expected standard deviation of the rotation angle between the true attitude and the estimated attitude from the prototype AR system in coupled CDGPS and INS mode for the dynamic test. This is computed from the filter covariance estimate based on the definition of the quaternion, as follows:

$$θ ( k ) = 2 arcsin ( \sqrt{{P}_{( δ {e}_{1} , δ {e}_{1} )} ( k ) + {P}_{( δ {e}_{2} , δ {e}_{2} )} ( k ) + {P}_{( δ {e}_{3} , δ {e}_{3} )} ( k )} ) \qquad ( 101 )$$

where P_{(δe1,δe1)}(k), P_{(δe2,δe2)}(k), and P_{(δe3,δe3)}(k) are the diagonal elements of the filter covariance estimate corresponding to the elements of the differential quaternion. This shows that the filter believes the error in its estimate of attitude has a standard deviation of no worse than 1.35° at any time. It should be noted that since no truth data is available it is not possible to verify the accuracy of the attitude estimate, but consistency, or lack of consistency, between this solution and the VNS solution is shown below.

The addition of a VNS 406 to the system provides a second set of measurements of both position and attitude. The additional attitude measurement is of particular consequence because VNS attitude measurements are not susceptible to magnetic disturbances like the INS attitude measurements. The loose coupling of the VNS 406 to both CDGPS 404 and INS 402 implemented in this prototype AR system does enable improvement of the estimates of both absolute position and absolute attitude over the coupled CDGPS and INS solution. However, this requires that the prototype AR system estimate the similarity transform between ECEF and the V-frame. In the future, this intermediate V-frame could be eliminated through a tighter coupling of the VNS 406 and CDGPS 404, as previously explained.

This section begins by demonstrating that the VNS solution is consistent, except for a roughly constant bias in the IMU attitude estimate, with the coupled CDGPS and INS solution for the dynamic test. Then, the results for the prototype AR system in coupled CDGPS 404, INS 402, and VNS 406 mode are provided for the dynamic test described above.

Before coupling the VNS 406 to the CDGPS 404 and INS 402 solution, consistency between the two solutions can be demonstrated with a single constant estimate of the similarity transform between ECEF and the V-frame. While this does not prove the accuracy of either solution in an absolute sense, consistency of the two solutions demonstrates accurate reconstruction of the trajectory of the prototype AR system. Combining this with the proven positioning accuracy of the CDGPS-based position estimates and motion of the system results in verification of the accuracy of the complete pose estimates. To be more specific, a bias in the attitude estimates from the IMU 416 would find its way into the estimate of the similarity transform between ECEF and the V-frame and, for the procedure for determining this similarity transform described above, would result in a rotation of the VNS position solution about the initial location of the prototype AR system. This is how the bias in the IMU's estimate of yaw was discovered.

The estimate of the similarity transform between ECEF and the V-frame is determined through the initialization procedure described above. This procedure may not result in the best estimate of the similarity transform, but it will be close to the best estimate. The VNS solution after transformation to absolute coordinates through the estimate of the similarity transform will be referred to as the calibrated VNS solution for the remainder of this section.

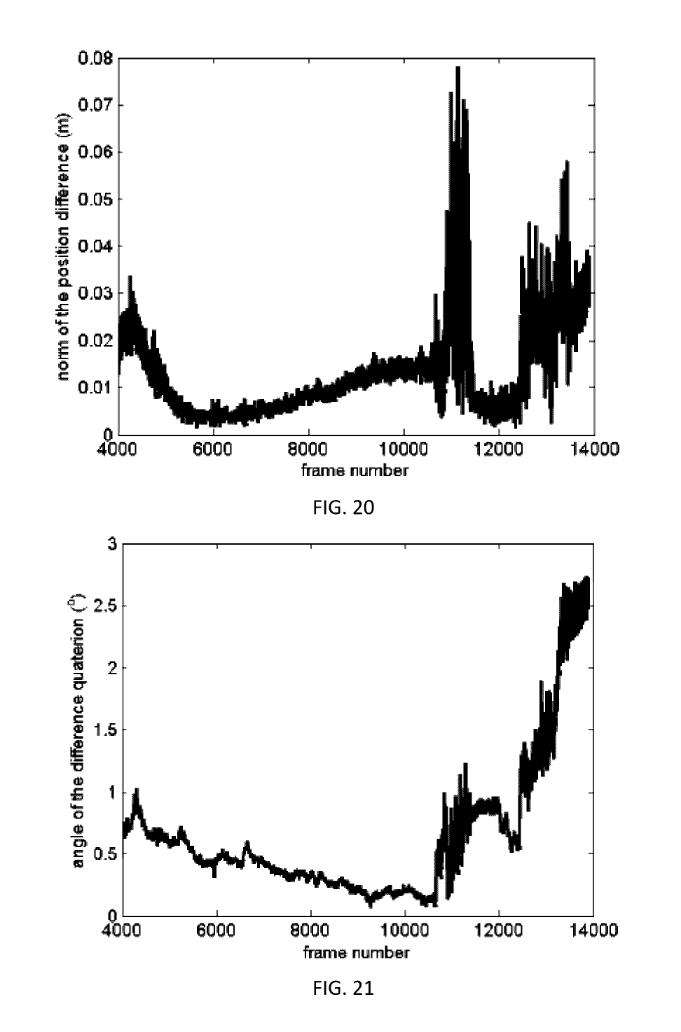

FIG. 20 shows the norm of the difference between the position of the webcam as estimated by the prototype AR system in coupled CDGPS and INS mode and the calibrated VNS solution from PTAM for the dynamic test. During stationary portions of the dataset, the position estimates agree to within 2 cm of one another at all times after an initial settling period. During periods of motion, the position estimates still agree to within 5 cm for more than 90% of the time. This larger difference between position estimates during motion occurs primarily because errors in the estimate of the similarity transform between ECEF and the V-frame are more pronounced during motion. Even with these errors, centimeter-level agreement of the position estimates between the two solutions is obtained at all times. The agreement might be even better if a more accurate estimate of the similarity transform between ECEF and the V-frame were determined.

FIG. 21 shows the rotation angle between the attitude of the webcam as estimated by the prototype AR system in coupled CDGPS 404 and INS 402 mode and the calibrated VNS 406 solution from PTAM for the dynamic test. The attitude estimates agree to within a degree for the entirety of the stationary period of the dataset. Once the system begins moving, the attitude estimates diverge from one another. By the end of the dataset, the two solutions only agree to within about 3°. This divergence was a result of the IMU 416 trying to correct the 26.5° bias in yaw that was mentioned above and removed from the IMU data. In the absence of the magnetic disturbance that caused this IMU bias to occur in the first place, the IMU 416 should be accurate to 2° during motion and 1° when stationary according to the datasheet. While these solutions are not consistent due to the IMU bias, it is reasonable to expect based on these results that the two solutions would be consistent if there were no bias in the IMU attitude estimates.

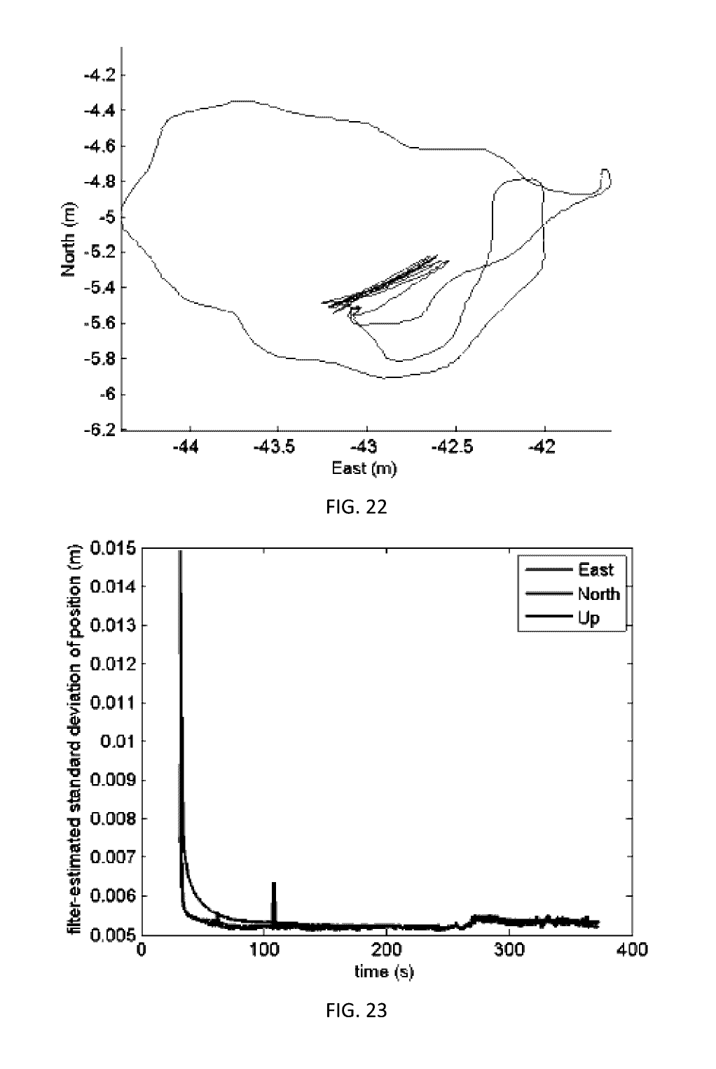

A trace of the East and North coordinates of the mobile antenna relative to the reference antenna as estimated by the prototype AR system in coupled CDGPS 404, INS 402, and VNS 406 mode is shown in FIG. 22 for the dynamic test. Only position estimates from after the integer ambiguities were declared converged, which occurred at the same time as in CDGPS mode, are shown in FIG. 22. This solution is nearly the same as the coupled CDGPS and INS solution from FIG. 15, which was expected based on the consistency of the two solutions demonstrated herein. The VNS corrections to the position estimates were small and are difficult to see at this scale, except for a few places.

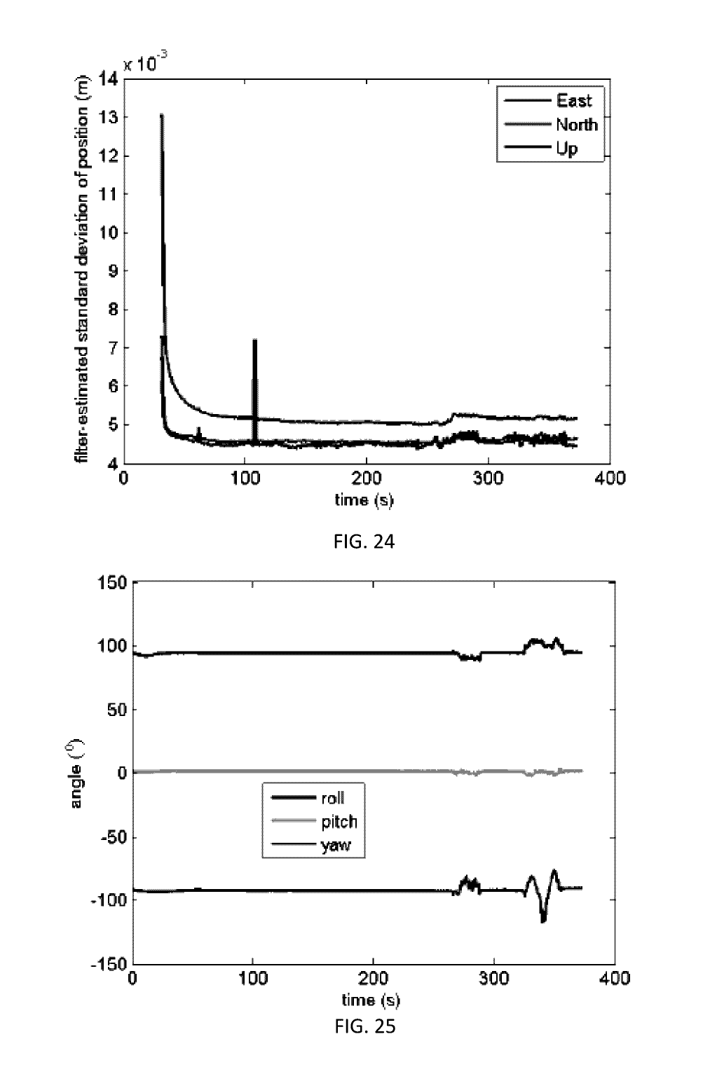

To illustrate the precision of the position estimates, FIGS. 23 and 24 show the standard deviations of the ENU position estimates of the IMU 416 based on the filter covariance estimates from the prototype AR system in coupled CDGPS 404, INS 402, and VNS 406 mode from just before and just after CDGPS measurement updates 422 respectively. These standard deviations are significantly smaller than those for the coupled CDGPS and INS mode, shown in FIGS. 16 and 17. Note that the covariance on the VNS position estimates was not provided by the VNS 406, but instead simply chosen to be a diagonal matrix with elements equal to 0.01² m² based on the consistency results from above.

The attitude estimates, expressed as standard yaw-pitch-roll Euler angle sequences, from the prototype AR system in coupled CDGPS 404, INS 402, and VNS 406 mode are shown in FIG. 25 for the dynamic test. This solution is nearly the same as the coupled CDGPS and INS solution from FIG. 18, which was expected based on the consistency of the two solutions demonstrated above. One point of difference to note occurs in the yaw estimate near the end of the dataset. It was mentioned above that the IMU yaw drifted toward the end of the dataset. The yaw at the end of the dataset should exactly match that during the initial stationary period, since the prototype AR system was returned to the same location at the same orientation for the last 15 to 20 s of the dataset. The inclusion of VNS attitude helped to correct some of this bias. However, this is an unmodeled error in the dataset that could not be completely removed by the filter.

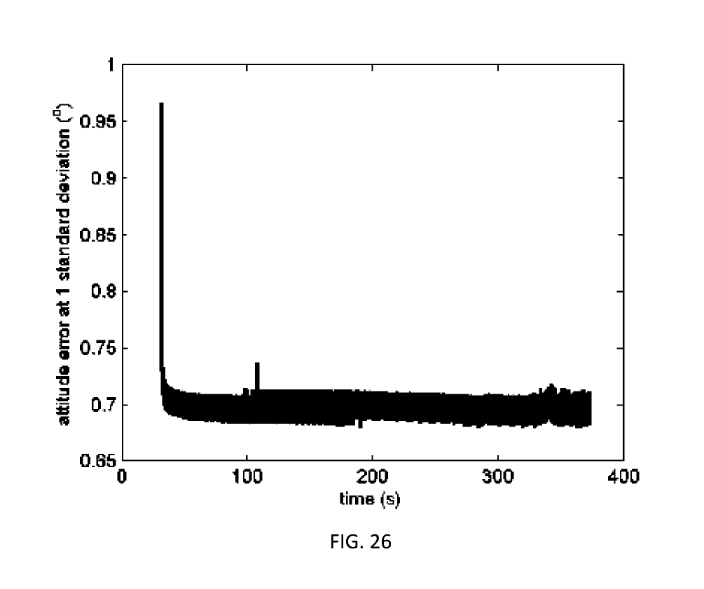

To illustrate the precision of the attitude estimates, FIG. 26 shows the expected standard deviation of the rotation angle between the true attitude and the estimated attitude from the prototype AR system in coupled CDGPS 404, INS 402, and VNS 406 mode for the dynamic test. This is computed from the filter covariance estimate using Eq. 101. This shows that the filter believes the error in its estimate of attitude has a standard deviation of no worse than 0.75° at any time after an initial settling period, which is almost twice as small as that obtained from the prototype AR system in coupled CDGPS 404 and INS 402 mode, as seen in FIG. 19. Note that the covariance on the VNS attitude estimates was not provided by the VNS, but instead simply chosen to be a diagonal matrix with elements equal to 0.005², which corresponds to a standard deviation of 1°, based on the consistency results from above.

When people think of AR, they imagine a world where both entirely virtual objects and real objects imbued with virtual properties could be used to bring the physical and virtual worlds together. Most existing AR technology has either suffered from poor registration of the virtual objects or been severely limited in application. Some successful AR techniques have been created using visual navigation, but these methods either are only capable of relative navigation, require preparation of the environment, or require a pre-surveyed environment. To reach the ultimate promise of AR, an AR system is ideally capable of attaining centimeter-level or better absolute positioning and degree-level or better absolute attitude accuracies in any space, both indoors and out, on a platform that is easy to use and priced reasonably for consumers.

The discussion herein proposed methods for combining CDGPS, visual SLAM, and inertial measurements to obtain precise and globally-referenced pose estimates of a rigid structure connecting a GPS receiver 104, a camera 108, and an IMU 416. Such a system should be capable of reaching the lofty goals of an ideal AR system. These methods for combining CDGPS, visual SLAM, and inertial measurements include sequential estimators and hybrid batch-sequential estimators. Further analysis is required to identify a single best methodology for this problem, since an optimal solution is computationally infeasible. Prior to defining these estimation methodologies, the observability of absolute attitude based solely on GPS-based position estimates and visual feature measurements was first proven. This eliminates the need for an attitude solution based on magnetometer and accelerometer measurements, which is inaccurate near magnetic disturbances or during long-term sustained accelerations. However, an IMU 416 is still useful for smoothing out dynamics and reduces the drift of the reference frame in GPS-challenged environments.

A prototype AR system was developed as a first step towards the goal of implementing the methods for coupling CDGPS, visual SLAM, and inertial measurements presented herein. This prototype only implemented a loose coupling of CDGPS and visual SLAM, which has difficulty estimating absolute attitude alone because of the need to additionally estimate the similarity transform between ECEF and the arbitrarily-defined frame in which the visual SLAM pose estimates are expressed. Therefore, a full INS 402 was employed by the prototype rather than just inertial measurements. However, the accuracy of both globally-referenced position and attitude are improved over a coupled CDGPS 404 and INS 402 navigation system through the incorporation of visual SLAM in this framework. This prototype demonstrated an upper bound on the precision that such a combination of navigation techniques could attain through a test performed using the prototype AR system. In this test, sub-centimeter-level positioning precision and sub-degree-level obtained precision was attained in a dynamic scenario. This level of precision would enable convincing augmented visuals.

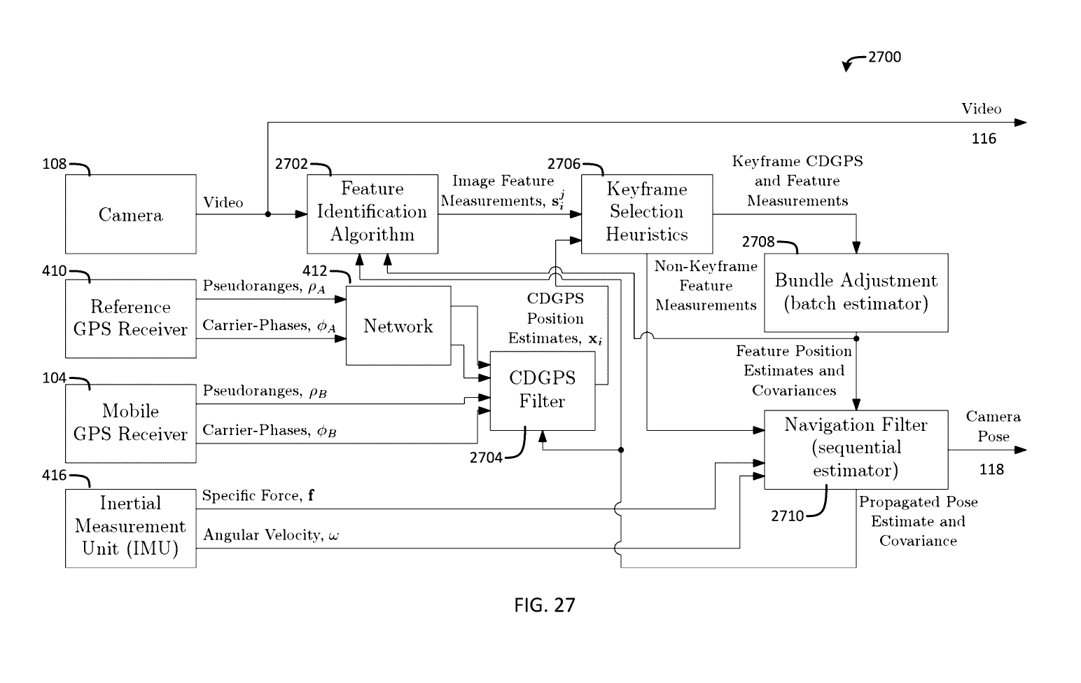

FIG. 27 is a block diagram of a navigation system 2700 in accordance with yet another embodiment of the present invention. The sensors for the system are shown on the left side of the block diagram which include a camera 108, an IMU 416, a mobile GNSS receiver 104, and a reference GNSS receiver 410 at a known location. In some embodiments, the reference receiver 410 receives a set of carrier-phase measurements based on signals from a second antenna or two or more antennas (e.g., as is common in Network Real Time Kinematic [NRTK] positioning). The camera 108 produces a video feed representing the user's view which, in addition to being used for augmented visuals, is passed frame-by-frame to a feature identification algorithm 2702. This feature identification algorithm 2702 identifies visually recognizable features in the image and correlates these features between frames to produce a set of measurements of the pixel locations of each feature in each frame of the video. After initialization of the system, the propagated camera pose and point feature position estimates are fed back into the feature identification algorithm 2702 to aid in the search and identification of previously mapped features for computational efficiency. The mobile 104 and reference 410 GNSS receivers both produce sets of pseudorange and carrier-phase measurements from the received GNSS signals. The system receives the measurements from the reference GNSS receiver or interface 410 over a network 412 connection and passes these measurements, along with the mobile GNSS receiver's measurements, to a CDGPS filter 2704 that produces estimates of the position of the GNSS antenna mounted on the system to centimeter-level or better accuracy that are time aligned with the video frames. After initialization of the system, the CDGPS filter 2704 uses the propagated camera pose for linearization. The image feature measurements produced by the feature identification algorithm 2702 and the antenna position estimate produced by the CDGPS filter 2704 are passed to a keyframe selection algorithm 2706. This keyframe selection algorithm 2706 uses a set of heuristics to select special frames that are diverse in camera pose, which are referred to as keyframes. If this frame is determined to be a keyframe, then the image feature measurements and antenna position estimate is passed to a batch estimator performing bundle adjustment 2708. This batch estimation procedure results in globally-referenced estimates of the keyframe poses and image feature positions. In other words, bundle adjustment 2708 is responsible for creating a map of the environment on the fly without any a priori information about the environment using only CDGPS-based antenna position estimates and image feature measurements. For frames not identified as keyframes, the image feature measurements are passed to the navigation filter 2710 along with the feature position estimates and covariances from bundle adjustment and the specific force and angular velocity measurements from the IMU 416. The navigation filter 2710 estimates the pose of the system using the image feature measurements by incorporating the feature position estimates and covariances from bundle adjustment into the measurement models. Between frames, the navigation filter 2710 uses the specific force and angular velocity measurements from the IMU 416 to propagate the state forward in time.

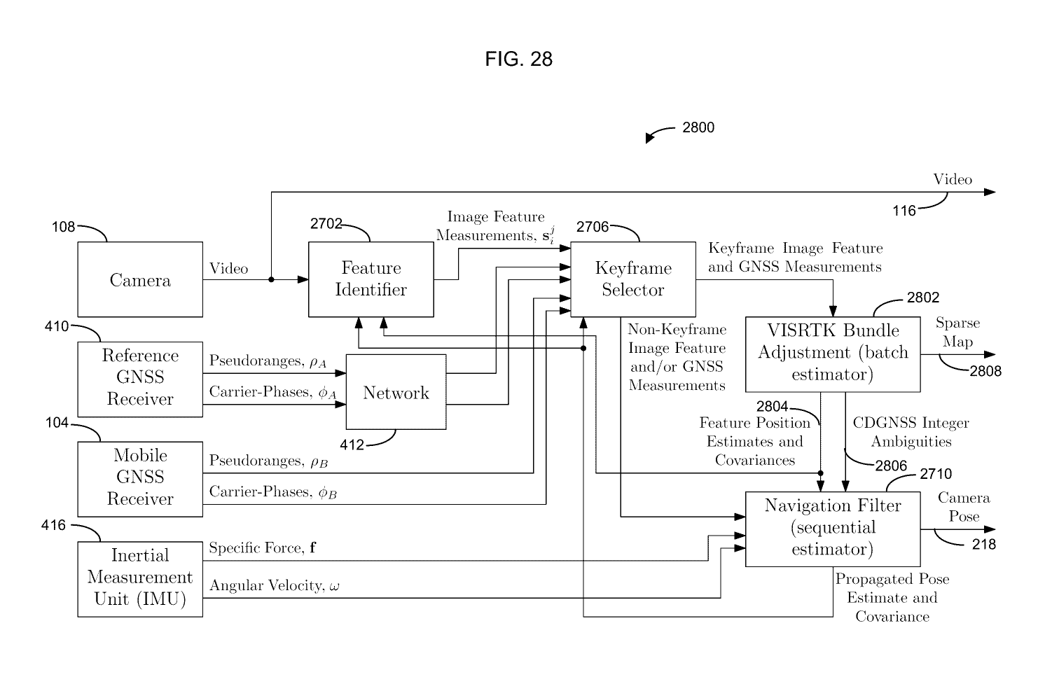

FIG. 28 is a block diagram of a navigation system 2800. The navigation system 2800 is similar to the navigation system 2700 illustrated and described with respect to FIG. 27 and related to apparatus 100 and/or apparatus 150. However, in FIG. 28, the CDGPS filter 2704 and bundle adjustment (batch estimator) 2708 of FIG. 27 have been combined into a single module, VISRTK bundle adjustment or batch estimator 2802. The modules within the navigation system 2800 that are commonly numbered with the navigation system 2700 are configured or operable to function in the manner previously described, and these modules will not be described any further herein. However, the operation of the VISRTK batch estimator 2802 is described in detail below.

By combining the CDGPS filter 2704 and bundle adjustment 2708 of FIG. 27 into the VISRTK batch estimator 2802, the navigation system 2800 allows vision measurements from cameras to aid resolution of the CDGNSS ambiguities needed for determining centimeter-accurate position trajectory (e.g., reducing CDGNSS time to ambiguity resolution [TAR]). The VISRTK batch estimator 2802 combines GNSS carrier-phase and point feature measurements to simultaneously compute (1) camera pose and point feature position estimates in the global coordinate frame and (2) CDGNSS integer ambiguities. Feature point measurements and carrier-phase ambiguities are jointly processed within the same non-linear cost function, enabling the feature point measurements to aid in the estimation of an integer ambiguity vector. Such a feature is not possible in existing frameworks (e.g., the Horn transform or a standalone CDGNSS solutions). Consequently, for these existing frameworks, the information transfer is one way-from the standalone CDGNSS solution (in which the integer ambiguities were already resolved) to the horn transform or loosely coupled framework. The VISRTK batch estimator 2802 outputs feature position estimates and covariances 2804, CDGNSS integer ambiguities 2806, and a sparse map 2808. As described in detail below, the sparse map 2808 can be stored in a database or other memory device for future use in resolving CDGNSS integer ambiguities and/or the device's pose.

Additionally, centimeter-accurate position trajectory can be determined without requiring external, high-cost GNSS and camera sensors. As a result, low-cost camera (e.g., smartphone camera) measurements can be combined with GNSS to enable a tightly-coupled fusion of the CDGNSS and batch estimation algorithms that reduces convergence time needed to resolve the CDGNSS ambiguities without significantly increasing computational demand.

Finally, the combined VISRTK batch estimator 2802 enables known or earlier-computed information regarding the position of point features to be integrated with current GNSS phase and point feature measurements to compute a pose estimate more rapidly than could be achieved on the basis of new measurements alone. The known or earlier-computed information enables the CDGNSS ambiguities to be resolved instantaneously or nearly instantaneously. In some embodiments, the VISRTK batch estimator 2802 achieves instantaneous or nearly instantaneous ambiguity resolution using a single image and at least 4 pre-mapped feature points.

Specifically, the VISRTK batch estimator 2802 receives double-differenced (DD) carrier-phase measurements made between two GNSS receivers and a reference, a rover, and image feature measurements. The VISRTK batch estimator 2802 processes these signals along with any prior information related to point feature locations to estimate (1) the camera position and orientation at each measurement epoch or pose and (2) a vector of carrier-phase integer ambiguities.

The VISRTK batch estimator 2802 preserves and exploits the sparse structure of the Jacobian matrix for a computationally efficient result. The VISRTK batch estimator 2802 also uses integer least squares or other integer resolution techniques (e.g., the Least-Squares Ambiguity Decorrelation Adjustment [LAMBDA] method) to solve for the integer ambiguities prior to solving for the rest of the state, thus improving estimation accuracy.

### State

The VISRTK batch estimator 2802's state is represented as:

$${X}_{BA} = [ \begin{matrix}{X}_{𝒞} \\ N \\ {X}_{𝒫}\end{matrix} ] \qquad ( 102 )$$

where, X_{C}, is a 6L×1 vector modeling the position and attitude of the camera at each pose (expanded below), where L is the total number of poses, where N is a P×1 integer-valued vector of carrier-phase ambiguities (expanded below), where P+1 is the total number of GNSS signals tracked (the “+1” denotes the reference signal), where X_{P} is a 3M×1 vector modeling the feature point positions (expanded below), and where M is the total number of feature points. X_{C}, N, and X_{P} can be expanded as

$${X}_{𝒞} = {[ \begin{matrix}{( {x}_{𝒢}^{{𝒞}_{1}} )}^{T} & {x ( {q}_{𝒢}^{{𝒞}_{1}} )}^{T} & … & {( {x}_{𝒢}^{{𝒞}_{L}} )}^{T} & {( {x}_{𝒢}^{{𝒞}_{L}} )}^{T}\end{matrix} ]}^{T} \\ N = {[ \begin{matrix}{N}^{1} & {N}^{2} & … & {N}^{P}\end{matrix} ]}^{T} \\ {X}_{𝒫} = {[ \begin{matrix}{( {x}_{𝒢}^{{𝒫}_{1}} )}^{T} & {x ( {q}_{𝒢}^{{𝒫}_{2}} )}^{T} & … & {( {x}_{𝒢}^{{𝒫}_{M}} )}^{T}\end{matrix} ]}^{T} \qquad ( 103 )$$

where [symbol] is a 3×1 vector modeling the position of the camera at pose i, i=1, 2 . . . , L, in the global earth-centered-earth-fixed (ECEF) coordinate system, where [symbol] is a 3×1 quaternion vector representation of the attitude of the camera at pose i, i=1, 2 . . . , L, in the ECEF coordinate system, where N^{k} is the integer-valued phase ambiguity for the k^{th} satellite pair, k=1, 2 . . . , P, assumed constant so long as both the reference and rover GNSS receivers retain phase lock on the tracked signals, and where [symbol] is a 3×1 vector modeling the position of the j^{th} point feature, j=1, 2 . . . , M, in the ECEF coordinate system.

### Measurement Models

The VISRTK batch estimator 2802's point feature measurement model relates the point feature and GNSS carrier-phase measurements to the batch estimator's state. The measurement of the j^{th} point feature taken at pose i is modeled as

$${y}_{i}^{{p}_{j}} = {h}_{y} ( {x}_{{𝒞}_{i}}^{{p}_{j}} ) + {w}_{i}^{{p}_{j}} = {[ \begin{matrix}\frac{{x}_{{𝒞}_{i}}^{{p}_{j}}}{{z}_{{𝒞}_{i}}^{{p}_{j}}} & \frac{{y}_{{𝒞}_{i}}^{{p}_{j}}}{{z}_{{𝒞}_{i}}^{{p}_{j}}}\end{matrix} ]}^{T} + {w}_{i}^{{p}_{j}} \qquad ( 104 )$$

where h_{y}(•) is the non-linear perspective projection measurement model relating the 2×1 point feature measurement [symbol] to the 3×1 position of the jth point feature referenced to the ith camera frame x_{C}_{ᵢ}^{P}^{ⱼ}. wᵢ^{P}^{ⱼ} is zero-mean Gaussian white noise. x_{C}_{ᵢ}^{P}^{ⱼ} is related to the state variables through the equation:

$${x}_{𝒞}^{{p}_{j}} = [ \begin{matrix}{x}_{𝒞}^{{p}_{j}} \\ {y}_{𝒞}^{{p}_{j}} \\ {z}_{𝒞}^{{p}_{j}}\end{matrix} ] = {( R ( {q}_{𝒢}^{𝒞} ) )}^{T} ( {x}_{𝒢}^{{p}_{j}} - {x}_{𝒢}^{𝒞} ) \qquad ( 105 )$$

where R(•) is the 3×3 rotation-matrix-representation of the camera attitude defined by [symbol] . The system 2800 assumes that a calibrated camera is used and that any distortion caused by the lens is removed by passing raw measurements through an inverted distortion model prior to passing the measurements to the estimators. This enables distortion-free point feature measurements to be accurately described by the pinhole-type perspective projection model of (104).

The non-linear point feature measurement model of (104) can be linearized with respect to the batch estimator's state to form the following linearized measurement model

$$\begin{matrix} {y}_{i}^{{p}_{j}} \approx {h}_{y} ( {\overline{x}}_{𝒢}^{{𝒞}_{i}} , {\overline{q}}_{𝒢}^{{𝒞}_{i}} , {\overline{x}}_{𝒢}^{{p}_{j}} ) + {H}_{i}^{j} {\vert}_{{\overline{X}}_{BA}} Δ {X}_{BA} + {w}_{i}^{{p}_{j}} \\ where & ( 106 ) \\ \begin{matrix}{H}_{i}^{j} {\vert}_{{\overline{X}}_{BA}} = \frac{\partial {h}_{y}}{\partial {X}_{BA}} \\ {= [ 0 , … , 0 , \frac{\partial {h}_{y}}{\partial {x}_{𝒢}^{{𝒞}_{i}}} , \frac{\partial {h}_{y}}{\partial δ {e}_{𝒢}^{{𝒞}_{i}}} , 0 , … , 0 , \frac{\partial {h}_{y}}{\partial {x}_{𝒢}^{{𝒫}_{j}}} , 0 , … , 0 ] \vert}_{{\overline{X}}_{BA}}\end{matrix} & ( 107 )\end{matrix}$$

is the 2×(6L+P+3M) Jacobian matrix, and [symbol] is the 3×1 minimal attitude representation of the differential quaternion [symbol] . Differential quaternions represent a small rotation from the current attitude to give an updated estimate of the attitude through the equation

q′=δq(δe) [symbol] q (108)

where q′ is the updated attitude estimate, represents quaternion multiplication, and δq(δe) is the differential quaternion.

$$\frac{\partial {h}_{y}}{\partial {x}_{g}^{{C}_{i}}} , \frac{\partial {h}_{y}}{\partial δ {e}_{g}^{{C}_{i}}} , and \frac{\partial {h}_{y}}{\partial {x}_{g}^{{P}_{j}}}$$

are the partial derivatives of (104) with respect to the relevant state elements and can be expanded as:

$$\begin{matrix}\frac{\partial {h}_{y}}{\partial {x}_{𝒢}^{{C}_{i}}} = \frac{\partial {h}_{y}}{\partial {x}_{C}^{{𝒫}_{j}}} \frac{\partial {x}_{C}^{{𝒫}_{j}}}{\partial {x}_{𝒢}^{{C}_{i}}} & ( 109 ) \\ \frac{\partial {h}_{y}}{\partial δ {e}_{𝒢}^{{C}_{i}}} = \frac{\partial {h}_{y}}{\partial {x}_{C}^{{𝒫}_{j}}} \frac{\partial {x}_{C}^{{𝒫}_{j}}}{\partial δ {e}_{𝒢}^{{C}_{i}}} & ( 110 ) \\ \frac{\partial {h}_{y}}{\partial {x}_{𝒢}^{{𝒫}_{j}}} = \frac{\partial {h}_{y}}{\partial {x}_{C}^{{𝒫}_{j}}} \frac{\partial {x}_{C}^{{𝒫}_{j}}}{\partial {x}_{𝒢}^{{𝒫}_{j}}} & ( 111 ) \\ where & \\ {\frac{\partial {h}_{y}}{\partial {x}_{C}^{{p}_{j}}} \vert}_{\overline{x}} = [ \begin{matrix}\frac{1}{{\overline{z}}_{C}^{{p}_{j}}} & 0 & \frac{- {\overline{x}}_{C}^{{p}_{j}}}{{( {\overline{z}}_{C}^{{p}_{j}} )}^{2}} \\ 0 & \frac{1}{{\overline{z}}_{C}^{{p}_{j}}} & \frac{- {\overline{y}}_{C}^{{p}_{j}}}{{( {\overline{z}}_{C}^{{p}_{j}} )}^{2}}\end{matrix} ] & ( 112 ) \\ {\frac{\partial {x}_{C}^{{𝒫}_{j}}}{\partial {x}_{𝒢}^{{C}_{i}}} \vert}_{\overline{x}} = - {( R ( {\overline{q}}_{𝒢}^{C} ) )}^{T} & ( 113 ) \\ {\frac{\partial {x}_{C}^{{𝒫}_{j}}}{\partial δ {e}_{𝒢}^{{C}_{i}}} \vert}_{\overline{x}} = - 2 {( R ( {q}_{𝒢}^{C} ) )}^{T} [ ( {\overline{x}}_{𝒢}^{{p}_{j}} - {\overline{x}}_{𝒢}^{C} ) \times ] & ( 114 ) \\ {\frac{\partial {x}_{C}^{{𝒫}_{j}}}{\partial {x}_{𝒢}^{{𝒫}_{j}}} \vert}_{\overline{x}} = {( R ( {\overline{q}}_{𝒢}^{C} ) )}^{T} & ( 115 )\end{matrix}$$

where [(•)×] represents the cross product equivalent matrix of the argument defined as

$$[ x \times ] = [ \begin{matrix}0 & - {x}_{3} & {x}_{2} \\ {x}_{3} & 0 & - {x}_{1} \\ - {x}_{2} & {x}_{1} & 0\end{matrix} ] \qquad ( 116 )$$

and where xᵢ is the ith element of x.

The DD GNSS carrier-phase measurement of satellite pair k taken at the time of pose i, tᵢ, is modeled as

y_{φ,i}^{k} [symbol] [φ_{A,i}^{k}−φ_{A,i}¹]−[φ_{B,i}^{k}−φ_{B,i}¹] (117)

where φ_{α,i}^{β}, αε{A, B}, βε{1, 2, . . . P} is the undifferenced carrier-phase measurement at tᵢ between receiver α and satellite β. Satellite 1 is the common reference satellite. y_{φ,i}^{k}, which has units of meters, can be related to the camera position and integer ambiguity state elements x_{g}^{C}^{ᵢ} and N^{k} of (103) by the following nonlinear measurement model:

$$\begin{matrix}{y}_{φ , i}^{k} = {h}_{φ} ( {x}_{𝒢}^{{C}_{i}} , {q}_{𝒢}^{C} , {N}^{k} ) + {w}_{AB , i}^{j 1} & ( 118 ) \\ = {r}_{AB , i}^{k} + λ {N}^{k} + {w}_{AB , i}^{k } & ( 119 ) \\ where \\ {r}_{AB , i}^{k} {=}^{Δ} ( {r}_{A , i}^{k} - {r}_{A , i}^{1} ) - ( {r}_{B , i}^{k} - {r}_{B , i}^{1} ) & ( 120 )\end{matrix} \qquad$$

is the DD range between the two receivers and two satellites and λ is the GNSS signal strength; N^{k} is the integer ambiguity for the k^{th} satellite pair defined previously; w_{AB,i}^{k} is the DD carrier-phase measurement error at tᵢ;

r_{α,i}^{β} [symbol] ∥xᵢ^{β}−x_{α,i}∥,αε{A,B},βε{1,2, . . . ,Mₖ}

is the range between receiver α and satellite β at tᵢ, where ∥•∥ represents the Euclidean norm; r_{B,i}^{β} is expanded below to relate this range to the VISRTK batch estimator 2802 state elements;

r_{A,i}^{β} [symbol] ∥xᵢ^{β}−x_{α,i}∥,βε{1,2, . . . ,P}

is the range between the antenna of reference receiver A and satellite β at tᵢ, where ∥•∥ represents the Euclidean norm;

r_{B,i}^{β} [symbol] ∥xᵢ^{β}−x_{α,i}∥=∥xᵢ^{β}−( [symbol] +R( [symbol] ) [symbol] )∥,βε{1,2, . . . ,P}

is the range between the antenna of mobile receiver B—the receiver attached to the camera—and satellite β at tᵢ; x_{α,i} is the 3×1 absolute position of the GNSS antenna of receiver αε{A, B} at the time of signal reception tᵢ, in the global coordinate frame; [symbol] is the 3×1 absolute position of satellite βε{1, 2, . . . , P} at the time of signal transmission, in the global coordinate frame; and x_{C}^{A}^{_{B}} is the 3×1 position of receiver B's GNSS antenna in the camera coordinate frame, which is constant so long as the antenna and camera are rigidly connected to the same platform.

r_{B,i}^{β} can be related to the VISRTK batch estimator 2802 state elements through the following model

$$\begin{matrix}{r}_{B , i}^{β} {=}^{Δ} ‖ {x}_{i}^{β} - {x}_{B , i} ‖ & ( 121 ) \\ = ‖ {x}_{i}^{β} - ( {x}_{𝒢}^{{C}_{i}} + R ( {q}_{𝒢}^{C} ) ) {x}_{{C}_{i}}^{A} ‖ , β ∈ \{ 1 , 2 , … , P \} & ( 122 )\end{matrix}$$

where x_{C}_{ᵢ}^{A} is the fixed 3×1 position of receiver B's GNSS antenna in the Cᵢ frame. This term is typically non-zero due to the physical offset between the GNSS antenna's phase center and the center of the camera lens.

The non-linear GNSS carrier-phase measurement model of (118) can be linearized with respect to the VISRTK batch estimator 2802's state information to form the following linearized measurement model:

$$\begin{matrix} {y}_{φ , i}^{k} \approx {h}_{φ} ( {\overline{x}}_{𝒢}^{{C}_{i}} , {\overline{q}}_{𝒢}^{C} , {\overline{N}}^{k} ) + {H}_{φ , i}^{k} {\vert}_{{\overline{X}}_{BA}} Δ {X}_{BA} + {w}_{AB , i}^{j 1} ( 123 ) \\ where & \\ \begin{matrix}{H}_{φ , i}^{k} \vert {\overline{x}}_{BA} = \frac{\partial {h}_{φ}}{\partial {X}_{BA}} & ( 124 ) \\ {= [ 0 , … , 0 , \frac{\partial {h}_{φ}}{\partial {x}_{𝒢}^{{C}_{i}}} , \frac{\partial {h}_{φ}}{\partial δ {e}_{𝒢}^{{C}_{i}}} , 0 , … 0 , \frac{\partial {h}_{φ}}{\partial {N}^{k}} , 0 , … , 0 ] \vert}_{{\overline{X}}_{BA}} & ( 125 )\end{matrix} & \end{matrix}$$

is the 1×(6L+P+3M) Jacobian matrix, and where

$$\frac{\partial {h}_{φ}}{\partial {x}_{g}^{{C}_{i}}} , \frac{\partial {h}_{φ}}{\partial δ {e}_{g}^{{C}_{i}}} , and \frac{\partial {h}_{φ}}{\partial {N}^{k}}$$

are the partial derivatives of (104) with respect to the relevant state elements and can be expanded as:

$${\frac{\partial {h}_{φ}}{\partial {x}_{𝒢}^{{C}_{i}}} \vert}_{\overline{X}} = {( {\hat{\overline{r}}}_{B , i}^{1} - {\hat{\overline{r}}}_{B , i}^{j} )}^{T} \qquad ( 126 )$$

$$\begin{matrix}{\frac{\partial {h}_{φ}}{\partial δ {e}_{𝒢}^{{C}_{i}}} \vert}_{\overline{X}} = 2 {( {\hat{\overline{r}}}_{B , i}^{1} - {\hat{\overline{r}}}_{B , i}^{j} )}^{T} [ R ( {\overline{q}}_{𝒢}^{C} ) {x}_{{C}_{i}}^{A} \times ] & ( 127 ) \\ {\frac{\partial {h}_{φ}}{\partial {N}^{k}} \vert}_{\overline{X}} = λ & ( 128 ) \\ where & \\ {\hat{\overline{r}}}_{B , i}^{β} {=}^{Δ} \frac{{x}_{i}^{β} - {\overline{x}}_{B , i}}{‖ {x}_{i}^{β} - {x}_{\overline{B} , i} ‖} & ( 129 )\end{matrix}$$

is the unit vector pointing from x̅_{B,i} to xᵢ^{k}. x̅_{B,i} is the prior position estimate of receiver B's GNSS antenna phase center, which can be modeled as a function of prior VISRTK batch estimator 2802's state elements as follows:

x̅_{B,i}=(x̅_{G}^{C}^{ᵢ}+R(q̅_{G}^{C}))x_{C}_{ᵢ}^{A} (130)

### State Estimation

Optimal maximum a posteriori state estimates, \hat{x}ₖ and \hat{n}ₖ k=1, 2, . . . , can be produced by incorporating all GNSS carrier-phase and feature point measurements into a cost function and minimizing the cost as a function of the state.

The cost function can be written as a function of the state X_{BA} as follows:

$$J ( {X}_{BA} ) = {\sum }_{i = 1}^{L} [ {‖ {R}_{{y}_{φ , i}^{k}}^{- 1 / 2} ( {y}_{φ , i} - {h}_{φ} ( {x}_{𝒢}^{{C}_{i}} , {q}_{𝒢}^{{C}_{i}} , N ) ) ‖}^{2} + {\sum }_{j = 1}^{M} {‖ {R}_{{y}_{i}^{{p}_{j}}}^{- 1 / 2} ( {y}_{i}^{{p}_{j}} - {h}_{y} ( {x}_{𝒢}^{{C}_{i}} , {q}_{𝒢}^{{C}_{i}} , {x}_{𝒢}^{{p}_{i}} ) ) ‖}^{2} ] \qquad ( 131 )$$

where L is the number of camera poses, where M is the number of feature points, where

$${R}_{{y}_{φ , i}^{k}}^{- 1 / 2}$$

is the phase measurement square-root information matrix, where

$${R}_{{y}_{i}^{{P}_{j}}}^{- 1 / 2}$$

is the point feature measurement square-root information matrix, where yᵢ^{P}^{ⱼ} and h_{y} (x_{g}^{C}^{ᵢ},q_{g}^{C}^{ᵢ}, x_{g}^{P}^{ᵢ}), for i=1, 2 . . . , L, j=1, 2 . . . , M, are the point feature measurements and measurement models, as defined previously, and where y_{φ,i} and h_{φ}(x_{g}^{C}^{ᵢ},q_{g}^{C}^{ᵢ},N) are stacked vectors of the previously defined GNSS carrier-phase measurements and measurement models at pose i for i=1, 2 . . . , L, expanded as

$$\begin{matrix}{y}_{φ , i} {=}^{Δ} {[ {y}_{φ , i}^{1} , {y}_{φ , i}^{2} , … , {y}_{φ , i}^{P} ]}^{T} & ( 132 ) \\ {h}_{φ} ( {x}_{𝒢}^{{C}_{i}} , {q}_{𝒢}^{C} , N ) {=}^{Δ} [ \begin{matrix}{h}_{φ} ( {x}_{𝒢}^{{C}_{i}} , {q}_{𝒢}^{C} , {N}^{1} ) \\ {h}_{φ} ( {x}_{𝒢}^{{C}_{i}} , {q}_{𝒢}^{C} , {N}^{2} ) \\ ⋮ \\ {h}_{φ} ( {x}_{𝒢}^{{C}_{i}} , {q}_{𝒢}^{C} , {N}^{P} )\end{matrix} ] & ( 133 ) \\ and & \\ {R}_{{y}_{i}^{{p}_{j}}} {=}^{Δ} {σ}_{{p}_{i}^{j}}^{2} [ \begin{matrix}1 & 0 & … & 0 \\ 0 & 1 & & ⋮ \\ ⋮ & & ⋱ & 0 \\ 0 & … & 0 & 1\end{matrix} ] & ( 134 ) \\ and & \\ {R}_{{y}_{φ , i}} {=}^{Δ} {σ}_{{φ}_{i}}^{2} [ \begin{matrix}4 & 2 & … & 2 \\ 2 & 4 & & ⋮ \\ ⋮ & & ⋱ & 2 \\ 2 & … & 2 & 4\end{matrix} ] & ( 135 )\end{matrix}$$

are the measurement covariance matrices for the feature point and carrier-phase measurements, respectively, whose inverse square roots are used to normalize the noise in the measurements. σₚ_{ᵢ}_{^{j}} is the standard deviation of the point feature measurement noise, in pixels, for i=1, 2 . . . , L, j=1, 2 . . . , M, and σ_{φi} is the standard deviation of the undifferenced carrier-phase measurements, in meters, for i=1, 2 . . . , L. The measurement noise is assumed zero mean and uncorrelated in time. Such is a reasonable assumption for feature point measurements, in general, and for a GNSS receiver antenna that is in motion.

In addition to the phase measurements used in (131), pseudorange measurements can be used in the cost function for VISRTK batch estimator 2802's state estimation. Including pseudorange measurements, the cost function (131) can be written as:

$$J ( {X}_{BA} ) = {\sum }_{i = 1}^{L} [ {‖ {R}_{{y}_{φ , i}^{k}}^{- 1 / 2} ( {y}_{φ , i} - {h}_{φ} ( {x}_{𝒢}^{{C}_{i}} , {q}_{𝒢}^{{C}_{i}} , N ) ) ‖}^{2} + {{‖ {R}_{{y}_{p , i}}^{- 1 / 2} ( {y}_{p , i} - {h}_{p} ( {x}_{𝒢}^{{C}_{i}} , {q}_{𝒢}^{{C}_{i}} ) ) ‖}^{2} + {\sum }_{j = 1}^{M} ‖ {R}_{{y}_{i}^{{p}_{j}}}^{- 1 / 2} ( {y}_{i}^{{p}_{j}} - {h}_{ij} ( {x}_{𝒢}^{{C}_{i}} , {q}_{𝒢}^{{C}_{i}} , {x}_{𝒢}^{{p}_{j}} ) ) ‖ ]}^{2} \qquad ( 136$$

where R_{y}_{_{p,i}}^{-1/2} is the pseudorange measurement square-root information matrix, y_{p,i} are pseudorange measurements, where hₚ(x_{g}^{C}^{ᵢ}, q_{g}^{C}^{ᵢ}) is a pseudorange measurement model. Embodiments of the invention described herein are described with respect to the cost function (131). However, a person skilled in the art in light of this disclosure would understand how to alternatively implement the cost function (136) that includes pseudorange measurements.

Minimization of (131) is performed by linearizing the function about an initial guess of the state X̅_{BA} and then solving for the incremental state update ΔX_{BA}. The linearized form of (131) can be written as a function of ΔX_{BA} as follows:

$$\begin{matrix}{f}_{L} ( Δ {X}_{BA} ) {\vert}_{{\overline{X}}_{BA}} = {\sum }_{i = 1}^{L} [ {‖ {R}_{{y}_{φ , i}}^{- 1 / 2} ( {\overline{z}}_{φ , i} - {H}_{φ , i} Δ {X}_{BA} ) ‖}^{2} + {\sum }_{j = 1}^{M} {‖ {R}_{{y}_{i}^{{p}_{j}}}^{- 1 / 2} ( {\overline{z}}_{i}^{j} - {H}_{i}^{j} Δ {X}_{BA} ) ‖}^{2} ] & ( 137 ) \\ where & \\ {\overline{z}}_{i}^{j} {=}^{Δ} {y}_{i}^{{p}_{j}} - {h}_{y} ( {\overline{x}}_{𝒢}^{{C}_{i}} , {\overline{q}}_{𝒢}^{{C}_{i}} , {\overline{x}}_{𝒢}^{{p}_{j}} ) & ( 138 ) \\ and & \\ {\overline{z}}_{φ , i} {=}^{Δ} {y}_{φ , i} - {h}_{φ} ( {\overline{x}}_{𝒢}^{{C}_{i}} , {\overline{q}}_{𝒢}^{C} , \overline{N} ) & ( 139 )\end{matrix}$$

H_{φ,i} is a vector of stacked Jacobian matrices of the GNSS carrier-phase measurement model at pose i, i=1, 2 . . . , L, giving

H_{φ,i} [symbol] [H_{φ,i}¹|x̅_{BA},H_{φ,i}²|x̅_{BA},H_{φ,i}^{P}|x̅_{BA}]^{T} (140)

and Hᵢ^{j} is the Jacobian matrix of the point feature measurement model, defined previously.

According to the first-order necessary conditions for the minimization of a function, the minimization of (137) can be achieved by setting its gradient with respect to ΔX_{BA} to zero and solving for ΔX_{BA}:

$$\begin{matrix}0 = {∇}_{Δ {X}_{BA}} {f}_{1} ( Δ {X}_{BA} ) = & ( 141 ) \\ {\sum }_{i = 1}^{L} [ - {( {H}_{φ , i} )}^{T} {R}_{{y}_{φ , i}}^{- 1} ( {\overline{z}}_{φ , i} - {H}_{φ , i} Δ {X}_{BA} ) + & ( 142 ) \\ {\sum }_{j = 1}^{M} - {( {H}_{i}^{j} )}^{T} {R}_{{y}_{i}^{{p}_{j}}}^{- 1} ( {\overline{z}}_{i}^{j} - {H}_{i}^{j} Δ {X}_{BA} ) ] & \end{matrix}$$

Bringing the unknown terms to the left-hand side and known terms to the right-hand side of the equation results in

$${\sum }_{i = 1}^{L} [ {( {H}_{φ , i} )}^{T} {R}_{{y}_{φ , i}}^{- 1} {H}_{φ , i} + {\sum }_{j = 1}^{M} {( {H}_{i}^{j} )}^{T} {R}_{{y}_{i}^{{p}_{j}}}^{- 1} {H}_{i}^{j} ] Δ {X}_{BA} = {\sum }_{i = 1}^{L} [ {( {H}_{φ , i} )}^{T} {R}_{{y}_{φ , i}}^{- 1} {\overline{z}}_{φ , i} + {\sum }_{j = 1}^{M} {( {H}_{i}^{j} )}^{T} {R}_{{y}_{i}^{{p}_{j}}}^{- 1} {\overline{z}}_{i}^{j} ] \qquad ( 143 )$$

After performing the summations, (143) can be re-written in matrix form, giving

$$[ \begin{matrix}U & W \\ {W}^{T} & V\end{matrix} ] \underbrace{[ \begin{matrix}[ \begin{matrix}Δ {X}_{C} \\ Δ N\end{matrix} ] \\ Δ {X}_{𝒫}\end{matrix} ]}_{Δ {X}_{BA}} = [ \begin{matrix}[ \begin{matrix}{ε}_{c} \\ {ε}_{n}\end{matrix} ] \\ {ε}_{p}\end{matrix} ] \qquad ( 144 )$$

where ΔX_{C}, ΔN, and ΔX_{P} are the components of ΔX_{BA} corresponding to increments to the camera pose, the carrier-phase integer ambiguity, and the point feature state elements, respectively. Due to the integer nature of N, ΔN is also an integer, and the VISRTK batch estimator 2802 cannot solve for an exact solution to (144). The VISRTK batch estimator 2802 instead solves for ΔX_{BA} subject to this integer-state constraint, which minimizes the difference between both sides of (144).

V in (144) is sparse because V is block diagonal with 3×3 block diagonal elements corresponding to each point feature location. The VISRTK batch estimator 2802 uses the sparsity of V to more efficiently solve for the minimizing ΔX_{BA} in (144). For example, rather than inverting the entire matrix on the left side of (144), the VISRTK batch estimator 2802 first pre-multiplies both sides of (144) by a special matrix:

$$[ \begin{matrix}I & - {W ( V )}^{- 1} \\ 0 & I\end{matrix} ] [ \begin{matrix}U & W \\ {W}^{T} & V\end{matrix} ] [ \begin{matrix}[ \begin{matrix}Δ {X}_{𝒞} \\ Δ N\end{matrix} ] \\ Δ {X}_{𝒫}\end{matrix} ] = [ \begin{matrix}U - {W ( V )}^{- 1} {W}^{T} & 0 \\ {W}^{T} & V\end{matrix} ] [ \begin{matrix}[ \begin{matrix}Δ {X}_{𝒞} \\ Δ N\end{matrix} ] \\ Δ {X}_{𝒫}\end{matrix} ] = [ \begin{matrix}I & - {W ( V )}^{- 1} \\ 0 & I\end{matrix} ] [ \begin{matrix}[ \begin{matrix}{ε}_{c} \\ {ε}_{n}\end{matrix} ] \\ {ε}_{p}\end{matrix} ] , \qquad ( 145 )$$

and then solves for ΔX_{C}, ΔN, and ΔX_{P} incrementally, as follows

$$[ \begin{matrix}Δ {\hat{X}}_{𝒞} \\ Δ \hat{N}\end{matrix} ] = {( U - {W ( V )}^{- 1} {W}^{T} )}^{- 1} ( [ \begin{matrix}{ε}_{c} \\ {ε}_{n}\end{matrix} ] - {W ( V )}^{- 1} {ε}_{p} ) \qquad ( 146 )$$

where the “̂” on ΔX_{C} and ΔN denotes estimations based on float ambiguities (i.e., estimations based on non-integer-constrained estimates for ΔN). The VISRTK batch estimator 2802 determines the integer-constrained or “fixed” estimate of ΔN, denoted as Δ\check{N}, using an integer-least squares or other integer resolution method to solve the following minimization problem

$$\begin{matrix}Δ {N}^{⋁} = {{argmin}_{Δ N ∈ {ℤ}^{P}} ( Δ \hat{N} - Δ N )}^{T} {Q}_{N}^{- 1} ( Δ \hat{N} - Δ N ) \\ where & ( 147 ) \\ [ \begin{matrix}{Q}_{{X}_{c}} & {Q}_{{X}_{c} N} \\ {Q}_{{NX}_{c}} & {Q}_{N}\end{matrix} ] {=}^{Δ} U - {W ( V )}^{- 1} {W}^{T} & ( 148 )\end{matrix}$$

The fixed ambiguity estimate Δ\check{N} can then be used to determine Δ\check{X}_{C}, the estimate of ΔX_{C} based on integer-constrained ambiguities:

Δx̅_{C}=Δ\hat{x}_{C}−Qₓ_{_{c}}_{N}Q_{N}⁻¹(Δ\hat{N}−ΔN)^{T} (149)

Lastly, the state increment for the point feature positions ΔX_{P} are determined via back-substitution:

$$Δ {{X}^{⋁}}_{𝒫} = {( V )}^{- 1} ( {ε}_{p} - {W}^{T} [ \begin{matrix}Δ {{X}^{⋁}}_{𝒞} \\ Δ {N}^{⋁}\end{matrix} ] ) \qquad ( 150 )$$

We now have all the components to form the state increment estimate

$$δ {\hat{X}}_{BA} = [ \begin{matrix}{{X}^{⋁}}_{𝒞} \\ {N}^{⋁} \\ {{X}^{⋁}}_{𝒫}\end{matrix} ] \qquad ( 151 )$$

that minimizes the linearized cost function of (137).

The only matrix inversions necessary during this minimization are V⁻¹, which, due to the sparse block-matrix-form of V, is computationally efficient to compute, and (U−W(V)⁻¹W^{T}) in (146), which, although not sparse like V, is only of dimension 6L+P.

The above procedure to determine the state increment estimate Δ\hat{X}_{BA} defines one iteration of the Levenberg-Marquardt algorithm (LMA), an iterative non-linear solver. To converge on the solution, multiple LMA iterations may be needed. The full procedure for LMA is:
(1) Given a prior for the state X̅_{BA}, use the above procedure to determine the state increment estimate Δ\hat{X}_{BA}.
(2) Accumulate Δ\hat{X}_{BA} with the prior state estimate, giving the updated state estimate,

\hat{X}_{BA} [symbol] X̅_{BA}\tilde{+}Δ\hat{X}BA (152)
where the \tilde{+} term represents the accumulation of all state elements via standard addition except for the quaternion elements, which must be accumulated via quaternion multiplication as outlined in (108).
(3) Insert \hat{X}_{BA} into (131) and compute a new cost.
(4) Compare the new cost to the old cost computed on behalf of the estimate from the previous LMA iteration or the initial guess (i.e., if this is the first iteration).
(5) If the cost decreased, then \hat{X}_{BA} is set to be the prior, giving

X̅_{BA}=\hat{X}_{BA} (153)
and the algorithm skips to the last step.
(6) If the cost has increased, then the diagonal elements of U and V are inflated by a multiplicative factor as follows:

$${U}_{ij}^{*} = \{ \begin{matrix}( 1 + λ ) {U}_{ii} ; & i = j \\ {U}_{ij} ; & otherwise\end{matrix} \\ {V}_{ij}^{*} = \{ \begin{matrix}( 1 + λ ) {V}_{ii} ; & i = j \\ {V}_{ij} ; & otherwise\end{matrix} \qquad ( 154 )$$

and the minimization procedure of (147)-(151) is repeated with U* and V* in place of U and V to obtain a new \hat{X}_{BA} and thus a new cost. This current step is repeated, multiplying λ by a factor of 10 each repeat until the cost has decreased (as compared to the cost from the previous LMA iteration). Then, skip to step 3.
(7) LMA convergence is determined by comparing (1) the norm of the estimated state increment vector and (2) the change in the cost at the end of each iteration to threshold values. If both threshold checks are passed, then the algorithm is declared to have converged and this procedure exits. Otherwise return to step 1, and repeat.

### Covariance

The VISRTK batch estimator 2802 can solve for its covariance matrix, assuming an entirely real-valued state, by inverting the LHS matrix of the normal equation in (144), giving

$${P}_{xx} = {[ \begin{matrix}U & W \\ {W}^{T} & V\end{matrix} ]}^{- 1} \qquad ( 155 )$$

The covariance matrix of (155) can be simplified, giving

$$\begin{matrix}{P}_{xx} = [ \begin{matrix}\overbrace{[ \begin{matrix}{P}_{cc} & {P}_{cn} \\ {P}_{n c} & {P}_{nn}\end{matrix} ]}^{A} & [ \begin{matrix}{P}_{cp} \\ {P}_{np}\end{matrix} ] \\ [ \begin{matrix}{P}_{cp}^{T} & {P}_{np}^{T}\end{matrix} ] & {P}_{pp}\end{matrix} ] \\ where & ( 156 ) \\ A = [ \begin{matrix}{P}_{cc} & {P}_{cn} \\ {P}_{nc} & {P}_{nn}\end{matrix} ] {=}^{Δ} {( U - {WV}^{- 1} {W}^{T} )}^{- 1} & ( 157 )\end{matrix}$$

is the joint camera pose-integer ambiguity covariance matrix, with P_{cc}, Pₙₙ, and P_{cn} being the camera pose, integer ambiguity, and camera pose/integer ambiguity cross covariance matrices, respectively. Additionally,

P_{PP} [symbol] V⁻¹W^{T}AWV⁻¹+V⁻¹ (158)

is the point feature position covariance matrix and

$$[ \begin{matrix}{P}_{cp} \\ {P}_{np}\end{matrix} ] {=}^{Δ} - {AWV}^{- 1} \qquad ( 159 )$$

is a matrix containing the cross-covariances between the camera pose and integer ambiguity states and the point feature position state.

However, since the state component N is constrained to be integer-valued, it is often the case that it is resolved correctly by the VISRTK batch estimator 2802. Consequently, the covariance can be adjusted to reflect the (significant) increase in accuracy to the other state components under the assumption that N is correct. Particularly, the covariance for the non-integer-valued state elements conditioned on N are:

P_{cc|N}=P_{cc}−P_{cn}Pₙₙ⁻¹P_{cn}^{T} (160)

and

P_{pp|N}=Pₚₚ−Pₙₚ^{T}Pₙₙ⁻¹P_{cp} (161)

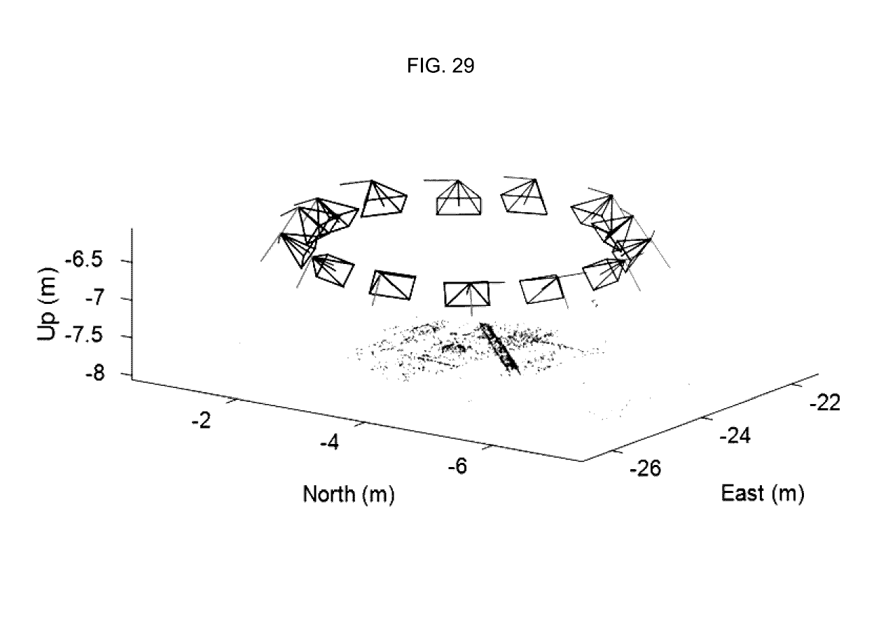

FIG. 29 illustrates the results of using the VISRTK batch estimator 2802 in the navigation system 2800 using measurements from 14 epochs of data (i.e., 14 sets of carrier phase measurements and 14 sets of point feature measurements, with the point feature measurements extracted from 14 images with one image taken at each frame). The reconstructed map or scene illustrates the estimated pose of all 14 frames and the estimated point feature positions in the globally-referenced East-North-Up (ENU) reference frame. The reconstructed scene in FIG. 29 based on determined absolute camera poses corresponds to a three-dimensional map of a particular location including a particular set of point features. The three-dimensional map, or the corresponding data used to generate the three-dimensional map, can be stored in a memory of the system 2800 or an external memory device.

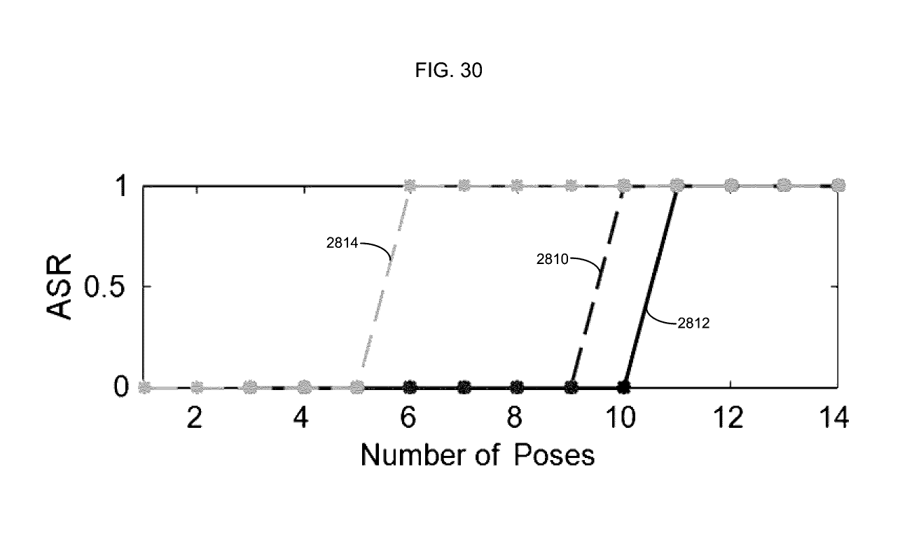

FIG. 30 compares the ambiguity success rate (ASR) 2810 using the VISRTK batch estimator 2802 compared to the ASR 2812 of a standalone CDGNSS solution and the ASR 2814 of a standalone CDGNSS solution aided with a prior centimeter-accurate antenna motion profile. The VISRTK batch estimator 2802 resolved the ambiguities when computing a solution on behalf of 10 (or more) epochs of data. CDGNSS, required 11 epochs of data. As a result, the efficiency with which the navigation system 2800 is able to resolve ambiguities, as compared to a known CDGNSS system, was increased by the VISRTK batch estimator 2802.

The efficiency of the navigation system 2800 and the VISRTK batch estimator 2802 can be further improved by incorporating known information into the system 2800 when resolving CDGNSS ambiguities. The known information allows for instantaneous or nearly instantaneous resolution of ambiguities if the information includes accurate position information for identified point features. This process, referred to herein as Jumpstart VISRTK, accelerates the ambiguity resolution process described above. In some embodiments, the VISRTK batch estimator 2802 resolves ambiguities instantaneously or nearly instantaneously (e.g., successful ambiguity resolution requiring only one epoch of measurements).

### Jumpstart VISRTK

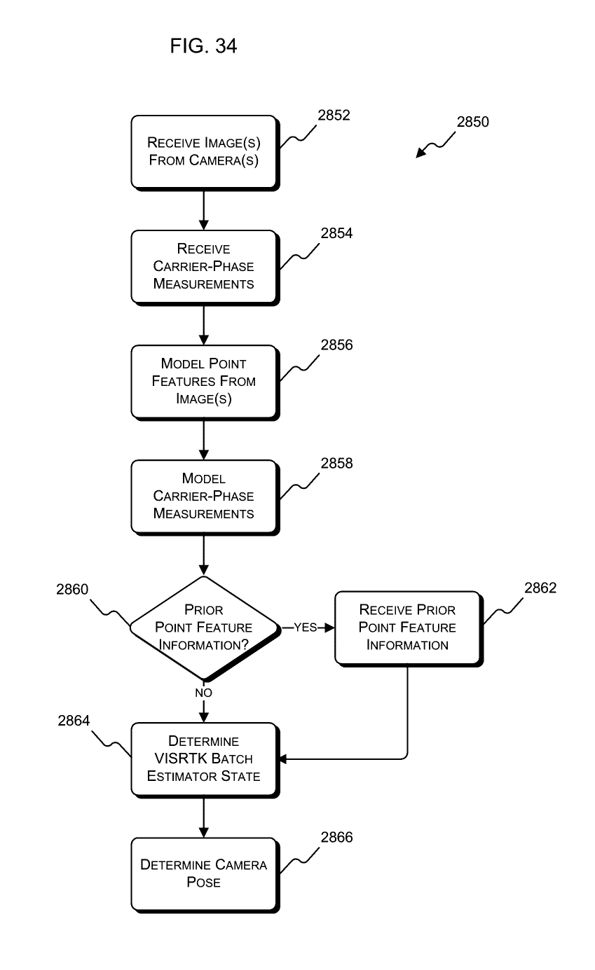

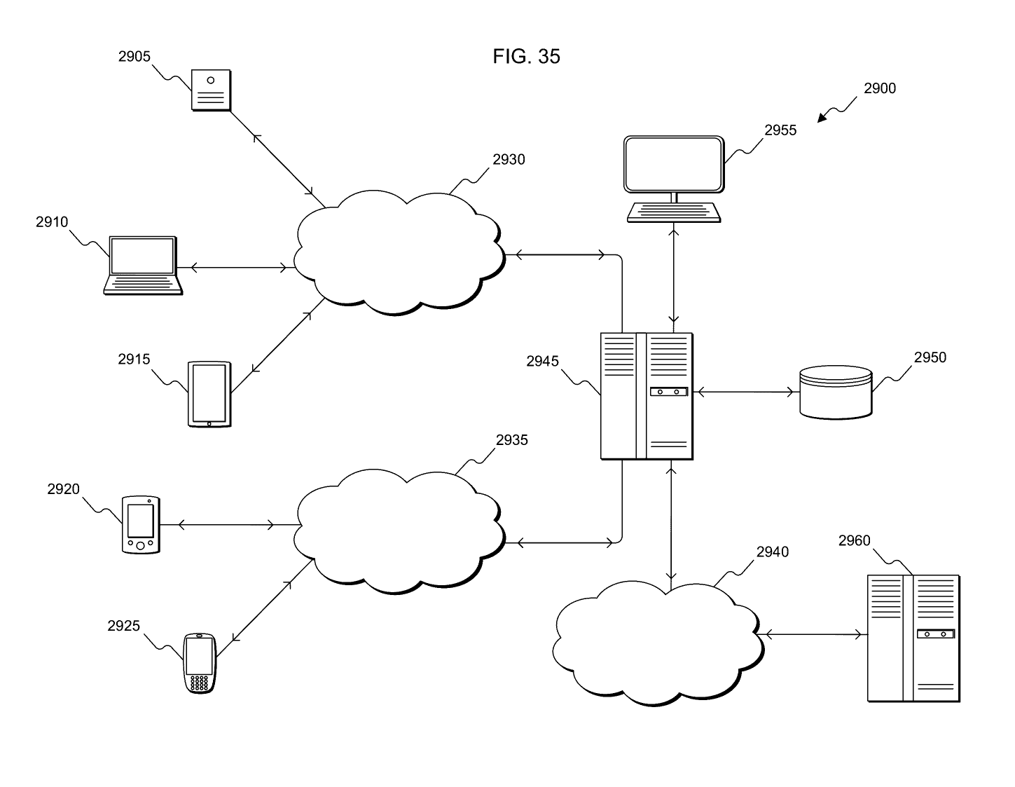

The VISRTK batch estimator 2802 incorporates prior or known information on the position of identified point features to improve the estimability of the VISRTK batch estimator 2802's state (i.e., the integer ambiguity state component N). For example, a camera (e.g., a cellphone camera) can be used to capture an image of a pre-mapped area. Information corresponding to known feature positions within the image is then used to accurately compute the camera's position, orientation, and GNSS antenna position from the camera position/orientation. The VISRTK batch estimator 2802 can acquire known or a priori information as described below with respect to FIGS. 34-35. To include a priori point feature position information within the VISRTK batch estimator 2802 framework, the cost function of (131) is expanded:

$${f}_{NL} ( {X}_{BA} ) = {\sum }_{i = 1}^{L} [ {‖ {R}_{{y}_{φ , i}}^{- 1 / 2} ( {y}_{φ , i} - {h}_{φ} ( {x}_{𝒢}^{{𝒞}_{i}} , {q}_{𝒢}^{{𝒞}_{i}} , N ) ) ‖}^{2} + {\sum }_{j = 1}^{M} {‖ {R}_{{y}_{i}^{{p}_{j}}}^{- 1 / 2} ( {y}_{i}^{{p}_{j}} - {h}_{y} ( {x}_{𝒢}^{{𝒞}_{i}} , {q}_{𝒢}^{{𝒞}_{i}} , {x}_{𝒢}^{{p}_{j}} ) ) ‖}^{2} ] + {\sum }_{j = 1}^{M} {‖ {R}_{{\overline{x}}_{𝒢}^{{p}_{j}}}^{- 1 / 2} ( {\overline{x}}_{𝒢}^{{p}_{j}} - {x}_{𝒢}^{{p}_{j}} ) ‖}^{2} \qquad ( 162 )$$

where [symbol] , j=1, 2, . . . , M are the 3×1 point position priors and

R [symbol] [symbol] σ [symbol] ²I_{3×3}, j=1,2, . . . ,M (163)

are 3×3 measurement covariance matrices associated with these priors, where [symbol] j=1, 2, . . . , M model the per-dimension standard deviation. For the subset of feature points, k⊂̅ {1, 2, . . . , M}, for which no prior information is available, the standard deviation associated with these points is set to infinity, i.e., [symbol] =∞, k⊂̅{1, 2, . . . , M}.

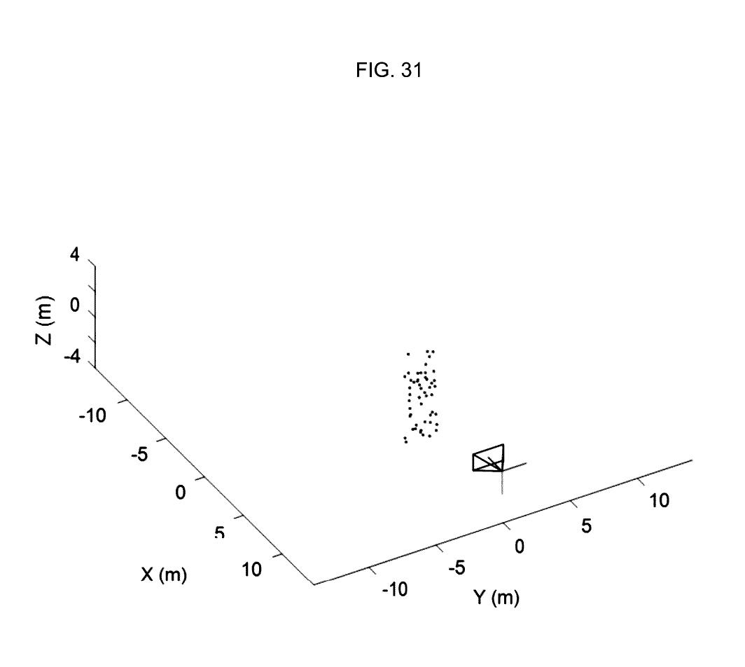

FIG. 31 illustrates a reconstructed scene where 50 feature points have centimeter-accurate positional priors that are provided to the VISRTK batch estimator 2802 and used to compute a single-epoch VISRTK solution. Using this prior information along with measurements of the 50 feature points and the GNSS carrier-phase measurements from this one camera frame, the camera's pose was estimated in the global ECEF reference frame to sub-centimeter and sub-degree accuracy. Accordingly, the carrier-phase integer ambiguities were also successfully estimated.

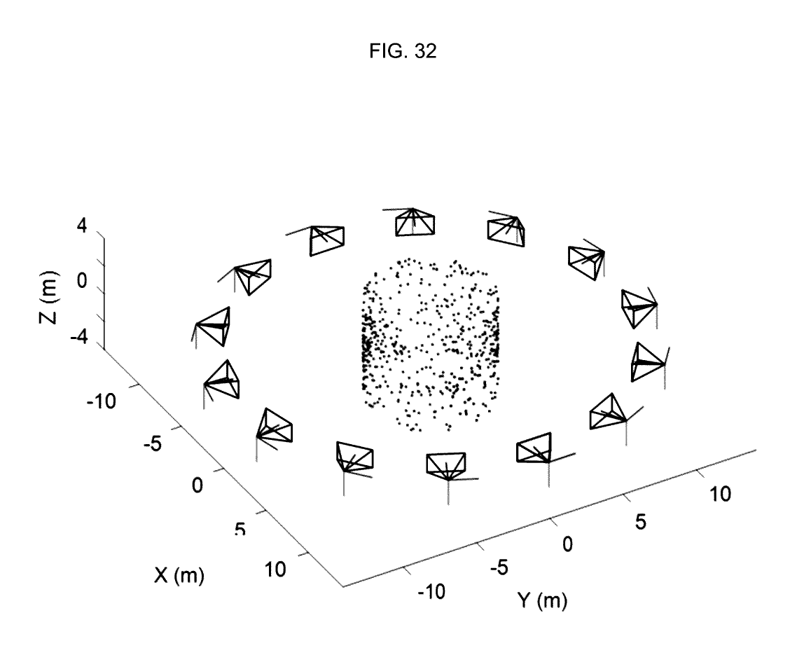

FIG. 32 illustrates the results of the Jumpstart VISRTK computed using point feature and GNSS measurements from 14 cameras frames. The illustrated points are the combination of the points for which a positional prior was available (i.e., the same 50 points and point priors used in FIG. 31) and points for which no prior information was available. Through linearization and iterative minimization of the augmented cost function of (163), the positional priors were aided in the estimation of all state components, including the CDGNSS integer ambiguity state vector.

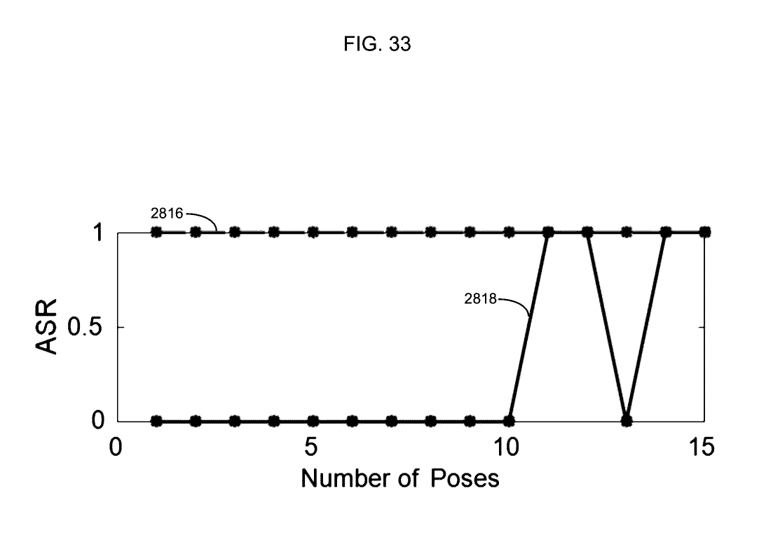

FIG. 33 compares the ASR 2816 of a Jumpstart VISRTK solution (see FIG. 32) to the ASR 2818 of a standalone CDGNSS solution. As illustrated in FIG. 33, in some embodiments, Jumpstart VISRTK enables the carrier-phase ambiguity resolution to be aided by the prior information and resolved instantaneously or nearly instantaneously on the basis of feature point and GNSS measurements from one camera frame. In contrast, when resolving the integer ambiguities using standard CDGNSS in which no vision measurements are available, 14 frames of GNSS measurements are needed to resolve the CDGNSS ambiguities.

FIG. 34 is a process 2850 for determining the pose (position and orientation or attitude) of an apparatus, such as a camera, cell phone, etc. The process 2850 begins with system 2800 of FIG. 28 receiving an image or images from a camera (e.g., camera 108) or multiple cameras (step 2852). The system 2800 also receives carrier-phase measurements from, for example, the mobile GNSS receiver 104 and the reference GNSS receiver 410 (step 2854). At step 2856, the VISRTK batch estimator 2802 of the system 2800 models point features from the received image(s) as described above with respect to (104)-(116) (step 2856). After the point features have been modeled, the VISRTK batch estimator 2802 models the carrier-phase measurements as described above with respect to (117)-(130) (step 2858). At step 2860, the VISRTK batch estimator 2802 can optionally incorporate prior point feature information to the process 2850. For example, if prior point feature information exists and/or is available to the system 2800 related to point features in the received image(s) (from step 2852), that information can be received by the system 2800 (step 2862). The VISRTK batch estimator 2802 uses the information to accelerate the resolution of CDGNSS ambiguities and determine its state as described above with respect to (131)-(163) (step 2864). If no prior point feature information is available, the process 2850 proceeds to step 2864 where the VISRTK batch estimator 2802 resolves CDGNSS ambiguities and determines its state as described above with respect to (131)-(161). After the VISRTK batch estimator 2802's state has been determined, the system 2800 determines the pose (i.e., absolute position and orientation or attitude) of the apparatus (e.g., camera 104) (step 2866).

At step 2862 of the process 2850 in FIG. 34, the system 2800 receives prior point feature information for performing Jumpstart VISRTK as described above. The system 2800 receives the prior point feature information from a database or memory associated with or connected to the system 2800. For example, the system 2800 is operable or configured to store point feature information related to a global reference frame for each image previously analyzed and processed by the system 2800. This prior point feature information can be stored internally to the system 2800 in a memory or external to the system 2800 in a database or remote memory device. In either instance, the system 2800 is operable or configured to receive the prior point feature information and use the prior (i.e., known) positions of point features to perform Jumpstart VISRTK and accelerate the resolution of CDGNSS ambiguities. Memory limitations of a device or apparatus, such as a mobile phone, limit the ability of the singular devices to store point feature information or three-dimensional maps of a significant number of areas.

Additionally or alternatively to storing prior point feature information or three-dimensional maps in an apparatus including a camera, such as a mobile phone, the apparatus can be connected through a network to a database or other memory device where the prior point feature information or three-dimensional maps (e.g., map 2808) are stored. In such a navigation system, a user can automatically receive or manually retrieve a three-dimensional map or the corresponding point feature information from a back-end system that is related to a point feature (or features) in a captured image. The received information can then be used by the system 2800 to implement Jumpstart VISRTK to accelerate resolution of CDGNSS ambiguities and determination of camera pose.

For example, FIG. 35 illustrates a navigation and mapping system 2900 that is operable or configured to receive, store, generate, and provide navigation information related to the position of feature points within images captured by a camera. The system 2900 includes a plurality of client-side devices 2905-2925, a first network 2930, a second network 2935, a third network 2940, a server-side mainframe computer or server 2945, a database 2950, a server-side computer or workstation 2955, and a third-party computing or storage device 2960 (e.g., a server, a workstation, etc.). The plurality of data input devices 2905-2925 include, for example, a navigation device 2905, a personal computer 2910, a tablet computer 2915, a personal digital assistant (“PDA”) (e.g., an iPod touch, an e-reader, etc.) 2920, and a mobile phone (e.g., a smart phone) 2925. Each of the devices 2905-2925 includes a camera and is operable or configured to communicatively connect to the server 2945 through the first network 2930 and/or the second network 2935 and receive information from the server 2945 to facilitate locating the devices 2905-2925. The devices 2905-2925 can receive the information from, or provide additional information (e.g., point feature information) to, the database 2950.

The first network 2930 is, for example, a wide area network (“WAN”) (e.g., a TCP/IP based network), a local area network (“LAN”), a neighborhood area network (“NAN”), a home area network (“HAN”), or personal area network (“PAN”) employing any of a variety of communications protocols, such as Wi-Fi, Bluetooth, ZigBee, etc. The second network 2935 is a cellular network, such as, for example, a Global System for Mobile Communications (“GSM”) network, a General Packet Radio Service (“GPRS”) network, a Code Division Multiple Access (“CDMA”) network, an Evolution-Data Optimized (“EV-DO”) network, an Enhanced Data Rates for GSM Evolution (“EDGE”) network, a 3GSM network, a 4GSM network, a 4G LTE network, a Digital Enhanced Cordless Telecommunications (“DECT”) network, a Digital AMPS (“IS-136/TDMA”) network, or an Integrated Digital Enhanced Network (“iDEN”) network, etc.

The connections between the devices 2905-2925 and the first and second networks 2930 and 2935 are, for example, wired connections, wireless connections, or a combination of wireless and wired connections. Similarly, the connections between the server 2945 and the first and second networks 2930 and 2935 are wired connections, wireless connections, or a combination of wireless and wired connections.

The third network 2940 is, for example, a WAN (e.g., a TCP/IP based network), a LAN, a NAN, a HAN, a PAN employing any of a variety of communications protocols, such as Wi-Fi, Bluetooth, ZigBee, etc., or a cellular network, such as, for example, a GSM network, a GPRS network, a CDMA network, an EV-DO network, an EDGE network, a 3GSM network, a 4GSM network, a 4G LTE network, a DECT network, am IS-136/TDMA network, an iDEN network, etc. In some embodiments, the third network 2940 corresponds to the first network 2930 or the second network 2935. The server 2945 connects to the device 2960 through the third network 2940 for accessing or receiving mapping or positional information (e.g., point feature information) from the device 2960 (e.g., related to the location of objects within a mapping system, such as buildings, signs, landmarks, etc.). The server 2945 can store the data accessed or received from the device 2960 and use the data to create and/or modify location or navigation information.

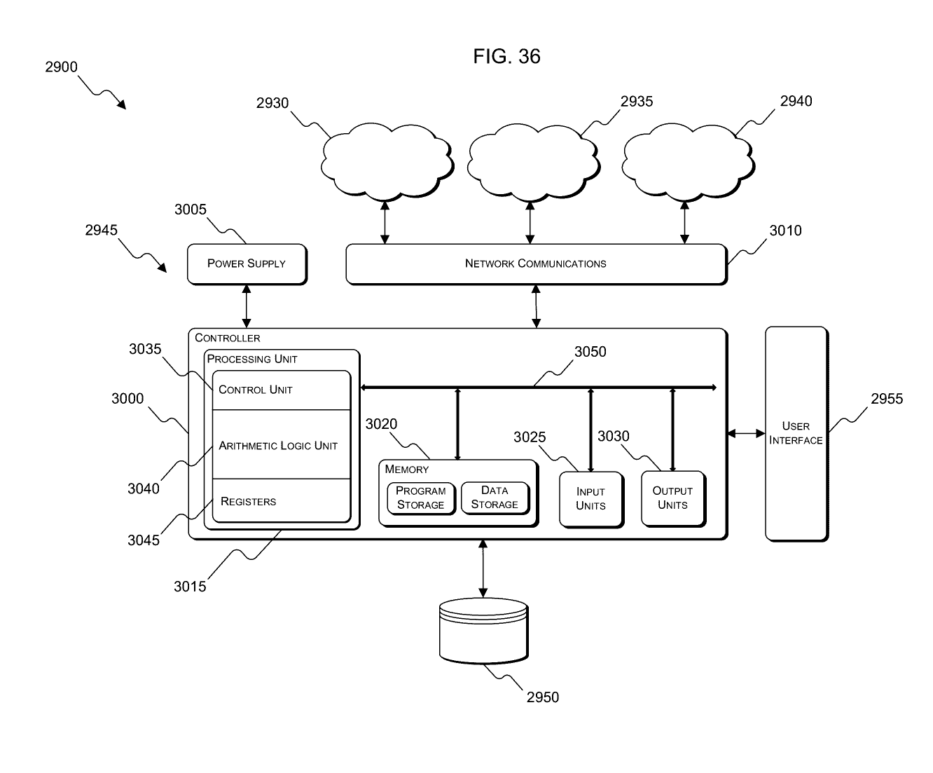

FIG. 36 illustrates the server-side of the navigation and mapping system 2900 with respect to the server 2945. The server 2945 is electrically and/or communicatively connected to a variety of modules or components of the system 2900. For example, the illustrated server 2945 is connected to the user interface module 2955 and the database 2950. The server 2945 includes a controller 3000, a power supply module 3005, and a network communications module 3010. The controller 3000 includes combinations of hardware and software that are configured or operable to, among other things, receive point feature information, receive three-dimensional maps of areas, generate three-dimensional maps of areas based on previously received point feature information, provide point feature information or three-dimensional maps to a client-side device 2905-2925, etc. In some constructions, the controller 3000 includes a plurality of electrical and electronic components that provide power, operational control, and protection to the components and modules within the controller 3000 and/or navigation and mapping system 2900. For example, the controller 3000 includes, among other things, a processing unit 3015 (e.g., a microprocessor, a microcontroller, or another suitable programmable device), a memory 3020, input units 3025, and output units 3030. The processing unit 3015 includes, among other things, a control unit 3035, an arithmetic logic unit (“ALU”) 3040, and a plurality of registers 3045 (shown is a group of registers in FIG. 36) and is implemented using a known computer architecture, such as a modified Harvard architecture, a von Neumann architecture, etc. The processing unit 3015, the memory 3020, the input units 3025, and the output units 3030, as well as the various modules connected to the controller 3000 are connected by one or more control and/or data buses (e.g., common bus 3050). The control and/or data buses are shown schematically in FIG. 36 for illustrative purposes. The use of one or more control and/or data buses for the interconnection between and communication among the various modules and components would be known to a person skilled in the art in view of the invention described herein.

The memory 3020 includes, for example, a program storage area and a data storage area. The program storage area and the data storage area can include combinations of different types of memory, such as read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, a hard disk, an SD card, or other suitable magnetic, optical, physical, electronic memory devices, or other data structures. The processing unit 3015 is connected to the memory 3020 and executes software instructions that are capable of being stored in a RAM of the memory 3020 (e.g., during execution), a ROM of the memory 3020 (e.g., on a generally permanent basis), or another non-transitory computer readable medium such as another memory or a disc.

In some embodiments, the controller 3000 or network communications module 3010 includes one or more communications ports (e.g., Ethernet, serial advanced technology attachment [“SATA”], universal serial bus [“USB”], integrated drive electronics [“IDE”], etc.) for transferring, receiving, or storing data associated with the system 2900 or the operation of the system 2900. Software included in the implementation of the system 2900 can be stored in the memory 3020 of the controller 3000. The software includes, for example, firmware, one or more applications, program data, filters, rules, one or more program modules, and other executable instructions. The controller 3000 is configured to retrieve from memory and execute, among other things, instructions related to the mapping and location processes and methods described herein.

The power supply module 3005 supplies a nominal AC or DC voltage to the controller 3000 or other components or modules of the system 2900. The power supply module 3005 is powered by, for example, mains power having nominal line voltages between 100V and 240V AC and frequencies of approximately 50-60 Hz. The power supply module 3005 is also operable or configured to supply lower voltages to operate circuits and components within the controller 3000 or system 2900. The user interface module 160 includes a combination of digital and analog input or output devices required to achieve a desired level of control and monitoring for the system 2900. For example, the user interface module 160 includes a display (e.g., a primary display, a secondary display, etc.) and input devices such as touch-screen displays, a plurality of knobs, dials, switches, buttons, etc.

The controller 3000 is operable or configured to receive, store, generate, and provide navigation information related to the position of point features within images captured by a camera. As a result, the controller can create a globally-referenced map of the entire world, specific regions, countries, states, cities, etc., based on camera pose and point feature information received from the devices 2905-2925 (e.g., the state or a subset of the state of the devices). For example, in some embodiments, each device 2905-2925 or device user has a corresponding account that allows previously determined absolute pose and point feature information (e.g., from the system 2800) to be stored for future use. If the user or device 2905-2925 is used to capture an image that includes previously determined point feature information, or corresponds to a previously determined pose, the controller 3000 provides that information to the device 2905-2925. The device 2905-2925 then uses the absolute pose or point feature information in the above-described Jumpstart VISRTK process for accelerated resolution of CDGNSS ambiguities. In other embodiments, the pose and point feature information received by the controller 3000 is not user or device specific. Rather, the controller crowdsources the pose and point feature information from a plurality of users and can provide the stored information to any system user. The result of such an implementation is a comprehensive globally-referenced mapping of any location around the world based on the VISRTK-based pose and point feature determinations described above.

It will be understood by those of skill in the art that information and signals may be represented using any of a variety of different technologies and techniques (e.g., data, instructions, commands, information, signals, bits, symbols, and chips may be represented by voltages, currents, electromagnetic waves, magnetic fields or particles, optical fields or particles, or any combination thereof). Likewise, the various illustrative logical blocks, modules, circuits, and algorithm steps described herein may be implemented as electronic hardware, computer software, or combinations of both, depending on the application and functionality. Moreover, the various logical blocks, modules, and circuits described herein may be implemented or performed with a general purpose processor (e.g., microprocessor, conventional processor, controller, microcontroller, state machine or combination of computing devices), a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. Similarly, steps of a method or process described herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. Although preferred embodiments of the present invention have been described in detail, it will be understood by those skilled in the art that various modifications can be made therein without departing from the spirit and scope of the invention as set forth in the appended claims.

What is claimed is:

1. An apparatus comprising:
a global navigation satellite system (GNSS) antenna;
a mobile GNSS receiver connected to the GNSS antenna, the mobile GNSS receiver operable to produce a set of carrier-phase measurements from a GNSS;
a camera operable to produce an image; and
a processor communicably coupled to the mobile GNSS receiver and the camera, the processor operable to:
receive the image and the set of carrier-phase measurements,
extract point feature measurements from the image,
model the point feature measurements based on the image to produce a point feature model,
model the set of carrier-phase measurements to produce a carrier-phase model,
execute a cost function including the point feature measurements, the carrier-phase measurements, the point feature model, and the carrier-phase model, and
determine a state associated with the apparatus based on the executed cost function.

2. The apparatus of claim 1, wherein the state associated with the apparatus includes an absolute position and an attitude of the camera.

3. The apparatus of claim 1, wherein the state associated with the apparatus includes carrier-phase ambiguities.

4. The apparatus of claim 1, wherein the state associated with the apparatus includes point feature positions.

5. The apparatus of claim 1, wherein the state associated with the apparatus includes an absolute position and an attitude of the camera and carrier-phase ambiguities.

6. The apparatus of claim 5, wherein the state associated with the apparatus includes an absolute position and an attitude of the camera, carrier-phase ambiguities, and point feature positions.

7. The apparatus of claim 1, wherein the mobile GNSS receiver, the camera, and the processor are integrated into a single device.

8. The apparatus of claim 7, wherein the apparatus is selected from the group consisting of a navigation device, a personal computer, a tablet computer, a personal digital assistant (PDA), a mobile phone, an augmented reality device, and a three-dimensional rendering device.

9. The apparatus of claim 1, wherein the processor is further operable to receive known point feature information, and the cost function further includes the known point feature information.

10. The apparatus of claim 9, wherein the known point feature information is received from a remote database.

11. The apparatus of claim 1, wherein the processor is further operable to provide at least a subset of the state associated with the apparatus to a remote database.

12. The apparatus of claim 1, wherein the processor is further operable to receive a second set of carrier-phase measurements.

13. The apparatus of claim 12, wherein the second set of carrier-phase measurements are from a second GNSS antenna.

14. The apparatus of claim 12, wherein the second set of carrier-phase measurements is based on signals from two or more GNSS antennas.

15. The apparatus of claim 14, wherein the state associated with the apparatus includes carrier-phase ambiguities.

16. A computerized method for determining a state associated with an apparatus, the apparatus including a global navigation satellite system (GNSS) antenna, a mobile GNSS receiver connected to the GNSS antenna, the mobile GNSS receiver operable to produce a set of carrier-phase measurements from a GNSS, a camera operable to produce an image, and
a processor communicably coupled to the mobile GNSS receiver and the camera, the method comprising:
receiving the image and the set of carrier-phase measurements;
extracting point feature measurements from the image;
modelling the point feature measurements based on the image to produce a point feature model;
modelling the set of carrier-phase measurements to produce a carrier-phase model;
executing a cost function including the point feature measurements, the carrier-phase measurements, the point feature model, and the carrier-phase model; and
determining the state associated with the apparatus based on the executed cost function.

17. The method of claim 16, wherein the state associated with the apparatus includes an absolute position and an attitude of the camera.

18. The method of claim 16, wherein the state associated with the apparatus includes carrier-phase ambiguities.

19. The method of claim 16, wherein the state associated with the apparatus includes point feature positions.

20. The method of claim 16, wherein the state associated with the apparatus includes an absolute position and an attitude of the camera and carrier-phase ambiguities.

21. The method of claim 20, wherein the state associated with the apparatus includes an absolute position and an attitude of the camera, carrier-phase ambiguities, and point feature positions.

22. The method of claim 16, further comprising receiving known point feature information, the cost function further including the known point feature information.

23. The method of claim 16, further comprising receiving a second set of carrier-phase measurements from a second GNSS antenna.

24. The method of claim 16, further comprising receiving a second set of carrier-phase measurements, wherein the second set of carrier-phase measurements is based on signals from two or more GNSS antennas.

25. The method of claim 24, wherein the state associated with the apparatus includes carrier-phase ambiguities.

26. An apparatus comprising:
a global navigation satellite system (GNSS) antenna;
a mobile GNSS receiver connected to the GNSS antenna, the mobile GNSS receiver operable to produce a first set of carrier-phase measurements;
an interface operable to receive a second set of carrier-phase measurements;
a camera operable to produce an image; and
a processor communicably coupled to the mobile GNSS receiver, the interface, and the camera, the processor operable to
receive the image and the set of carrier-phase measurements,
extract point feature measurements from the image,
model the point feature measurements based on the image to produce a point feature model,
model the first set of carrier-phase measurements and second set of carrier-phase measurements to produce a carrier-phase model,
execute a cost function including the point feature measurements, the first set of carrier-phase measurements, the second set of carrier-phase measurements, the point feature model, and the carrier-phase model, and
determine an absolute position and an attitude of the camera, carrier-phase ambiguities, and point feature positions based on the executed cost function.

27. The apparatus of claim 26, wherein the second set of carrier-phase measurements is based on signals from one or more GNSS antennas.

28. The apparatus of claim 26, wherein the cost function further includes a set of pseudorange measurements from the mobile GNSS receiver.

29. The apparatus of claim 28, wherein the cost function further includes a second set of pseudorange measurements, and wherein the second set of pseudorange measurements is based on signals from one or more GNSS antennas.

30. The apparatus of claim 29, wherein the processor is further operable to receive known point feature information from a remote database and determine the absolute position and the attitude of the camera, the carrier-phase ambiguities, and the point feature position based on the known point feature information, the cost function further including the known point feature information.
